(19) United States
(12) Patent Application Publication
(10) Pub. No.: US 2010/0110986 A1
(43) Pub. Date: May 6, 2010

(54) BASE STATION DEVICE, TERMINAL DEVICE, COMMUNICATION SYSTEM AND COMMUNICATION METHOD

(76) Inventors: Toshizo Nogami, Osaka (JP); Takashi Onodera, Osaka (JP); Osamu Nakamura, Osaka (JP)

Correspondence Address: BIRCH STEWART KOLASCH & BIRCH, PO BOX 747, FALLS CHURCH, VA, 22040-0747, US

(21) Appl. No.: 12/596,630

(22) PCT Filed: Feb. 21, 2008
(86) PCT No.: PCT/JP2008/052961

§ 371 Date: Oct. 19, 2009

(30) Foreign Application Priority Data
Apr. 20, 2007 (JP) 2007-111520

(51) Int. Cl. H04W 40/00

(52) U.S. Cl. 370/328

(57) ABSTRACT

A base station device performs communication with terminal devices, and includes a load information acquisition section which acquires load information which shows a load on the base station device, a reporting method selection section which selects a reporting method for the terminal devices to report reception state information to the base station device based on load information acquired by the load information acquisition section, and a reporting section which reports the reporting method selected by the reporting method selection section to the terminal devices.

### TECHNICAL FIELD

The present invention relates to a base station device, a terminal device, a communication system and a communication method.

Priority is claimed on Japanese Patent Application No. 2007-111520, filed Apr. 20, 2007, the contents of which are incorporated herein by reference.

### BACKGROUND ART

As a method of improving communication efficiency (i.e., improving the total throughput of a system and improving the essential transmission speed in consideration of the occurrence of reception errors), a method has been proposed (see Non-patent document 1) in which, based on an index showing the transmission path state and reception state such as the reception signal power and the SNR (Signal to Noise power Ratio), communication parameters such as the modulation format, channel code rate, error correction coding method, diffusion rate, code multiplex number, transmission power, and the like are changed. In particular, a system in which modulation parameters such as the modulation format and channel code rate are adaptively selected is known as adaptive modulation.

Moreover, in communication systems which comprises a base station device and a plurality of terminal devices, and which use multicarrier communication for communication from the base station device to the terminal devices (i.e., on the downlink), a system in which scheduling is performed in order to allocate channels to each terminal device in accordance with the reception state of the downlink signal of each channel of each terminal device, and a system in which adaptive modulation is performed for the downlink for each channel which is formed by either one subcarrier or by several subcarriers have been investigated (see Non-patent document 2 and Non-patent document 3).

Note that in a communication system which employs scheduling and adaptive modulation systems which are based on the reception state of the terminal devices, in order to determine the allocations and modulation parameters, it is necessary for an index which shows the transmission path state and reception state of the reception signal power and SNR and the like of the channels used for the communication to be reported to the other partner in the communication.

In this type of system, it is necessary for each terminal device to report reception state information relating to each channel to the base station device using an uplink control channel or the like. Because of this, the problem has arisen that the amount of reception state information which is transmitted using the uplink increases enormously in proportion to the number of terminal devices and the number of channels.

In order to alleviate the above described problems, with the aim of reducing the amount of reception state information which is transmitted using the uplink, a method (i.e., a first measure) has been proposed in which the reception states of all channels allocated for communication to the respective terminal devices by the base station device are measured by each terminal device, and only an average value for the reception states of all the channels is reported by each terminal device to the base station.

In addition, a method (i.e., a second measure) has been proposed in which, of all the channels allocated for communication by the base station device to each terminal device, a predetermined number of channels having a superior reception state are selected from among channels having a superior reception state, and only the reception states of these channels are reported to the base station device.

In addition, a method (i.e., a third measure) has been proposed in which DCT (Discrete Cosine Transform) is performed in the frequency axis direction on values representing the reception state of each one of all of the channels allocated for communication by the base station device to the respective terminal devices so as to compress the reception state information.

In addition, a method (i.e., a fourth measure) has been proposed in which several reference channels are chosen from among all the channels allocated for communication by the base station device to the respective terminal devices, and values representing the reception state of each channel are expressed using differential values between the reception states and the reference channels, and these are then reported to the base station device (see Patent document 1, Patent document 2, Non-patent document 3, Non-patent document 4, and Non-patent document 5).

Furthermore, as a method which the base station device uses to control the amount of feedback information on the uplink, a method has been proposed in which a number of subcarriers that provide feedback on the reception states is decided using the downlink request transmission rate of each terminal device or the number of subcarriers previously allocated (Patent document 3).

Hereinafter, a description of the conventional technology described in Patent document 3 will be described.

FIG. 41 is a schematic block diagram showing the structure of a base station device 9100 of the conventional technology.

This base station device 9100 is provided with an antenna section 9101, a reception RF section 9102, a channel quality information extraction section 9103, an allocation control section 9104, a requested subcarrier number determination section 9105, a user information storage section 9106, a requested subcarrier number information creation section 9107, an allocation information creation section 9108, a control information multiplexing section 9109, a subcarrier allocation section 9110, modulation sections 9111-1 through 9111-N, a switching section 9112, an IFFT section 9113, a GI insertion section 9114, and a transmission RF section 9115.

The base station device 9100 has the requested subcarrier number determination section 9105. In this requested subcarrier number determination section 9105, the number of requested subcarriers is determined based on the number of subcarriers previously allocated by the allocation control section 9104 to each of one of respective terminal devices 9200. Moreover, the number of requested subcarriers for terminal devices 9200 which were not previously allocated is determined based on the request transmission rate of the terminal devices 9200 (see FIG. 42) which were not previously allocated or on the request transmission rates of all of the terminal devices 9200. The number of requested subcarriers determined by the requested subcarrier number determination section 9105 is sent to the requested subcarrier number information creation section 9107, and requested subcarrier number information which is used for reporting the requested subcarrier number to the terminal devices 9200 is created. The requested subcarrier number information is multiplexed in the control information multiplexing section 9109, the switching section 9112, and the IFFT section 9115, and after GI insertion has been performed thereon in the GI insertion section 9114, the requested subcarrier number information is sent from the transmission RF section 9115 to the terminal devices 9200.

FIG. 42 is a schematic block diagram showing the structure of a terminal device 9200 of the conventional technology. This terminal device 9200 is provided with an antenna section 9201, a reception RF section 9202, a GI removal section 9203, an FFT section 9204, a channel quality estimation section 9205, a channel estimation section 9206, an equalization section 9207, a separating section 9208, demodulation sections 9209-1 through 9209-N, a P/S section 9210, a control information extraction section 9211, an allocation information extraction section 9212, a subcarrier number information extraction section 9213, a subcarrier selection section 9214, a channel quality information creation section 9215, and a transmission RF section 9216.

In the terminal device 9200, signals transmitted from the base station device 9100 are received by the reception RF section 9202, the GI is removed therefrom by the GI removal section 9203, and after the signals have undergone processing in the FFT section 9204, the equalization section 9207, and the separation section 9208, subcarrier number information is extracted by the control information extraction section 9211 and the subcarrier number information extraction section 9213 so that the requested number of subcarriers is obtained. The requested number of subcarriers thus obtained is then sent to the subcarrier selection section 9214, and a number of subcarriers corresponding to the requested number of subcarriers are selected. The channel quality information creation section 9215 then creates channel quality information which is used to report to the base station device 9100 about the channel quality of the subcarriers selected by the subcarrier selection section 9214, and this is then transmitted from the transmission RF 9216.

Moreover, a method has also been proposed in which, based on the SNR of the terminal device 9200 or on the maximum Doppler frequency, a decision is made as to whether to report only an average value for the channel quality of all the channels, or whether to report information showing a portion of the channels and also an average value of the quality of those channels and an average value of channels other than those channels (see Non-patent document 6).

Patent document 1: Japanese Patent Application Laid-Open (JP-A) No. 2004-208234

Patent document 2: Japanese Patent Application Laid-Open (JP-A) No. 2006-50545

Patent document 3: WO No. 2005-020489

Non-patent document 1: “Experiment Evaluations of Throughput in Downlink VSF-OFCDM Broadband Wireless Access by Adaptive Modulation and Channel Coding”, Kishiyama et. al., Technology Research Report of The Institute of Electronics, Information, and Communication Engineers (IEICE), May 2003, RCS 2003-25

Non-patent document 2: “On OFDM/TDD Transmission Scheme with Subcarrier Adaptive Modulation”, Maehara et. al., Proceedings of the IEICE General Conference March 2001, B-5-100, p. 498

Non-patent document 3: “CQI Report and Scheduling Procedure”, 3GPP, TSG-RAN WG1 Meeting #42bis, R1-051045, October 2005

Non-patent document 4: “Sensitivity of DL/UL Performance to CQI-Compression with Text Proposal”, 3GPP, TSG-RAN WG1 ad hoc meeting on LTE, R1-060228, January 2006

Non-patent document 5: “Assessment of Adaptive Transmission Technologies”, WINNER, IST-2003-507581, D2. 4 ver 1.0, February 2005

Non-patent document 6: “Description of UL L1/L2 Control Message”, 3GPP, TSG-RAN WG1 Meeting #48, R1-070899, February 2007

However, in the conventional technology, in cases in which a base station is communicating with a large number of terminal devices and cases in which a base station is communicating with a small number of terminal devices, the base station device receives the same amount of reception state information from each terminal device, and using these items of reception state information the base station device performs adaptive modulation and adaptive scheduling processing on the signals transmitted to each terminal device. Because of this, the problem arises that the total amount of reception state information reported to the base station is considerable.

The present invention was conceived in view of the above described circumstances and it is an object thereof to provide a base station device, a terminal device, a communication system, and a communication method which make it possible to obtain superior transmission efficiency by enabling adaptive modulation and adaptive scheduling to be performed at the same time as the total amount of reception state information reported to the base station is kept to a minimum.

### DISCLOSURE OF INVENTION

(1) The present invention was conceived in view of the above described circumstances and an aspect of the present invention is a base station device which performs communication with terminal devices, and includes: a load information acquisition section which acquires load information which shows a load on the base station device; a reporting method selection section which selects a reporting method for the terminal devices to report reception state information to the base station device based on load information acquired by the load information acquisition section; and a reporting section which reports the reporting method selected by the reporting method selection section to the terminal devices.

In the present invention, a structure is employed in which a base station device performs communication with terminal devices, and a load information acquisition section acquires load information which shows the load of the base station device, a reporting method selection section selects a reporting method for the terminal devices to report reception state information to the base station device based on load information acquired by the load information acquisition section, and a reporting section reports the reporting method selected by the reporting method selection section to the terminal devices. Accordingly, as a result of the reporting method selection section selecting a reporting method for a small amount of information when the load of the base station device is large, and selecting a reporting method for a large amount of information when the load of the base station device is large, it is possible to reduce the amount of reception state information reported from the terminal devices when the load of the base station device is large, and thereby lighten the processing load of the base station device. Moreover, by increasing the amount of reception state information reported from the terminal devices when the load of the base station device is small, it is possible for the base station device to acquire detailed reception state information about the terminal devices, and the base station device is able to perform suitable processing such as scheduling for each terminal device.
(2) Moreover, in the base station device according to an aspect of the present invention, the load information acquisition section acquires the number of terminal devices which are performing communication with the base station device as the load information, and the reporting method selection section selects the reporting method for the terminal devices to report reception state information to the base station device based on the number of terminal devices acquired by the load information acquisition section.

In the present invention, when a large number of terminal devices are communicating with a base station device, namely, when there is a large load on the base station device, it is possible to reduce the amount of reception state information reported from the terminal devices and lighten the processing load of the base station device. Moreover, when a small number of terminal devices are communicating with the base station device, namely, when there is a small load on the base station device, by increasing the amount of reception state information reported from the terminal devices it is possible for the base station device to acquire detailed reception state information about the terminal devices, and the base station device is able to perform suitable processing such as scheduling for each terminal device.
(3) Moreover, in the base station device according to an aspect of the present invention, the load information acquisition section acquires the number of terminal devices which are reporting reception state information to the base station device as the load information, and the reporting method selection section selects the reporting method for the terminal devices to report reception state information to the base station device based on the number of terminal devices acquired by the load information acquisition section.

In the present invention, when a large number of terminal devices are communicating with a base station device, namely, when there is a large load on the base station device, it is possible to reduce the amount of reception state information reported from the terminal devices and lighten the processing load of the base station device. Moreover, when a small number of terminal devices are communicating with the base station device, namely, when there is a small load on the base station device, by increasing the amount of reception state information reported from the terminal devices it is possible for the base station device to acquire detailed reception state information about the terminal devices, and the base station device is able to perform suitable processing such as scheduling for each terminal device.
(4) Moreover, in the base station device according to an aspect of the present invention, the reporting method selection section selects the reporting method for the terminal devices to report reception state information to the base station device from among reporting methods for reception state information in which there are different amounts of information to be reported.

In the present invention, because the reporting method selection section selects a reporting method for reception state information whose amount of information to be reported varies in accordance with the load on the base station device, when there is a large load on the base station device, it allocates a, reporting method suitable for a small amount of reception state information to be reported from the terminal devices to the base station device, while when there is a small load on the base station device, it allocates a reporting method suitable for a large amount of reception state information to be reported from the terminal devices to the base station device. As a result, it is possible to lighten the processing load of the base station device, and reduce the amount of reception state information reported from the terminal devices to the base station device.
(5) Moreover, in the base station device according to an aspect of the present invention, the reporting method selection section selects a reporting method for the reception state information in which the amount of information to be reported decreases as the load shown by the load information increases.

In the present invention, when there is a large load on the base station device, because the reporting method selection section selects a reporting method for a small amount of reception state information to be reported from the terminal devices to the base station device, it is possible to lighten the processing load of the base station device when there is a large load on the base station device.
(6) Moreover, in the base station device according to an aspect of the present invention, there are provided: a reception level acquisition section which acquires the reception levels in the terminal devices of signals transmitted from the base station device to the terminal devices; and a reception level threshold value storage section which stores threshold values for the reception levels in accordance with the load shown by the load information, and the reporting method selection section selects a reporting method for the terminal devices to report the reception state information to the base station device based on the load information acquired by the load information acquisition section and on the threshold values stored by the reception level threshold value storage section and on the reception levels.

In the present invention, it is possible to switch the reporting method that a terminal device uses to report reception state information to the base station device in accordance with the size correlation between the threshold values stored by the reception level threshold value storage section and the load of the base station device acquired by the load information acquisition section.
(7) Moreover, in the base station device according to an aspect of the present invention, the reporting method selection section selects a reporting method for the terminal devices to report the reception state information to the base station device based on threshold values stored by the reception level threshold value storage section which correspond to the load information acquired by the load information acquisition section and on the reception level.

In the present invention, it is possible to switch the reporting method that a terminal device uses to report reception state information to the base station device in accordance with the size correlation between the threshold values stored by the reception level threshold value storage section and the reception level acquired by the reception level acquisition section.
(8) Moreover, in the base station device according to an aspect of the present invention, when the reception level acquired by the reception level acquisition section is equal to or more than a threshold value stored by the reception level threshold value storage section which corresponds to the load information acquired by the load information acquisition section, the reporting method selection section selects a reporting method for reception state information having a larger amount of information to be reported than when this acquired reception level is less than this threshold value.

In the present invention, when the reception level acquired by the reception level acquisition section is greater than a threshold value stored in the reception level threshold value storage section, because the amount of reception state information reported from the terminal devices to the base station device is increased, it is possible to more accurately ascertain the reception states of the terminal devices in the base station device, and the base station device is able to perform suitable processing such as scheduling for each terminal device.
(9) Moreover, in the base station device according to an aspect of the present invention, there are provided: a maximum Doppler frequency acquisition section which acquires the maximum Doppler frequency of signals transmitted between the base station device and the terminal devices; and a maximum Doppler frequency threshold value storage section which stores threshold values for the maximum Doppler frequency in accordance with the load shown by the load information, and the reporting method selection section selects the reporting method for the terminal devices to report the reception state information to the base station device based on the threshold values stored by the maximum Doppler frequency threshold value storage section which correspond to the load information acquired by the load information acquisition section and on the maximum Doppler frequency.

In the present invention, it is possible to switch the reporting method that a terminal device uses to report reception state information to the base station device in accordance with the size correlation between the threshold values stored by the reception level threshold value storage section and the reception level acquired by the reception level acquisition section.
(10) Moreover, in the base station device according to an aspect of the present invention, when the maximum Doppler frequency acquired by the maximum Doppler frequency acquisition section is equal to or more than a threshold value stored by the maximum Doppler frequency threshold value storage section which corresponds to the load information acquired by the load information acquisition section, the reporting method selection section selects a reporting method for reception state information having a smaller amount of information to be reported than when this acquired maximum Doppler frequency is less than this threshold value.

In the present invention, when the maximum Doppler frequency acquired by the maximum Doppler frequency acquisition section is greater than a threshold value stored in the maximum Doppler frequency threshold value storage section, because the amount of reception state information reported from the terminal devices to the base station device is reduced, it is possible to more accurately ascertain the reception states of the terminal devices in the base station device, and the base station device is able to perform suitable processing such as scheduling for each terminal device.
(11) Moreover, in the base station device according to an aspect of the present invention, there are provided: a delay dispersion acquisition section which acquires the delay dispersion in the terminal devices of signals transmitted from the base station device to the terminal devices; and a delay dispersion threshold value storage section which stores threshold values for the delay dispersion in accordance with the load shown by the load information, and the reporting method selection section selects the reporting method for the terminal devices to report the reception state information to the base station device based on the threshold values stored by the delay dispersion threshold value storage section which correspond to the load information acquired by the load information acquisition section and on the delay dispersion.

In the present invention, it is possible to switch the reporting method that a terminal device uses to report reception state information to the base station device in accordance with the size correlation between the threshold values stored by the delay dispersion threshold value storage section and the load of the base station device acquired by the load information acquisition section.
(12) Moreover, in the base station device according to an aspect of the present invention, when the delay dispersion acquired by the delay dispersion acquisition section is equal to or more than a threshold value stored by the delay dispersion threshold value storage section which corresponds to the load information acquired by the load information acquisition section, the reporting method selection section selects a reporting method for reception state information having a smaller amount of information to be reported than when this acquired delay dispersion is less than this threshold value.

In the present invention, when the delay dispersion acquired by the delay dispersion acquisition section is greater than a threshold value stored in the delay dispersion threshold value storage section, because the amount of reception state information reported from the terminal devices to the base station device is reduced, it is possible to more accurately ascertain the reception states of the terminal devices in the base station device, and the base station device is able to perform suitable processing such as scheduling for each terminal device.
(13) Moreover, in the base station device according to an aspect of the present invention, there are provided: a priority level acquisition section which acquires the priority level of signals transmitted from the base station device to the terminal devices; and a priority level threshold value storage section which stores threshold values for the priority levels in accordance with the load shown by the load information, and the reporting method selection section selects the reporting method for the terminal devices to report the reception state information to the base station device based on the threshold values stored by the priority level threshold value storage section which correspond to the load information acquired by the load information acquisition section and on the priority level.

In the present invention, it is possible to switch the reporting method that a terminal device uses to report reception state information to the base station device in accordance with the size correlation between the threshold values stored by the priority level threshold value storage section and the maximum Doppler frequencies acquired by the priority level acquisition section.
(14) Moreover, in the base station device according to an aspect of the present invention, when the priority level acquired by the priority level acquisition section is equal to or more than a threshold value stored by the priority level threshold value storage section which corresponds to the load information acquired by the load information acquisition section, the reporting method selection section selects a reporting method for reception state information having a greater amount of information to be reported than when this acquired priority level is less than this threshold value.

In the present invention, when the priority level acquired by the priority level acquisition section is greater than a threshold value stored in the priority level threshold value storage section, because the amount of reception state information reported from the terminal devices to the base station device is increased, it is possible to more accurately ascertain the reception states of the terminal devices in the base station device, and precedence can be given to the transmitting of transmission data with a high level of priority from the base station device to terminal devices.
(15) Moreover, in the base station device according to an aspect of the present invention, the reporting method selection section selects as the reporting method for the terminal devices to report the reception state information to the base station device either a first reporting method in which a representative value of the reception states of all the channels is reported or a second reporting method in which the reception state of each channel is reported.

In the present invention, because the reporting method selection section selects either a first reporting method in which a representative value of the reception states of all the channels is reported or a second reporting method in which the reception state of each channel is reported, it is possible to vary the amount of information when transmitting reception state information from a terminal device to a base station device in accordance with the load on the base station device.
(16) Moreover, in the base station device according to an aspect of the present invention, the reporting method selection section selects the first reporting method when the load shown by the load information is equal to or more than a predetermined threshold value, and selects the second reporting method when the load shown by the load information is less than the predetermined threshold value.

In the present invention, because the reporting method selection section selects the first reporting method for a small amount of information when the load of the base station device is equal to or more than a predetermined threshold value, and selects the second reporting method for a large amount of information when the load of the base station device is less than the predetermined threshold value, it is possible to lighten the workload of the base station device when the load on the base station device is large, and the base station device is able to perform suitable processing such as scheduling for each terminal device when the load on the base station device is light.
(17) Moreover, in the base station device according to an aspect of the present invention, the second reporting method is a method which reports the reception state information of all the channels.

In the present invention, because a method in which reception state information is reported for all of the channels is used as the second reporting method, it is possible to precisely ascertain the reception states of the terminal devices in the base station device, and the base station device is able to perform suitable processing such as scheduling for each terminal device.
(18) Moreover, in the base station device according to an aspect of the present invention, the second reporting method is a method which reports identification information of predetermined channels from all the channels, and reports the reception state information of those predetermined channels.

In the present invention, because a method in which identification information of predetermined channels from among all the channels and also the reception state information in all the channels reporting the reception state information of these predetermined channels are reported is used as the second reporting method, it is possible to reduce the amount of reception state information being reported from the terminal devices to the base station device compared with when the reception state information of all the channels is reported.
(19) Moreover, in the base station device according to an aspect of the present invention, the second reporting method is a method which reports the reception state information of all the channels after the information amount thereof has been reduced by means of discrete cosine conversion.

In the present invention, because a method in which the reception state information of all the channels is made to undergo discrete cosine conversion and is then reported is used as the second reporting method, it is possible to reduce the amount of reception state information being reported from the terminal devices to the base station device compared with when the reception state information of all the channels is reported.
(20) Moreover, in the base station device according to an aspect of the present invention, the second reporting method is a method which reports a differential value between the reception state of a predetermined channel and the reception state of a channel adjacent thereto.

In the present invention, because a method in which a differential value between the reception state of a predetermined channel and the reception state of a channel adjacent thereto is reported is used as the second reporting method, it is possible to reduce the amount of reception state information being reported from the terminal devices to the base station device compared with when the reception state information of all the channels is reported.
(21) Moreover, in the base station device according to an aspect of the present invention, the first reporting method is a method which reports either an average value, a median value, or a minimum value of the reception states of all the channels.

In the present invention, because a method in which either an average value, a median value, or a minimum value of the reception states of all the channels is reported is used as the first reporting method, it is possible to reduce the amount of reception state information being reported from the terminal devices to the base station device.
(22) Moreover, in the base station device according to an aspect of the present invention, there are provided: a reception state information receiving section which receives reception state information reported from the terminal devices; and a channel allocation section which allocates to each channel transmission data for the terminal devices based on the reporting method for the reception state information received by the reception state information receiving section.

In the present invention, because a channel allocation section allocates to each channel transmission data for the terminal devices based on the reporting method information by which the reception state information receiving section received the reception state information, it is possible to allocate channels to terminal devices in accordance with the load situation in the base station device.
(23) Moreover, in the base station device according to an aspect of the present invention, the channel allocation section gives priority to allocating transmission data to each channel in terminal devices which have used the second reporting method to report reception state information received by the reception state information receiving section over terminal devices which have used the first reporting method to report this reception state information.

In the present invention, because priority is given to allocating channels to terminal devices which have reported reception state information to the base station device using a reporting method for a large amount of information, it is possible to perform suitable processing such as scheduling for each terminal device based on detailed reception state information received by the base station device from the terminal device.
(24) Moreover, another aspect of the present invention is a terminal device which performs communication with a base station device, and includes: a reporting method receiving section which receives the reporting method, which was selected based on the load of the base station device, for the terminal device to report reception state information to the base station device; a reception state measurement section which measures the reception state of each channel; and a transmission section which transmits the reception states measured by the reception state measurement section to the base station device using the reporting method information received by the reporting method receiving section.
(25) Moreover, another aspect of the present invention is a terminal device which performs communication with a base station device, and includes: a load information receiving section which receives load information which shows a load of the base station device; a reception state measurement section which measures the reception state of each channel; a reporting method selection section which selects a reporting method for the terminal devices to report reception state information to the base station device based on load information received by the load information receiving section; and a transmission section which transmits the reception states measured by the reception state measurement section to the base station device using the reporting method selected by the reporting method selection section.
(26) Moreover, another aspect of the present invention is a communication system which is provided with a base station device and terminal devices, wherein the base station device is provided with: a load information acquisition section which acquires load information which shows a load of the base station device; a reporting method selection section which selects a reporting method for the terminal devices to report reception state information to the base station device based on load information acquired by the load information acquisition section; and a reporting section which reports the reporting method selected by the reporting method selection section to the terminal devices, and wherein the terminal devices are provided with: a reporting method receiving section which receives the reporting method reported by the reporting section; a reception state measurement section which measures the reception state of each channel; and a transmission section which transmits the reception states measured by the reception state measurement section to the base station device using the reporting method information received by the reporting method receiving section.
(27) Moreover, another aspect of the present invention is a communication system which is provided with a base station device and terminal devices, wherein the base station device is provided with: a load information acquisition section which acquires load information which shows a load of the base station device; and a load information transmission section which transmits the load information acquired by the load information acquisition section to the terminal devices, and wherein the terminal devices are provided with: a load information receiving section which receives load information transmitted by the load information transmission section; a reception state measurement section which measures the reception state of each channel; a reporting method selection section which selects a reporting method for the terminal devices to report reception state information to the base station device based on load information received by the load information receiving section; and a transmission section which transmits the reception states measured by the reception state measurement section to the base station device using the reporting method selected by the reporting method selection section.
(28) Moreover, another aspect of the present invention is a communication method for a base station device which performs communication with terminal devices, and includes: a load information acquisition step in which load information which shows a load on the base station device is acquired; a reporting method selection step in which a reporting method for the terminal devices to report reception state information to the base station device is selected based on load information acquired in the load information acquisition step; and a reporting step in which the reporting method selected in the reporting method selection step is reported to the base station device.
(29) Moreover, another aspect of the present invention is a communication method for a terminal device which performs communication with a base station device, and includes: a reporting method receiving step in which a reporting method for the terminal device to report reception state information to the base station device is received; a reception state measurement step in which the reception state of each channel is measured; and a transmission step in which the reception states measured by the reception state measurement section is transmitted to the base station device using the reporting method information received in the reporting method receiving step.
(30) Moreover, another aspect of the present invention is a communication method for a terminal device which performs communication with a base station device, and includes: a load information receiving step in which load information which shows a load of the base station device is received; a reception state measurement step in which the reception state of each channel is measured; a reporting method selection step in which a reporting method for the terminal devices to report reception state information to the base station device is selected based on load information received in the load information receiving step; and a transmission step in which the reception states measured by the reception state measurement section are transmitted to the base station device using the reporting method selected in the reporting method selection step.
(31) Moreover, another aspect of the present invention is a communication method which utilizes a base station device and terminal devices, wherein the base station device executes: a load information acquisition step in which load information which shows a load of the base station device is acquired; a reporting method selection step in which a reporting method for the terminal devices to report reception state information to the base station device is selected based on load information acquired in the load information acquisition step; and a reporting step in which the reporting method selected in the reporting method selection step is reported to the base station device, and wherein the terminal devices execute: a reporting method receiving step in which the reporting method reported in the reporting step is received; a reception state measurement step in which the reception state of each channel is measured; and a transmission step in which the reception states measured in the reception state measurement step are transmitted to the base station device using the reporting method information received in the reporting method receiving step.
(32) Moreover, another aspect of the present invention is a communication method which utilizes a base station device and terminal devices, wherein the base station device executes: a load information acquisition step in which load information which shows a load of the base station device is acquired; and a load information transmission step in which the load information acquired in the load information acquisition step is transmitted to the terminal devices, and wherein the terminal devices execute: a load information receiving step in which load information transmitted in the load information transmission step is received; a reception state measurement step in which the reception state of each channel is measured; a reporting method selection step in which a reporting method for the terminal devices to report reception state information to the base station device is selected based on load information received in the load information receiving step; and a transmission step in which the reception states measured in the reception state measurement step are transmitted to the base station device using the reporting method selected in the reporting method selection step.

### Effect of the Invention

The base station device, terminal device, communication system, and communication method of the present invention make it possible to obtain superior transmission efficiency by enabling adaptive modulation and adaptive scheduling to be performed at the same time as the total amount of reception state information is kept to a minimum

### BRIEF DESCRIPTION OF THE DRAWINGS

FIG. 1 is a view showing an example of the subframe structure of a downlink of a first embodiment of the present invention.

FIG. 2 is a schematic block diagram showing the structure of a base station device 200 of the first embodiment of the present invention.

FIG. 3 is a schematic block diagram showing the structure of a terminal device 300 of the present embodiment.

FIG. 4 is a flowchart showing decision processing for report request information of a report request decision section 213 of the base station device 200 of the first embodiment of the present invention.

FIG. 5 is a view illustrating threshold values in the first embodiment of the present invention.

FIG. 6 is a flowchart showing a scheduling operation and a modulation parameter selection operation of the base station device 200 of the first embodiment of the present invention.

FIG. 7 is a flowchart showing another example of a scheduling operation and a modulation parameter selection operation of the base station device 200 of the first embodiment of the present invention.

FIG. 8A is a view illustrating an effect of the first embodiment of the present invention.

FIG. 8B is a view illustrating an effect of the first embodiment of the present invention.

FIG. 9 is a schematic block diagram showing the structure of a base station device 800 of a second embodiment of the present invention.

FIG. 10 is a schematic block diagram showing the structure of a terminal device 900 of the second embodiment of the present invention.

FIG. 11 is a flowchart showing decision processing for report request information of a report request decision section 813 of the base station device 800 of the second embodiment of the present invention.

FIG. 12 is a flowchart showing a scheduling operation and a modulation parameter selection operation of the base station device 800 of the second embodiment of the present invention.

FIG. 13 is a schematic block diagram showing the structure of a base station device 1200 of a third embodiment of the present invention.

FIG. 14 is a schematic block diagram showing the structure of a terminal device 1300 of the third embodiment of the present invention.

FIG. 15 is a flowchart showing decision processing for report request information of a report request decision section 1213 of the base station device 1200 of the third embodiment of the present invention.

FIG. 16 is a flowchart showing a scheduling operation and a modulation parameter selection operation of the base station device 1200 of the third embodiment of the present invention.

FIG. 17 is a schematic block diagram showing the structure of a base station device 1600 of a fourth embodiment of the present invention.

FIG. 18 is a schematic block diagram showing the structure of a terminal device 1700 of the fourth embodiment of the present invention.

FIG. 19 is a flowchart showing decision processing for report request information of a report request decision section 1613 of the base station device 1600 of the fourth embodiment of the present invention.

FIG. 20 is a flowchart showing a scheduling operation and a modulation parameter selection operation of the base station device 1600 of the fourth embodiment of the present invention.

FIG. 21 is a schematic block diagram showing the structure of a base station device 2000 of a fifth embodiment of the present invention.

FIG. 22 is a schematic block diagram showing the structure of a terminal device 2100 of the fifth embodiment of the present invention.

FIG. 23 is a flowchart showing decision processing for report request information of a report request decision section 2013 of the base station device 2000 of the fifth embodiment of the present invention.

FIG. 24 is a view illustrating threshold values used in the fifth embodiment of the present invention.

FIG. 25 is a flowchart showing a scheduling operation and a modulation parameter selection operation of the base station device 2000 of the fifth embodiment of the present invention.

FIG. 26 is a schematic block diagram showing the structure of a base station device 2500 of a sixth embodiment of the present invention.

FIG. 27 is a flowchart showing decision processing for report request information of a report request decision section 2513 of the base station device 2500 of the sixth embodiment of the present invention.

FIG. 28 is a view illustrating maximum Doppler frequency threshold values of the sixth embodiment of the present invention.

FIG. 29 is a schematic block diagram showing the structure of a base station device 2800 of a seventh embodiment of the present invention.

FIG. 30 is a flowchart showing decision processing for report request information of a report request decision section 2813 of the base station device 2800 of the seventh embodiment of the present invention.

FIG. 31 is a view illustrating delay dispersion threshold values of the seventh embodiment of the present invention.

FIG. 32 is a schematic block diagram showing the structure of a base station device 3100 of an eighth embodiment of the present invention.

FIG. 33 is a view illustrating QoS levels in the eighth embodiment of the present invention.

FIG. 34 is a view illustrating threshold values for QoS levels in the eighth embodiment of the present invention.

FIG. 35 is a flowchart showing decision processing for report request information of a report request decision section 3113 of the base station device 3100 of the eighth embodiment of the present invention.

FIG. 36 is a schematic block diagram showing the structure of a base station device 3500 of a ninth embodiment of the present invention.

FIG. 37 is a schematic block diagram showing the structure of a terminal device 3600 of the ninth embodiment of the present invention.

FIG. 38 is a view showing an example of information stored by the base station device 3500 of the ninth embodiment of the present invention.

FIG. 39 is a view illustrating threshold values in the ninth embodiment of the present invention.

FIG. 40 is a view showing an example of the subframe structure of a downlink of a tenth embodiment of the present invention.

FIG. 41 is a schematic block diagram showing the structure of a base station device 9100 of the conventional technology.

FIG. 42 is a schematic block diagram showing the structure of a terminal device 9200 of the conventional technology.

### REFERENCE SYMBOLS

200 Base station device
201 Transmission buffer section
202 Coding section
203 Mapping section
204 IFFT section
205 GI insertion section
206 D/A conversion section
207 Wireless transmission section
208 Antenna section
209 Radio reception section
210 A/D conversion section
211 Mapping section
212 Decoding section
213 Report request decision section
214 Scheduling section
215 Downlink control information creation section
216 Pilot creation section
217 Reception state information storage section
221 Maximum Doppler frequency threshold value storage section
222 Maximum Doppler frequency acquisition section
223 Delay dispersion threshold value storage section
224 Delay dispersion acquisition section
800 Base station device
813 Report request decision section
814 Scheduling section
817 Reception state information storage section
900 Terminal device
909 Reception state information creation section
1200 Base station device
1213 Report request decision section
1214 Scheduling section
1217 Reception state information storage section
1300 Terminal device
1309 Reception state information creation section
1600 Base station device
1613 Report request decision section
1614 Scheduling section
1617 Reception state information storage section
1700 Terminal device
1709 Reception state information creation section
2000 Base station device
2013 Report request decision section
2014 Scheduling section
2017 Reception state information storage section
2100 Terminal device
2109 Reception state information creation section
2500 Base station device
2513 Report request decision section
2514 Scheduling section
2517 Reception state information storage section
2800 Base station device
2813 Report request decision section
2814 Scheduling section
3100 Base station device
3113 Report request decision section
3114 Scheduling section
3500 Base station device
3515 Downlink control information creation section
3600 Terminal device
3606 Demapping section
3608 Reception state measurement section
3614 Demodulation control section
3615 Report request decision section

### BEST MODE FOR CARRYING OUT THE INVENTION

Hereinafter, respective embodiments of the present invention will be described with reference made to the drawings. In the embodiments described below, an orthogonal frequency division multiplex (hereinafter abbreviated to OFDM) system is employed, and a cellular system is described in which adaptive modulation and adaptive scheduling (allocation of channels) are performed in each channel which is formed by at least one subcarrier.

Note that in the following descriptions of the respective embodiments, cases are described in which CNR (Carrier to Noise power Ratio), which is an index that is calculated based on pilot symbols, is used for the reception state information.

Note also that in each of the following embodiments, a cellular system is assumed and descriptions are given of an OFDM-based downlink from a base station device to a terminal device and an uplink from a terminal device that reports reception state information to a base station device, however, the present invention is not limited to this. Between two radio communication devices, the side which provides report about reception state information of a channel (i.e., the side that has a function of sending reception state information) is taken to be the terminal device, while the side that performs adaptive modulation by allocating to each channel the transmission data for each terminal device based on the reported reception state information (i,e., the side that has a scheduling function) is taken to be the base station device. There may also be cases in which a single radio communication device has the functions of both of these devices. The radio station devices are devices which perform radio communication and such devices include base station devices, terminal devices, radios, portable terminal devices, mobile telephones, and the like.

In addition, each of the embodiments described below may be applied to radio communication devices having a relationship in which any one of the plurality of radio communication devices performs scheduling and adaptive modulation, and the other radio communication devices transmit reception state information.

### First Embodiment

Firstly, a first embodiment of the present invention will be described.

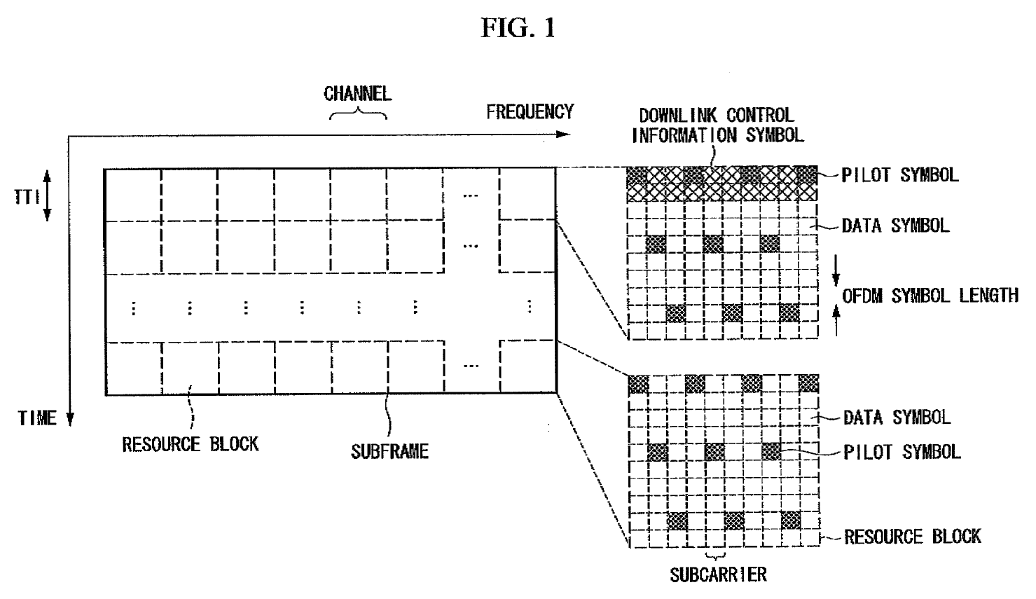

FIG. 1 is a view showing an example of a subframe structure of a downlink in the first embodiment of the present invention. In FIG. 1, the horizontal axis shows frequency, while the vertical axis shows time. As is shown in the left half of the diagram in FIG. 1, the term “channels” in the present embodiment refers to one or a plurality of subcarriers. Moreover, the term “subframe” refers to a unit of transmission. A subframe forms the range in which channel allocation is performed in a single scheduling processing. Moreover, the subframes are divided into T (wherein T is a natural number) number of predetermined time lengths TTI (Transmission Time Interval) in the time axis direction, and the description below is of a case in which the contents of one TTI in one channel is taken as a scheduling unit (hereinafter, this is called a resource block).

The diagram in the top right in FIG. 1 shows in detail one resource block which is the first resource block transmitted in one subframe. This resource block is formed by 10 subcarriers and 10 TTI. In the first TTI, pilot symbols are placed in the first and last subcarriers, and two other pilot symbols are placed at equidistant intervals. In addition, downlink control information symbols are placed in the remaining subcarriers. All other downlink control information symbols are placed in the second TTI. Data symbols are placed in the third through tenth TTI, however, in the fifth TTI, pilot symbols are placed in the second, fifth, and eighth subcarriers respectively from the low-frequency side, while in the ninth TTI, pilot symbols are placed in the third, sixth, and ninth subcarriers respectively from the low frequency side. The diagram in the bottom right in FIG. 1 shows details of one resource block as being representative of the resource blocks transmitted second through tenth. The layout of this resource block is the same as the resource block in the top right, however, data symbols are used in place of downlink control information.

Note that, in systems which perform communication using a plurality of channels, the base station and terminal station devices described below are also able to be applied to systems in which there is a possibility that the reception state will be different in each channel of each terminal device.

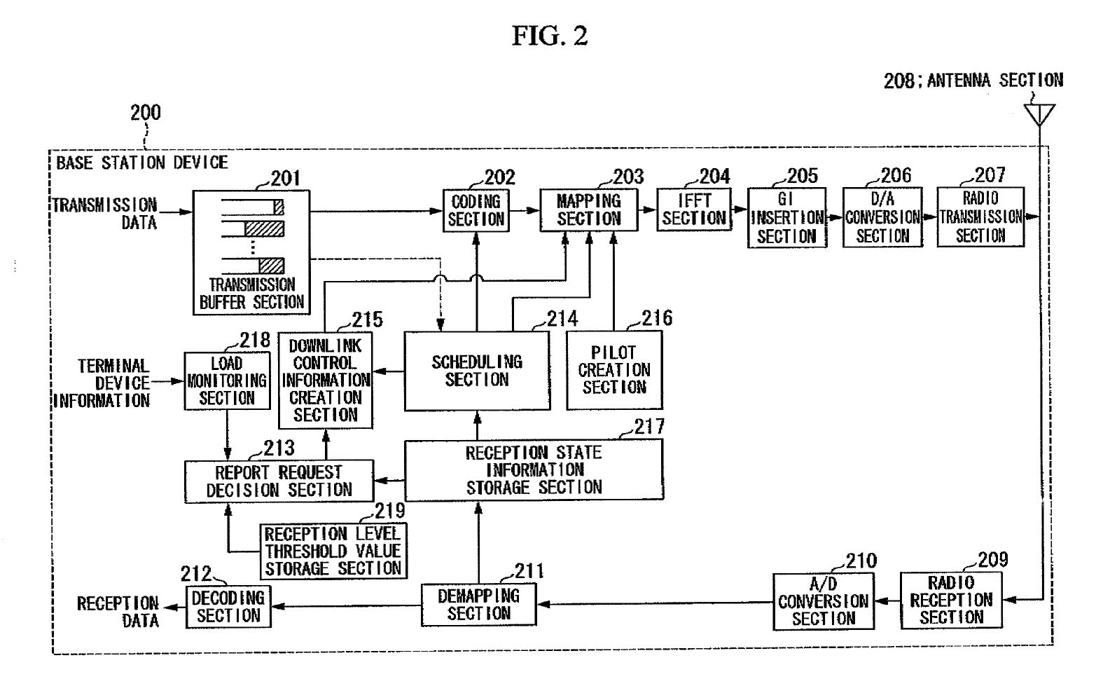

FIG. 2 is a schematic block diagram showing the structure of a base station device 200 of the first embodiment of the present invention. The base station device 200 is provided with a transmission buffer section 201, a coding section 202, a mapping section 203, an IFFT (Inverse Fast Fourier Transform) section 204, a GI (Guard Interval) insertion section 205, a D/A (Digital-to-Analog) conversion section. 206, a radio transmission section 207 (also called a report section), an antenna section 208, a radio reception section 209 (also called a reception state information receiving section), an AM (Analog-to-Digital) conversion section 210, a demapping section 211, a decoding section 212, a report request decision section 213 (also called a reporting method selection section), a scheduling section 214 (also known as a channel allocation section), a downlink control information creation section 215, a pilot creation section 216, a reception state information storage section 217 (also called a reception level acquisition section), a load monitoring section 218 (also called a load information acquisition section), and a reception level threshold value storage section 219.

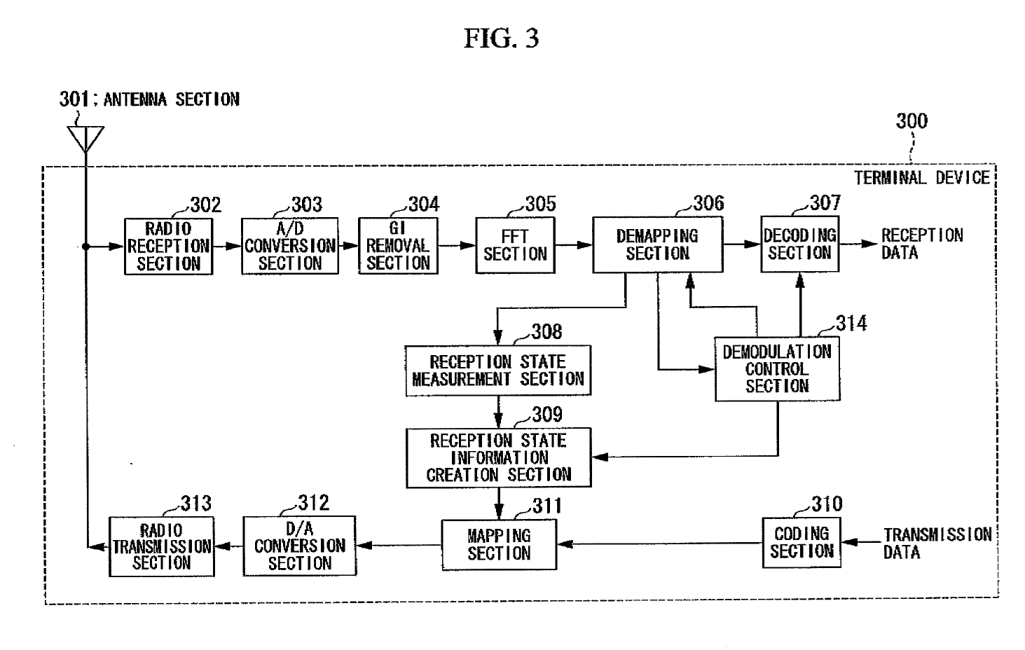

The load monitoring section 218 acquires load information showing the load on the base station device 200 based on terminal device information of the terminal device 300 (see FIG. 3) which is the recipient of the transmission data, and then outputs it to the report request decision section 213. Indexes showing the load on the base station device 200 such as the number of terminal devices performing communication with the base station device 200, the number of terminal devices reporting reception state information to the base station device 200, and the number of terminal devices to whom the transmission data is addressed are used as the terminal device information acquired by the load monitoring section 218.

The transmission buffer section 201 stores input transmission data in a buffer for each terminal device 300 to whom it is to be sent.

When the reception level stored by the reception state information storage section 217 is equal to or greater than the threshold value stored by the reception level threshold value storage section 219 which corresponds to the load information acquired by the load monitoring section 218, the report request decision section 213 selects a reporting method for reporting a greater amount of reception state information than when this reception level is less than the threshold value. In the present embodiment, if the reception level is equal to or greater than the threshold value, the report request decision section 213 selects a method in which the reception state information of all the channels is reported, while if the reception level is less than the threshold value, the report request decision section 213 selects a method in which an average value of the reception states of all the channels is reported.

Namely, the report request decision section 213 reads the reception levels (i.e., levels showing the reception signal power) of each terminal device 300 from the reception state information storage section 217, and based on the read reception levels and on the load information output from the load monitoring section 218, decides whether to request that the respective terminal devices 300 report first reception state information which shows the average value of all the reception states (i.e., one information item: hereinafter referred to as average reception state information), or whether to request that they report second reception state information which shows each one of the reception states of all the channels (i.e., information items equal to the number of channels: hereinafter referred to as individual reception state information). The report request decision section 213 then outputs the result of its decision to the downlink control information creation section 215 as report request information.

The decision procedure for deciding the report request information is described below in detail. Note that, here, the wording of all of the channels refers to all of the channels of the respective terminal devices 300 to which there is a possibility that transmission data addressed to the respective terminal devices 300 will be allocated, and refers, for example, to all of the channels included in the frequency band used for the downlink, all of the channels included the frequency band of a portion of the downlink which is decided between the respective terminal devices 300 and the base station device 200 as bandwidths to be received by the respective terminal devices 300, and all of the channels for which the respective terminal devices 300 are requesting allocation. This also applies in each of the embodiments described below.

The scheduling section 214 reads the reception state information reported from the respective terminal devices 300 which is stored in the reception state information storage section 217, and performs scheduling processing by allocating terminal devices 300 to the respective resource blocks of each channel based on this reception state information. The scheduling section 214 also selects modulation parameters to be used in the respective resource blocks, and outputs the scheduling results (i.e., the scheduling information) and the modulation parameter selection results (i.e., modulation parameter information) to the coding section 202, the mapping section 203, and the downlink control information creation section 215. More specifically, the scheduling section 214 gives priority to allocating transmission data to the terminal devices which reported the reception state information received by the radio reception section 209 by means of the second reporting method (i.e., the method in which the reception state information of all the channels is reported) over the terminal devices which reported the reception state information by means of the first reporting method (i.e., the method in which an average value of the reception states of all the channels is reported).

Note that it is also possible for the scheduling section 214 to perform the scheduling processing based also on the amount of transmission data within the transmission buffer section 201. Operations of the scheduling section 214 are described below in detail.

The downlink control information creation section 215 creates downlink control information which includes report request information from the report request decision section 213 and scheduling information and modulation parameter information from the scheduling section 214, and then outputs this downlink control information to the mapping section 203. Note that it is also possible for report request information to not be included in the downlink control information for terminal devices 300 whose report request information is the same as the previous report request information.

Moreover, it is also possible for bits to not be allocated to downlink control information for request report information relating to the addressee terminal device 300 for either one of report request information for average reception state information and report request information for individual reception state information.

The coding section 202 reads the required amount of transmission data addressed to each terminal device 300 from the transmission buffer 201 in accordance with the allocation information (i.e., the scheduling information) reported from the scheduling section 214 for allocating each terminal device 300 to the downlink. In addition, the coding section 202 performs error correction coding processing for transmission data addressed to each terminal device 300 in accordance with the modulation parameter information and scheduling information reported from the scheduling section 214. It then creates a data series, and outputs this to the mapping section 203.

The pilot creation section 216 creates a pilot series which is a signal which is inserted into a transmission signal in order to measure the signal state in a terminal device 300, and then outputs this to the mapping section 203.

The mapping section 216 performs the mapping of each bit in the data series onto the modulation symbols on the subcarriers based on modulation parameter information and the scheduling information reported from the scheduling section 214. It then performs the mapping of the downlink control information and the pilot series created by the pilot creation section 216 onto predetermined modulation symbols on a predetermined subcarrier, and outputs the results to the IFFT section 204.

For example, in FIG. 1, the data series is mapped onto the data symbols based on the scheduling information, while the pilot series is mapped onto predetermined pilot symbols in the diagram, and the downlink control information is mapped onto predetermined downlink control information symbols.

The IFFT 204 performs IFFT processing on modulation symbol series output from the mapping section 203, and converts them into OFDM signals on the time axis. Signals which have been converted by the IFFT section 204 are output to the GI insertion section 205.

The GI insertion section 205 attaches guard intervals (GI) to the OFDM signals created by the IFFT section 204, and outputs them to the D/A conversion section 206.

The D/A conversion section 206 converts the signals to which guard intervals (GI) have been attached into analog signals, and outputs these to the radio transmission section 207.

The radio transmission section 207 performs up-conversion on the analog signals output by the D/A conversion section 206, and transmits them to the terminal devices 300 using the antenna 208. In addition, the radio transmission section 207 acquires the reporting method information selected by the report request decision section 213 via the downlink control information creation section 215, the mapping section 203, the IFFT section 204, the GI insertion section 205, and the D/A conversion section 206, and reports it to the terminal devices 300 by transmission from the antenna section 208.

Moreover, the radio reception section 209 receives signals for reception state information and the like transmitted from the terminal devices 300 using the antenna section 208. The radio reception section 209 then performs down-conversion on the received analog signals, and the A/D conversion section 210 then converts these into digital signals and outputs them to the demapping section 211.

The demapping section 211 performs demapping on digital signals (i.e., modulation symbols) sent from the A/D conversion section 210, and separates them into reception state information, reception level information, and data series. The reception state information and reception level information are then output to the reception state information storage section 216, while the data series are output to the decoding section 212.

The decoding section 212 performs error correction decoding on data series extracted by the demapping section 211, and extracts reception data therefrom.

The reception state information storage section 217 stores for each terminal device 300 the reception state information and reception level information which has been reported from the respective terminal devices 300 and separated by the demapping section 211, and outputs the reception state information to the scheduling section 214, and outputs the reception level information to the report request decision section 213.

The reception level threshold value storage section 219 stores the threshold values for reception levels in accordance with the load (i.e., the number of terminal devices) indicated by the load information. The information stored by the reception level threshold value storage section 219 is described in FIG. 5.

FIG. 3 is a schematic block diagram showing the structure of a terminal device 300 of the present embodiment. The terminal device 300 is provided with an antenna section 301, a radio reception section 302 (also called a reporting method reception section), an A/D conversion section 303, a GI removal section 304, an FFT (Fast Fourier Transformation) section 305, a demapping section 306, a decoding section 307, a reception state measurement section 308, a reception state information creation section 309, a coding section 310, a mapping section 311, a D/A conversion section 312, a radio transmission section 313 (also called a transmission section), and a demodulation control section 314.

The radio reception section 302 receives signals transmitted from the base station device 200 using the antenna section 301, and outputs these to the A/D conversion section 303. For example, the radio reception section 302 may receive the reporting method information by which the terminal device 300 reports the reception state information to the base station device 200.

The A/D conversion section 303 converts analog signals which have been received and down-converted by the radio reception section 302 into digital signals, and outputs these to the GI removal section 304.

The GI removal section 304 removes guard intervals (GI) from the digital signals output by the A/D conversion section 303, and outputs signals from which these guard intervals (GI) have been removed to the FFT section 305.

The FFT section 305 performs fast Fourier transformation on the OFDM signals output from the GI removal section 304 so as to convert them to a modulation symbol series which it then outputs to the demapping section 306.

The demapping section 306 firstly separates pilot symbols from the modulation symbol series output from the FFT section 305, and outputs these to the reception state measurement section 308. The demapping section 306 also performs demapping on the downlink control information and then outputs this to the demodulation control section 314. The demapping section 306 also performs demapping on the data series in accordance with the scheduling information and demodulation parameter information from the demodulation control section 314, and then outputs the result to the decoding section 307.

Note that the demapping section 306 may also perform transmission path compensation for the modulation symbol series based on the pilot symbols.

The decoding section 307 performs error correction decoding processing on the time series output from the demapping section 306 in accordance with the scheduling information and demodulation parameter information output from the demodulation control section 314, and then outputs reception data.

The demodulation control section 314 extracts scheduling information (i.e., information relating to channels allocated to the transmission data addressed to the terminal device 300), modulation parameter information (i.e., information relating to modulation parameters for these allocated channels) and report request information from the downlink control information input from the demapping section 306, and outputs the scheduling information and modulation parameter information respectively to the demapping section 306 and decoding section 307, and outputs the report request information to the reception state information creation section 309.

Note that if the downlink control information has previously undergone error correction coding in the base station device 200, then it is sufficient to perform error correction decoding processing. Moreover, in the system in which the base station device 200 does not send report request information to a terminal device 300 for which the report request information is the same as the previous time, if report request information addressed to the terminal device 300 does not exist in the downlink control information, the base station device 200 instructs the reception state information creation section 309 to create the same reception state information that was given to the base station device 200 the previous time. Furthermore, in systems in which the base station device 200 does not allocate bits to the downlink control information for one of either report request information for average reception state information or report request information for individual reception state information, if report request information addressed to the terminal device 300 does not exist in the downlink control information, the base station device 200 instructs the reception state information creation section 309 to create the reception state information.

The reception state measurement section 308 measures reception levels and reception states in each of the channels using pilot symbols output from the demapping section 306, and outputs the reception level and reception state measurement results to the reception state information creation section 309.

Note that, in the present embodiment, a case is described in which the reception levels and reception states are measured using pilot symbols, however, it is also possible to measure reception states using data symbols, or to make reception level measurements and reception state measurements using the error correction decoding determination results for the reception data.

When the report request information output from the demodulation control section 314 is information requesting average reception state, the reception state information creation section 309 calculates an average value for the reception state measurement results for all of the channels output from the reception state measurement section 308, and creates reception state information showing the result of this calculation, and when the report request information is information requesting individual reception state information, the reception state information creation section 309 creates reception state information showing the results of the reception state measurements for each one of the channels which are output from the reception state measurement section 308, and outputs this information together with reception level information showing the reception level.

The coding section 310 performs error correction coding on transmission data to be transmitted to the base station device 200, and outputs a data series to the mapping section 311.

The mapping section 311 maps the reception state information and the reception level information created by the reception state information creation section 309, and also the data series output by the coding section 310 onto the modulation symbols, and outputs the result to the D/A conversion section 312. Note that it is also possible for the reception state information and reception level information to be reported to the base station device 200 independently of the transmission data.

The D/A conversion section 312 converts the signals output from the mapping section 311 into analog signals, and outputs these to the radio transmission section 313. The radio transmission section 313 performs up-conversion on the converted analog signals, and transmits the resulting signals to the base station device 200 using the antenna section 301. In addition, the reception state information which was measured by the reception state measurement section 308 and output via the reception state information creation section 309, the mapping section 311, and the D/A conversion section 312 is transmitted by the radio transmission section 313 to the base station device 200 by means of the reporting method information received by the radio reception section 302.

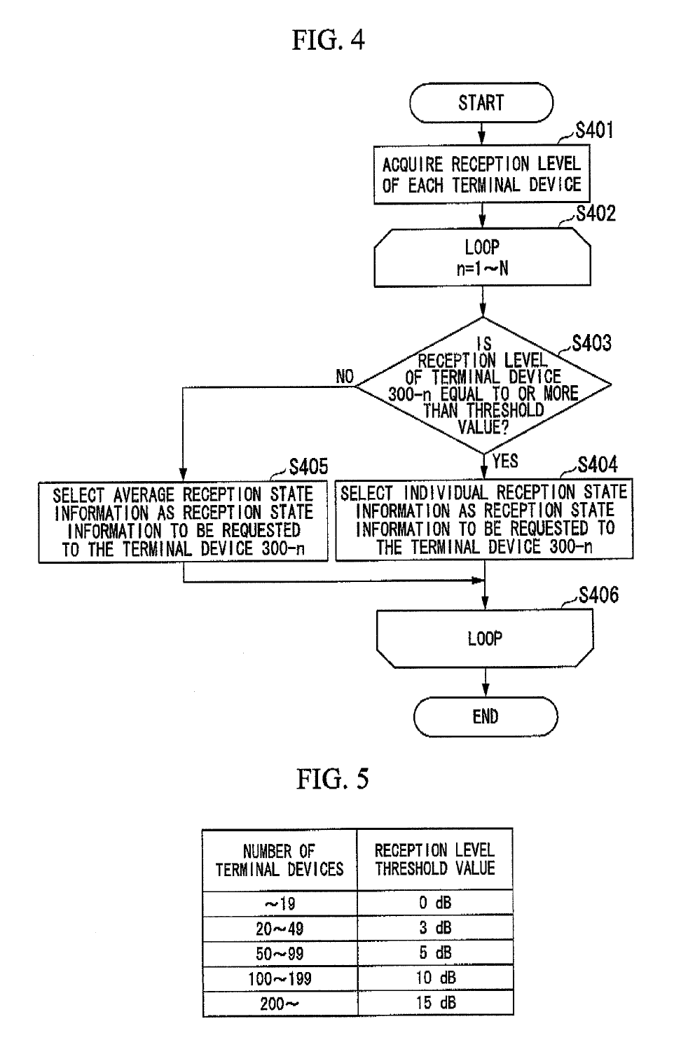

FIG. 4 is a flowchart showing the report request information decision processing of the report request decision section 213 of the base station device 200 according to the first embodiment of the present invention.

Firstly, the report request decision section 213 acquires the reception level for each terminal device 300 from the reception state information storage section 217 (step S401). Next, the following processing is repeated for each of the terminal devices 300-n (1≦n≦N (wherein N is an integer of 2 or more)) (i.e., a loop from step S402 through step S406).

Incidentally, the report request decision section 213 compares the reception level of each one of the terminal devices 300-n with a predetermined threshold value (step S403). If the reception level is equal to or greater than the predetermined threshold value, the report request decision section 213 selects the choice of requesting individual reception state information from the terminal device 300-n (step S404), while if the reception level is less than the predetermined threshold value, the report request decision section 213 selects the choice of requesting average reception state information from the terminal device 300-n (step S405).

FIG. 5 is a view illustrating threshold values in the first embodiment of the present invention. The table shown in FIG. 5 is used to decide threshold values (see step S403 in FIG. 4) corresponding to the number of terminal devices (i.e., load information), and is stored in the reception level threshold value storage section 219.

The report request decision section 213 refers to a table (i.e., FIG. 5) showing relationships between the number of terminal devices and the threshold values which are recorded in the reception level threshold value storage section 219, and decides a threshold value (for example, 3 dB) which corresponds to the number of terminal devices (for example 30) output by the load monitoring section 218. In the present embodiment, by setting the threshold values so that they are greater as the number of terminal devices increases, the threshold values are set such that the proportion of terminal devices requesting average reception state information increases as the number of terminal devices increases, while, conversely, the proportion of terminal devices requesting individual reception state information increases as the number of terminal devices decreases.

Note that the terminal device numbers and threshold values shown in FIG. 5 are simply an example thereof and the present invention is not limited to these. It is also possible to use as the threshold values a value which creates a predetermined ratio between the number of terminal devices reporting average reception state information and the number of terminal devices reporting individual reception state information, or a value which provides a ratio for the numbers of terminal devices which causes the total amount of reception state information reported from all of the terminal devices 300-1 through 300-N in accordance with the request information at the time of reporting to be not more than a predetermined value.

Moreover, in the present embodiment, a description is given of a case in which threshold values are decided from the number of terminal devices using the table shown in FIG. 5, however, the present invention is not limited to this. For example, it is also possible to use another decision method in which the threshold value increases as the number of terminal devices increases such as using a predetermined formula which calculates threshold values for the reception levels using the number of terminal devices as an argument.

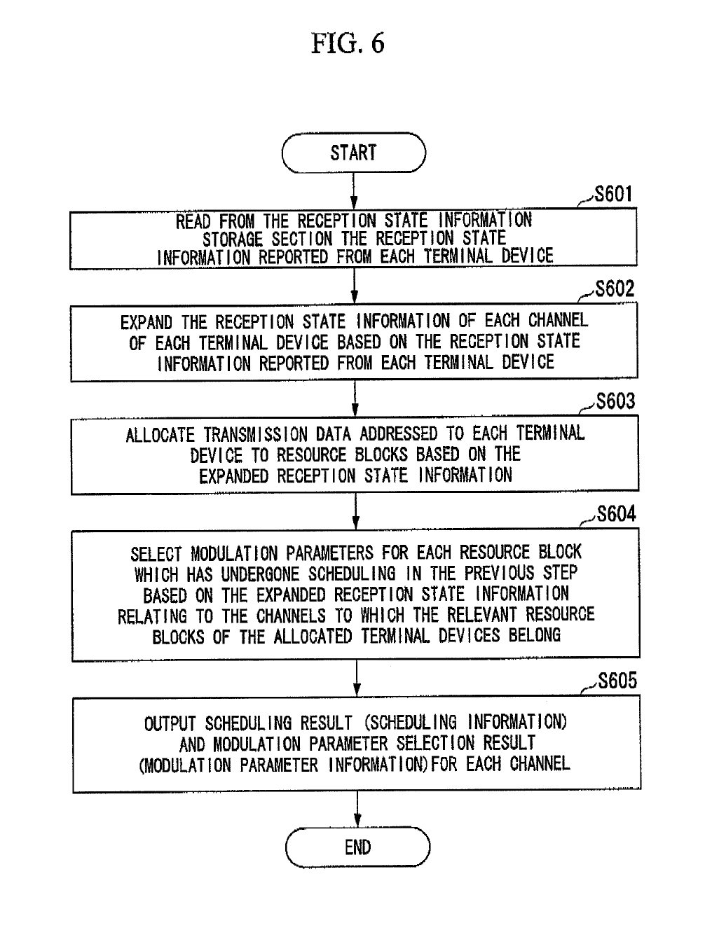

FIG. 6 is a flowchart showing a scheduling operation and a modulation parameter selection operation of the base station device 200 in the first embodiment of the present invention.

The scheduling section 214 reads from the reception state information storage section 217 the reception state information which has been reported from each terminal device 300 (step S601). Next, based on the reception state information of each terminal device 300, the scheduling section 214 expands the reception state information of each channel of the respective terminal devices 300 (step S602).

Next, based on the expanded reception state information of each channel of the respective terminal devices 300, the scheduling section 214 allocates transmission data to be transmitted to each terminal device 300 to resource blocks (step S603). Next, the scheduling section 214 selects modulation parameters for the respective resource blocks allocated in step S603 based on the reception state information of the respective terminal devices 300 allocated to the respective resource blocks (step S604).

Next, the scheduling section 214 outputs the scheduling result (i.e., the scheduling information) and the modulation parameter selection result (i.e., the modulation parameter information) to the coding section 202, the mapping section 203, and the downlink control information creation section 215 (step S605).

Note that the method which is used to expand the reception state information of each channel in each of the respective terminal devices 300 based on the reception state information of each terminal device 300 may be one in which the reception state information of each channel of those terminal devices 300 sending report of individual reception state information is taken as the reception state information for each individual channel which is indicated by the individual reception state information, and in which the reception state information of each channel of those terminal devices 300 sending report of average reception state information is taken as reception state information in which the average reception state information indicates the average reception state of all of the channels.

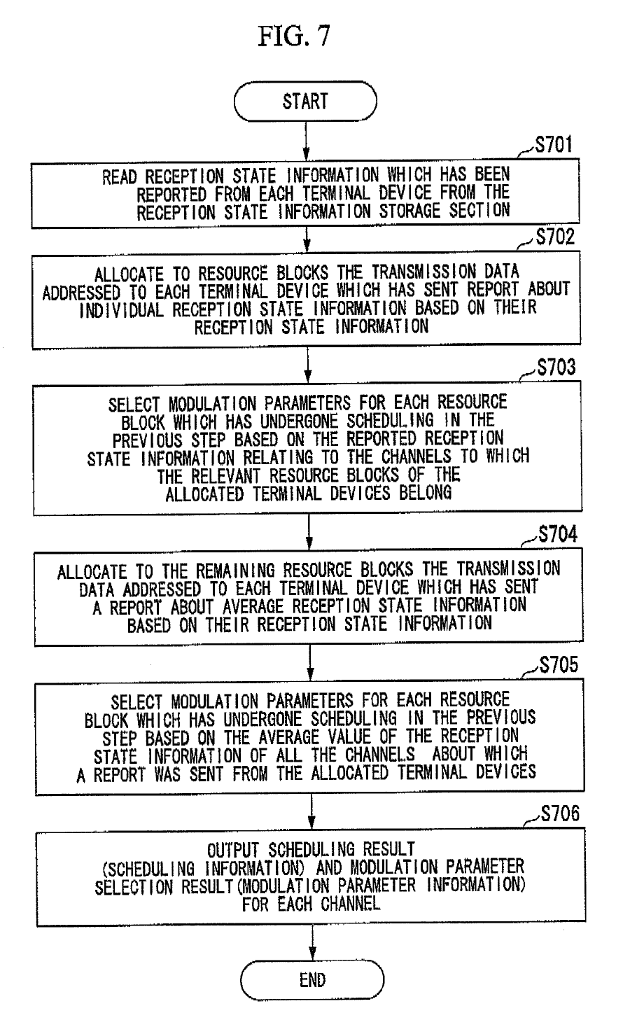

FIG. 7 is a flowchart showing another example of a scheduling operation and modulation parameter selection operation of the base station device 200 in the first embodiment of the present invention.

The scheduling section 214 reads from the reception state information storage section 217 the reception state information which has been reported from each terminal device 300 (step S701). Next, based on the reception state information of each channel of each terminal device 300, the scheduling section 214 allocates transmission data to be transmitted to each terminal device 300 which reported individual reception state information to resource blocks (step S702).

Next, the scheduling section 214 selects modulation parameters for the respective resource blocks allocated in step S702 based on the reception state information in the channels of the terminal devices 300 allocated to the respective resource blocks (step S703).

Next, based on the reception state information of each terminal device 300, the scheduling section 214 allocates transmission data which is to be transmitted to each terminal device 300 which reported average reception state information to the remaining resource blocks which received allocations in step S702 (step S704). Next, the scheduling section 214 selects modulation parameters for the respective resource blocks which received allocations in step S704 based on the reception state information in each terminal device 300 allocated to the respective resource blocks (step S705).

Next, the scheduling section 214 outputs the scheduling result (i.e., the scheduling information) and the modulation parameter selection result (i.e., the modulation parameter information) to the coding section 202, the mapping section 203, and the downlink control information creation section 215 (step S706).

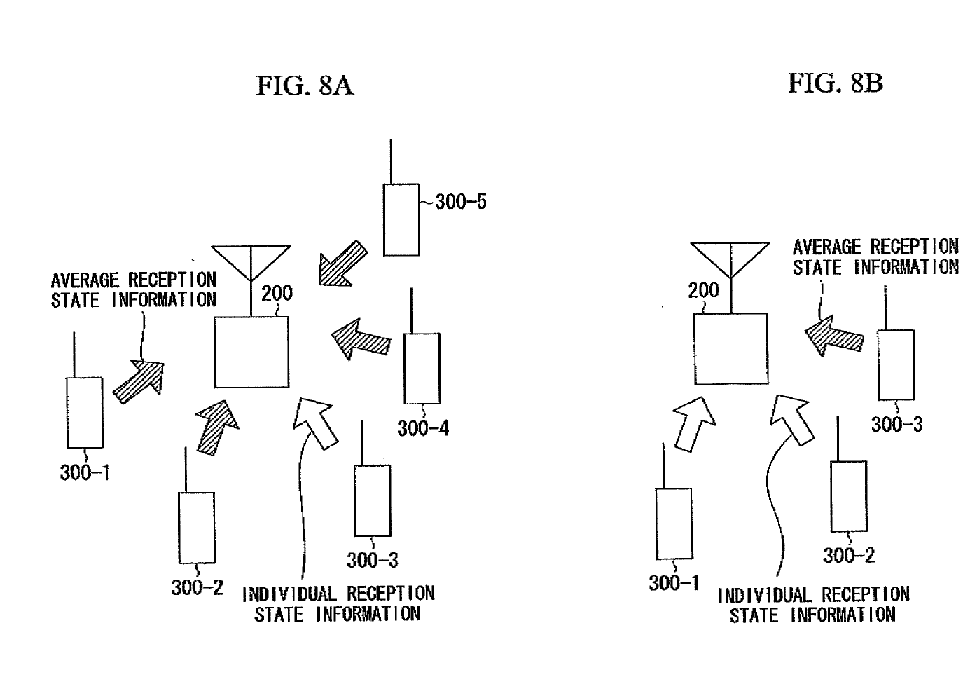

FIG. 8A and FIG. 8B are views illustrating the effects of the first embodiment of the present invention. The capacity of the uplink which is required in order to send report about individual reception state information is greater than the capacity of the uplink which is required in order to send report about average reception state information. Conversely, because the individual reception state information is able to express a more detailed reception state than the average reception state information, it is possible to perform more efficient scheduling.

In a case in which either the individual reception state information or the average reception state information is decided using only the reception level, if a large number of the terminal devices 300 which are communicating with the base station device 200 have a high reception level, then because communication ends up being performed solely by the terminal devices 300 which are sending report of individual reception state information, this puts considerable strain on the uplink. On the other hand, if a large number of the terminal devices 300 which are communicating with the base station device 200 have a low reception level, then because communication ends up being performed solely by the terminal devices 300 which are sending report of average reception state information, efficient scheduling cannot be achieved.

If either the individual reception state information or the average reception state information is decided using both the load information and the reception level, then if a large number of terminal devices are communicating with the base station device 200 (see FIG. 8A), by setting a high threshold value, the number of terminal devices which are sending report of individual reception state information decreases while the number of terminal devices which are sending report of average reception state information increases. Note that in FIG. 8A, a case is shown in which five terminal devices 300-1 through 300-5 are communicating with the base station device 200.

Because of this, it is possible to minimize the uplink capacity required by all of the terminal devices communicating with the base station device 200 to send report of their reception states. Conversely, if a small number of terminal devices are communicating with the base station device 200 (see FIG. 8B), by setting a low threshold value, the number of terminal devices which are sending report of individual reception state information increases while the number of terminal devices which are sending report of average reception state information decreases. Note that in FIG. 8B, a case is shown in which three terminal devices 300-1 through 300-3 are communicating with the base station device 200.

As a result of this, even though an uplink capacity is small for all of the terminal devices to send report of their reception states due to the number of terminal devices being small, because report can be given in detail about the reception state, scheduling can be performed more efficiently.

Note that a case has been described in which the reception signal power level is used as the reception level, however, in addition to this, it is also possible to use another index which is related to the average reception signal power such as the average SNR level or the distance from the base station 200 and the like. Moreover, it is not necessary for the reception level information to be reported every time, and it is also possible for the reception level information to only be reported when it undergoes a considerable change.

Furthermore, a description has been given of a case in which both reception state information and reception level information are reported from the terminal devices 300 to the base station device 200, however, even if reception level information is not reported, it is sufficient if it is possible to estimate the reception level in each terminal device within the base station device 200.

For example, in terminal devices which report average reception state information, the reception state information which is shown by the average reception state information can be taken as the reception level, while in terminal devices which report individual reception state information, a value obtained by averaging the reception states of all the channels which are shown by the individual reception state information can be taken as the reception level. Note that this also applies in each of the following embodiments.

In this manner, in the present embodiment, when report is given from a plurality of terminal devices 300 to the base station device 200 about their reception state information, a choice is made in accordance with the load information and the reception level in each terminal device as to whether to send report using average reception state information which represents an average value of the reception states of all of the channels, or to send individual reception state information which represent the respective reception states of all of the channels. At this time, the inter-relationship between the reception level and the reporting method used for the reception quality information is altered in accordance with the load. Because of this, in a situation in which the load is light, it becomes possible to perform efficient scheduling and adaptive modulation by priority based on the detailed reception state information of each individual channel, so that transmissions can be achieved at even higher rates.

In contrast, in a situation in which the load is heavy, by performing scheduling and adaptive modulation based on reception state information which represents an average value of the reception states of all of the channels, it is possible to reduce the amount of reception state information which needs to be reported from the respective terminal devices using an uplink.

As a result of the above, in the overall system, it becomes possible to perform efficient scheduling and adaptive modulation for terminal devices requiring high-rate and large-capacity communication, while limiting the total amount of reception state information reported from each terminal device using the uplink.

### Second Embodiment

Next, a second embodiment of the present invention will be described.

In the first embodiment, a case is described in which either average reception state information which represents an average value of the reception states of all of the channels or else individual reception state information which represent the individual reception states of each channel is chosen as the reception state information about which the base station device 200 requests a report from each terminal device 300.

A base station device 800 of the second embodiment selects, as the reception state information for which it is requesting a report, either first reception state information in the form of average reception state information, or second reception state information (described below as Top-M reception state information) which expresses channel identification numbers for a predetermined M number (wherein M is a natural number and is less than the total number of channels) of channels which have excellent reception states and also expresses the reception states.

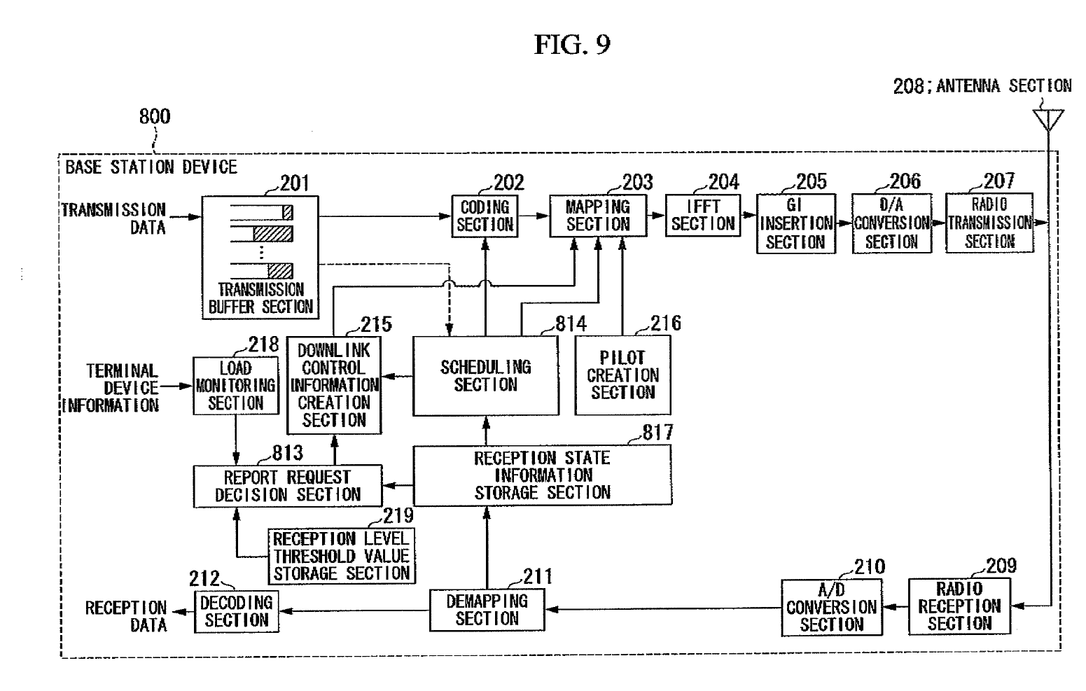

FIG. 9 is a schematic block diagram showing the structure of the base station device 800 of the second embodiment of the present invention. The base station device 800 is provided with a transmission buffer section 201, a coding section 202, a mapping section 203, an IFFT section 204, a GI insertion section 205, a D/A conversion section 206, a radio transmission section 207, an antenna section 208, a radio reception section 209, an A/D conversion section 210, a demapping section 211, a decoding section 212, a report request decision section 813, a scheduling section 814, a downlink control information creation section 215, a pilot creation section 216, a reception state information storage section 817, and a load monitoring section 218.

Of the functional blocks of the base station device 800, the report request decision section 813 which corresponds to the report request decision section 213 of the base station device 200 (see FIG. 2), the scheduling section 814 which corresponds to the scheduling section 214 of the base station device 200, and the reception state information storage section 817 which corresponds to the reception state information storage section 217 of the base station device 200 are different from the first embodiment.

Because the rest of the structure of the base station device is the same as in the first embodiment (see FIG. 2), a description thereof is omitted.

In the base station device 800 shown in FIG. 9, if the reception level is equal to or greater than a threshold value, the report request decision section 813 selects a method in which a report is sent about identification information for predetermined channels from among all of the channels and also the reception state information for these predetermined channels, while if the reception level is less than the threshold value, the report request decision section 813 selects a method in which a report is sent about an average value of the reception states of all the channels. Namely, the report request decision section 813 reads the reception levels (i.e., levels showing the reception signal power) of each terminal device 900 from the reception state information storage section 817, and based on the read reception levels and on the load information output from the load monitoring section 218, decides whether to request the respective terminal devices to report the average reception state information, or whether to request them to report the Top-M reception state information. The report request decision section 813 then outputs the result of its decision to the downlink control information creation section 215 as report request information. Note that the procedure to decide the report request information is described below in detail.

The scheduling section 814 reads the reception state information reported from the respective terminal devices and stored in the reception state information storage section 817, and performs scheduling processing by allocating terminal devices to the respective resource blocks of each channel based on this reception state information. The scheduling section 814 also selects modulation parameters to be used in the respective resource blocks, and outputs the scheduling results (i.e., the scheduling information) and the modulation parameter selection results (i.e., modulation parameter information) to the coding section 202, the mapping section 203, and the downlink control information creation section 215.

Note that it is also possible for the scheduling section 814 to perform the scheduling processing based also on the amount of transmission data within the transmission buffer section 201. Operations of the scheduling section 814 are described below in detail.

The reception state information storage section 817 stores for each terminal device the reception state information which has been reported from the respective terminal devices and separated by the demapping section 211, and outputs it to the scheduling section 814. Note that when report about Top-M information is given, the reception state information storage section 817 also stores the corresponding channel identification number at the same time.

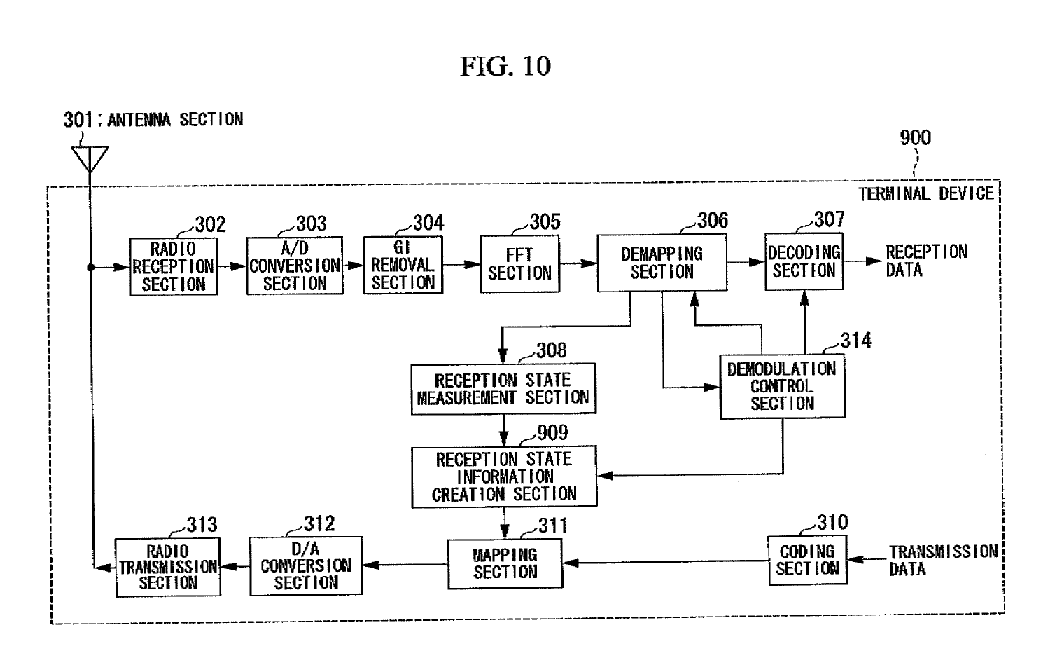

FIG. 10 is a schematic block diagram showing the structure of a terminal device 900 of the second embodiment of the present invention. The terminal device 900 is provided with an antenna section 301, a radio reception section 302, an A/D conversion section 303, a GI removal section 304, an FFT section 305, a demapping section 306, a decoding section 307, a reception state measurement section 308, a reception state information creation section 309, a coding section 310, a mapping section 311, a D/A conversion section 312, a radio transmission section 313, and a demodulation control section 314.

In the terminal device 900 of the present embodiment, the reception state information creation section 909 which corresponds to the reception state information creation section 309 of the terminal device 300 is different from the first embodiment (see FIG. 3). Because the rest of the structure of the terminal device is the same as the first embodiment, a description thereof is omitted.

In the terminal device 900 shown in FIG. 10, the reception state information creation section 909 calculates an average value of the reception state measurement results for all of the channels output from the reception state measurement section 308 when, based on the report request information output from the demodulation control section 314, it determines that this report request information is information requesting average reception state information, and creates reception state information showing the result of this calculation which it then outputs to the mapping section 311. When the report request information is information requesting Top-M reception state information, the reception state information creation section 909 selects M number of channels having excellent reception state measurement results which have been output from the reception state measurement section 308, and creates reception state information showing the identification numbers of these channels and showing the results of the reception state measurements for these channels which it then outputs to the mapping section 311.

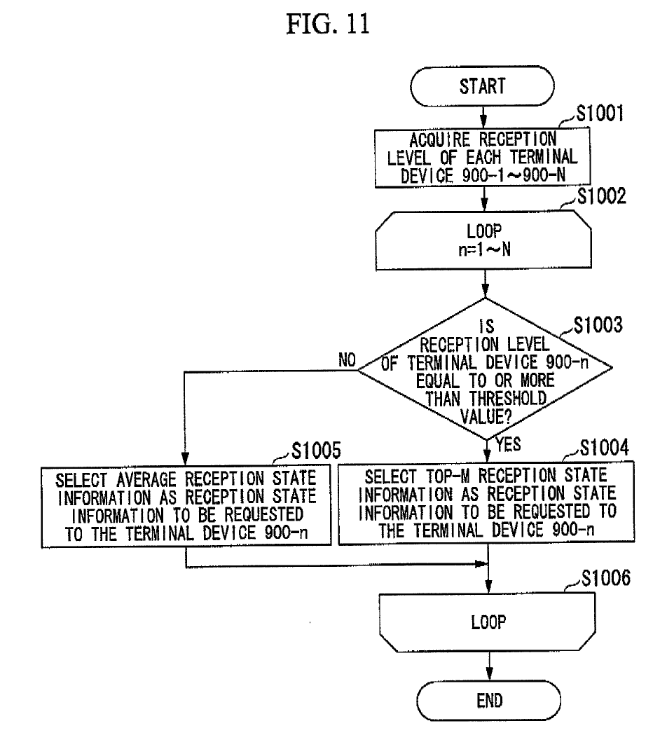

FIG. 11 is a flowchart showing the report request information decision processing of the report request decision section 813 of the base station device 800 according to the second embodiment of the present invention.

Firstly, the report request decision section 813 acquires the reception level for each terminal device from the reception state information storage section 817 (step S1001). Next, the report request decision section 813 repeats the following processing for each of the terminal devices 900 (i.e., terminal devices 900-1 through 900-N) (i.e., a loop from step S1002 through step S1006).

Incidentally, the report request decision section 813 compares the reception level of each one of the terminal devices 900-n with a predetermined threshold value (step S1003). If the reception level is equal to or greater than the predetermined threshold value, the report request decision section 813 selects the choice of requesting the Top-M reception state information from the terminal device 900-n (step S1004), while if the reception level is less than the predetermined threshold value, the report request decision section 813 selects the choice of requesting average reception state information from the terminal device 900-n (step S1005). Note that the threshold values used in the first embodiment (see FIG. 5) can be used for the predetermined threshold values.

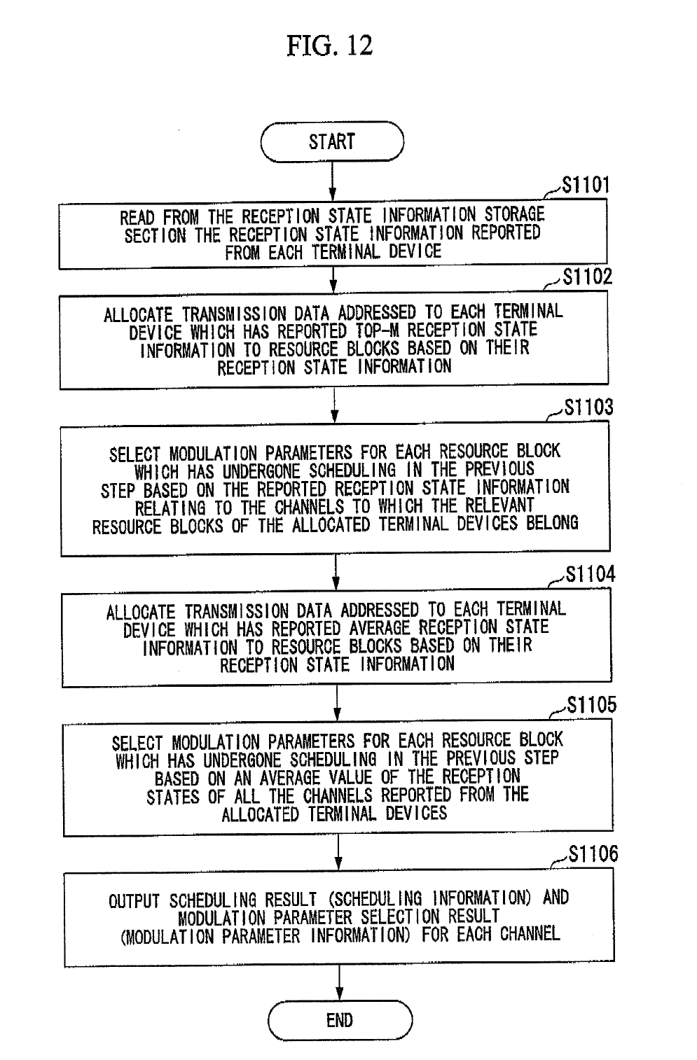

FIG. 12 is a flowchart showing a scheduling operation and a modulation parameter selection operation of the base station device 800 in the second embodiment of the present invention.

The scheduling section 814 reads from the reception state information storage section 817 the reception state information which has been reported from each terminal device 900-1 through 900-N (step S1101). Next, based on the reception state information of each channel which has been reported by the respective terminal devices, the scheduling section 814 allocates the transmission data to be transmitted to each terminal device which has reported Top-M reception state information to the respective resource blocks (step S1102).

Next, for each of the resource blocks which received allocations in step S1102, the scheduling section 814 selects modulation parameters based on the reception state information of each channel of the terminal devices which was allocated to the respective resource blocks (step S1103).

Next, based on the reception state information of each terminal device, the scheduling section 814 allocates transmission data which is to be transmitted to each terminal device which reported average reception state information to the remaining resource blocks from the allocation in step S1102 (step S1104).

Next, the scheduling section 814 selects modulation parameters for the respective resource blocks which received allocations in step S1104 based on the reception state information in each terminal device which was allocated to the respective resource blocks (step S1105).

Next, the scheduling section 814 outputs the scheduling result (i.e., the scheduling information) and the modulation parameter selection result (i.e., the modulation parameter information) to the coding section 202, the mapping section 203, and the downlink control information creation section 215 (step S1106).

In this manner, in the present embodiment, when reception state information is reported from a plurality of terminal devices 900 to the base station device 800, a choice is made in accordance with the load information and the reception level in each terminal device as to whether to report average reception state information which represents an average value of the reception states of all of the channels, or to report Top-M reception state information which represents the reception state of a predetermined M number of channels which have an excellent reception state.

At this time, the inter-relationship between the reception level and the reporting method used for the reception quality information is altered in accordance with the load. Because of this, in a situation in which the load is light, it becomes possible to perform efficient scheduling and adaptive modulation by priority based on the detailed reception state information of each individual channel which has a superior reception state, so that transmissions can be achieved at even higher rates.

In contrast, in a situation in which the load is heavy, by performing scheduling and adaptive modulation based on average reception state information which represents an average value of the reception states of all of the channels, it is possible to reduce the amount of reception state information which needs to be reported from the respective terminal devices using an uplink.

As a result of the above, in the overall system, it becomes possible to perform efficient scheduling and adaptive modulation for terminal devices requiring high-rate and large-capacity communication, while limiting the total amount of reception state information reported from each terminal device using the uplink.

Note that in the present embodiment, a case is described in which either average reception state information or else reception state information (i.e., Top-M reception state information) which represents the channel identification numbers and reception states of a predetermined M number of channels which have superior reception states is chosen as the reception state information, however, instead of the Top-M reception state information, it is also possible to use reception state information which represents the channel identification numbers of a predetermined M number of channels which have superior reception states and an average value for the reception states in this M number of channels.

### Third Embodiment

Next, a third embodiment of the present invention will be described.

In the first embodiment a case is described in which either average reception state information which represents an average value of the reception states of all of the channels or else individual reception state information which represent the individual reception states of each channel is chosen as the reception state information about which the base station device 200 requests a report from each terminal device 300.

A base station device 1200 of the third embodiment selects, as the reception state information for which it is requesting report, either first reception state information in the form of average reception state information, or second reception state information (described below as DCT reception state information) which is obtained by performing information compression by means of discrete cosine transform on information showing the respective reception states of all of the channels.

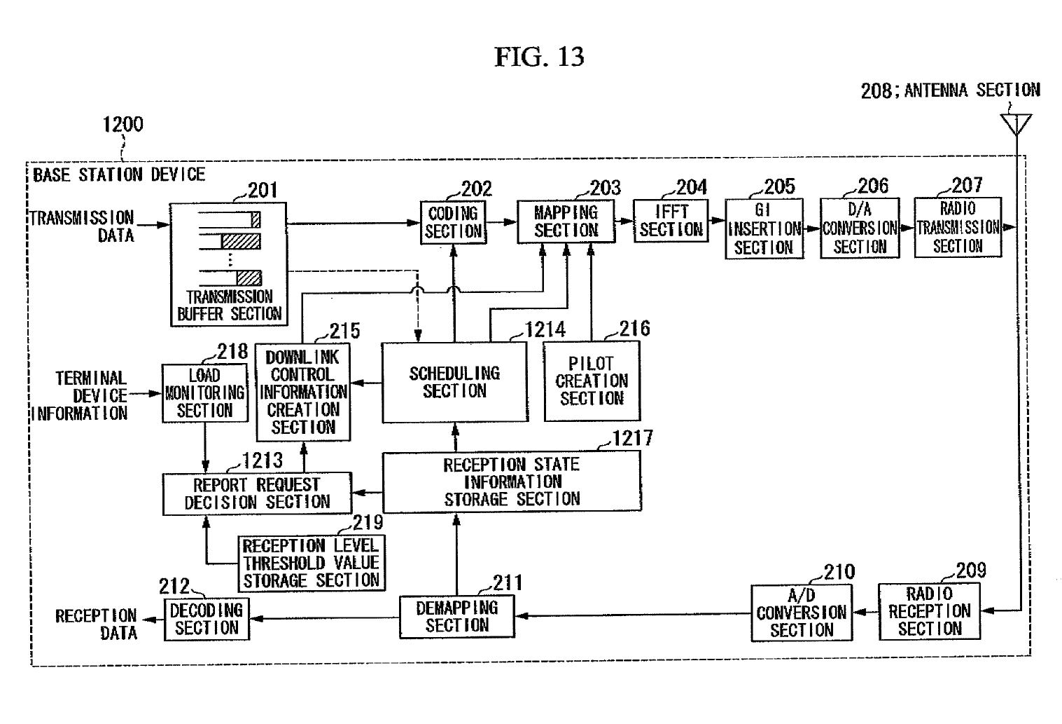

FIG. 13 is a schematic block diagram showing the structure of the base station device 1200 of the third embodiment of the present invention. The base station device 1200 is provided with a transmission buffer section 201, a coding section 202, a mapping section 203, an IFFT section 204, a GI insertion section 205, a D/A conversion section 206, a radio transmission section 207, an antenna section 208, a radio reception section 209, an A/D conversion section 210, a demapping section 211, a decoding section 212, a report request decision section 1213, a scheduling section 1214, a downlink control information creation section 215, a pilot creation section 216, a reception state information storage section 1217, and a load monitoring section 218.

Of the functional blocks of the base station device 1200, the report request decision section 1213 which corresponds to the report request decision section 213 of the base station device 200, the scheduling section 1214 which corresponds to the scheduling section 214 of the base station device 200, and the reception state information storage section 1217 which corresponds to the reception state information storage section 217 of the base station device 200 are different from the first embodiment (see FIG. 2).

Because the rest of the structure of the base station device is the same as in the first embodiment (see FIG. 2), a description thereof is omitted.

In the base station device 1200 shown in FIG. 13, if the reception level is equal to or greater than a threshold value, the report request decision section 1213 selects a method in which reception state information for all of the channels undergoes discrete cosine transformation and a report is then sent, while if the reception level is less than the threshold value, the report request decision section 1213 selects a method in which an average value of the reception states of all the channels is reported. Namely, the report request decision section 1213 reads the reception levels (i.e., levels showing the reception signal power) of each terminal device from the reception state information storage section 1217, and based on the read reception levels and on the load information output from the load monitoring section 218, decides whether to request the respective terminal devices to report the average reception state information, or whether to request them to report the DCT reception state information. The report request decision section 1213 then outputs the result of its decision to the downlink control information creation section 215 as report request information. Note that the procedure to decide the report request information is described below in detail.

The scheduling section 1214 reads the reception state information reported from the respective terminal devices and stored in the reception state information storage section 1217, and performs scheduling processing by allocating terminal devices to the respective resource blocks of each channel based on this reception state information. The scheduling section 1214 also selects modulation parameters to be used in the respective resource blocks, and outputs the scheduling results (i.e., the scheduling information) and the modulation parameter selection results (i.e., modulation parameter information) to the coding section 202, the mapping section 203, and the downlink control information creation section 215.

Note that it is also possible for the scheduling section 1214 to perform the scheduling processing based also on the amount of transmission data within the transmission buffer section 201. Operations of the scheduling section 1214 are described below in detail.

The reception state information storage section 1217 stores for each terminal device the reception state information which has been separated by the demapping section 211 and which has been reported from the respective terminal devices, and outputs it to the scheduling section 1214. Note that when DCT reception state information is reported, an IDCT (Inverse Discrete Cosine Transform) is performed on this DCT reception state information so that information showing the reception state for each channel is restored. This information is then recorded in the reception state information storage section 1217.

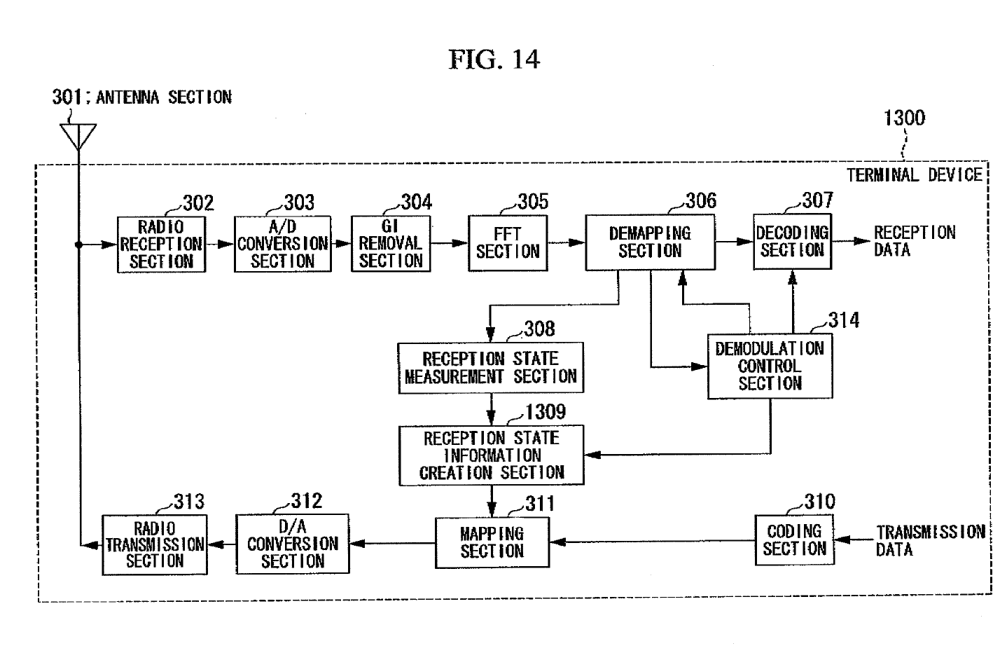

FIG. 14 is a schematic block diagram showing the structure of a terminal device 1300 of the third embodiment of the present invention. The terminal device 1300 is provided with an antenna section 301, a radio reception section 302, an Am conversion section 303, a GI removal section 304, an FFT section 305, a demapping section 306, a decoding section 307, a reception state measurement section 308, a reception state information creation section 1309, a coding section 310, a mapping section 311, a D/A conversion section 312, a radio transmission section 313, and a demodulation control section 314.

In the terminal device 1300 of the present embodiment, the reception state information creation section 1309 which corresponds to the reception state information creation section 309 of the terminal device 300 is different from the first embodiment (see FIG. 3). Because the rest of the structure of the terminal device is the same as in the first embodiment (i.e., FIG. 3), a description thereof is omitted.

In the terminal device 1300 shown in FIG. 14, the reception state information creation section 1309 calculates an average value of the reception state measurement results for all of the channels output from the reception state measurement section 308 when, based on the report request information output from the demodulation control section 314, it determines that this report request information is for average reception state information, and creates reception state information showing the result of this calculation which it then outputs to the mapping section 311. When the report request information output from the demodulation control section 314 is information requesting DCT reception state information, the reception state information creation section 1309 performs a discrete cosine transform on the reception state measurement results of each channel output from the reception state measurement section 308, and creates reception state information showing the discrete cosine transform results for these channels which it then outputs to the mapping section 311.

Note that it is also possible for delay dispersion values on the transmission path between the base station device 1200 and the terminal devices 1300 to be measured by the reception state measurement section 308 or by a delay dispersion acquisition section 224 which is provided for this purpose, and, based on these delay dispersion measurement results, for number of DCT points to be increased as the delay dispersion value increases, or for the number of DCT points to be decreased as the delay dispersion value decreases.

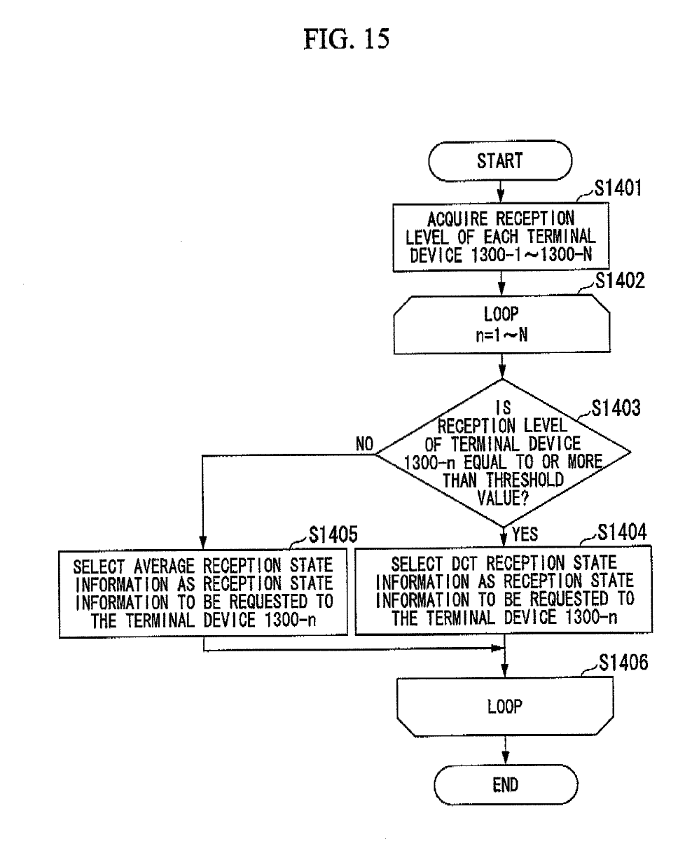

FIG. 15 is a flowchart showing the report request information decision processing of the report request decision section 1213 of the base station device 1200 according to the third embodiment of the present invention.

Firstly, the report request decision section 1213 acquires the reception levels for the respective terminal devices 1300-1 through 1300-N from the reception state information storage section 1217 (step S1401). Next, the report request decision section 1213 repeats the following processing for each of the terminal devices 1300-1 through 1300-N (i.e., a loop from step S1402 through step S1406).

Incidentally, the report request decision section 1213 compares the reception levels of each one of the terminal devices 1300-n with a predetermined threshold value (step S1403). If the reception level is equal to or greater than the predetermined threshold value, the report request decision section 1213 then selects the choice of requesting the DCT reception state information from each terminal device (step S1404), while if the reception level is less than the predetermined threshold value, the report request decision section 1213 selects the choice of requesting average reception state information from each terminal device (step S1405). Note that the threshold values used in the first embodiment (see FIG. 5) can be used for the predetermined threshold values.

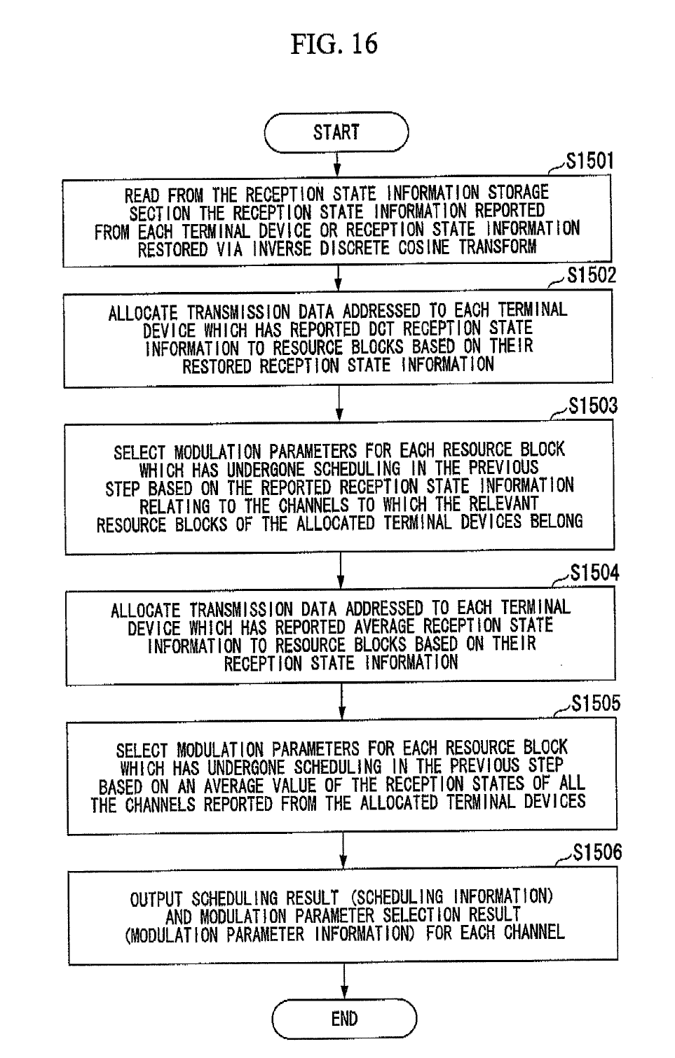

FIG. 16 is a flowchart showing a scheduling operation and a modulation parameter selection operation of the base station device 1200 in the third embodiment of the present invention.

The scheduling section 1214 reads from the reception state information storage section 1217 the reception state information which has been reported from the respective terminal devices or the reception state information which has been restored by inverse discrete cosine transform (step S1501). Next, based on the reception state information for each channel in the results of the inverse discrete cosine transform of each terminal device, the scheduling section 1214 allocates the transmission data to be transmitted to each terminal device which has reported DCT reception state information to the respective resource blocks (step S1502).

Next, for each of the resource blocks which received allocations in step S1502, the scheduling section 1214 selects modulation parameters based on the reception state information of each channel of the terminal devices which was allocated to the respective resource blocks (step S1503).

Next, based on the reception state information of each terminal device, the scheduling section 1214 allocates transmission data which is to be transmitted to each terminal device which reported average reception state information to the remaining resource blocks from the allocation in step S1502 (step S1504).

Next, the scheduling section 1214 selects modulation parameters for the respective resource blocks which received allocations in step S1504 based on the reception state information in each terminal device which was allocated to the respective resource blocks (step S1505).

Next, the scheduling section 1214 outputs the scheduling result (i.e., the scheduling information) and the modulation parameter selection result (i.e., the modulation parameter information) to the coding section 202, the mapping section 203, and the downlink control information creation section 215 (step S1506).

In this manner, in the present embodiment, when reception state information is reported from a plurality of terminal devices 1300 to the base station device 1200, a choice is made in accordance with the load information and the reception level in each terminal device as to whether to report average reception state information which represents an average value of the reception states of all of the channels, or to report DCT reception state information which is obtained by performing information compression by means of discrete cosine transform on information showing the respective reception states of all of the channels.

At this time, the inter-relationship between the reception level and the reporting method used for the reception quality information is altered in accordance with the load. Because of this, in a situation in which the load is light, it becomes possible to perform efficient scheduling and adaptive modulation by priority based on the detailed reception state information of each individual channel which has a superior reception state, so that transmissions can be achieved at even higher rates.

In contrast, in a situation in which the load is heavy, by performing scheduling and adaptive modulation based on average reception state information which represents an average value of the reception states of all of the channels, it is possible to reduce the amount of reception state information which needs to be notified from the respective terminal devices using an uplink.

As a result of the above, in the overall system, it becomes possible to perform efficient scheduling and adaptive modulation for terminal devices requiring high-rate and large-capacity communication, while limiting the total amount of reception state information notified from each terminal device using the uplink.

### Fourth Embodiment

Next, a fourth embodiment of the present invention will be described.

In the first embodiment a case is described in which either average reception state information which represents an average value of the reception states of all of the channels or else individual reception state information which represent the individual reception states of each channel is chosen as the reception state information about which the base station device 200 requests a report from each terminal device 300.

A base station device 1600 of the fourth embodiment selects, as the reception state information for which it is requesting a report, either first reception state information in the form of average reception state information, or second reception state information (described below as differential reception state information) in which the amount of information is reduced by using information showing the reception state of a first channel together with differential values between this information and information showing the reception states of adjacent channels for all the other channels.

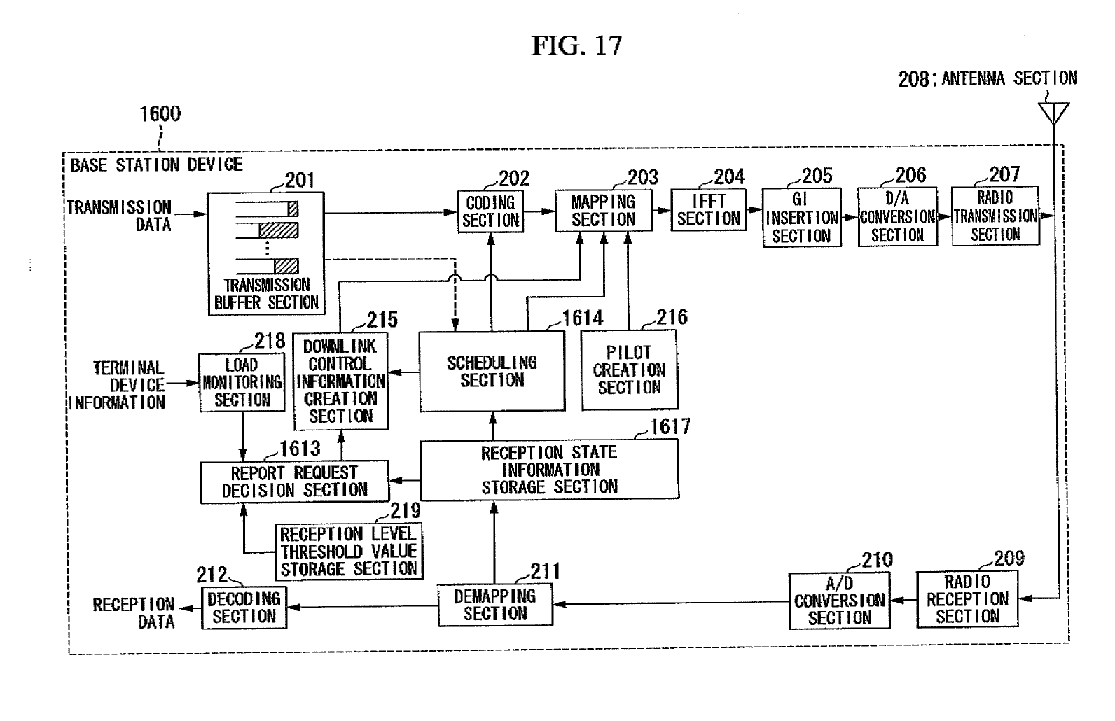

FIG. 17 is a schematic block diagram showing the structure of the base station device 1600 of the fourth embodiment of the present invention. The base station device 1600 is provided with a transmission buffer section 201, a coding section 202, a mapping section 203, an IFFT section 204, a GI insertion section 205, a D/A conversion section 206, a radio transmission section 207, an antenna section 208, a radio reception section 209, an A/D conversion section 210, a demapping section 211, a decoding section 212, a report request decision section 1613, a scheduling section 1614, a downlink control information creation section 215, a pilot creation section 216, a reception state information storage section 1617, and a load monitoring section 218.

Of the functional blocks of the base station device 1600, the report request decision section 1613 which corresponds to the report request decision section 213 of the base station device 200, the scheduling section 1614 which corresponds to the scheduling section 214 of the base station device 200, and the reception state information storage section 1617 which corresponds to the reception state information storage section 217 of the base station device 200 are different from the first embodiment (see FIG. 2). Because the rest of the structure of the base station device is the same as in the first embodiment, a description thereof is omitted.

In the base station device 1600 shown in FIG. 17, if the reception level is equal to or greater than a threshold value, the report request decision section 1613 selects a method in which the reception state of a predetermined channel and differential values between this and the reception state of an adjacent channels are reported, while if the reception level is less than the threshold value, the report request decision section 1613 selects a method in which an average value of the reception states of all the channels is reported. Namely, the report request decision section 1613 reads the reception levels (i.e., levels showing the reception signal power) of each terminal device from the reception state information storage section 1617, and based on the read reception levels and on the load information output from the load monitoring section 218, decides whether to request the respective terminal devices to report the average reception state information, or whether to request them to report the differential reception state information. The report request decision section 1613 then outputs the result of its decision to the downlink control information creation section 215 as report request information. Note that the procedure to decide the report request information is described below in detail.

The scheduling section 1614 reads the reception state information reported from the respective terminal devices and stored in the reception state information storage section 1617, and performs scheduling processing by allocating terminal devices to the respective resource blocks of each channel based on this reception state information. The scheduling section 1614 also selects modulation parameters to be used in the respective resource blocks, and outputs the scheduling results (i.e., the scheduling information) and the modulation parameter selection results (i.e., modulation parameter information) to the coding section 202, the mapping section 203, and the downlink control information creation section 215.

Note that it is also possible for the scheduling section 1614 to perform the scheduling processing based also on the amount of transmission data within the transmission buffer section 201. Operations of the scheduling section 1614 are described below in detail.

The reception state information storage section 1617 stores for each terminal device the reception state information reported from the respective terminal devices and separated by the demapping section 211, and outputs it to the scheduling section 1614.

Note that when differential reception state information is reported, information showing the reception state for each channel is restored by adding the differential values of each channel in sequence taking the reception state information of the initial channel as a starting point. This information is then recorded in the reception state information storage section 1217.

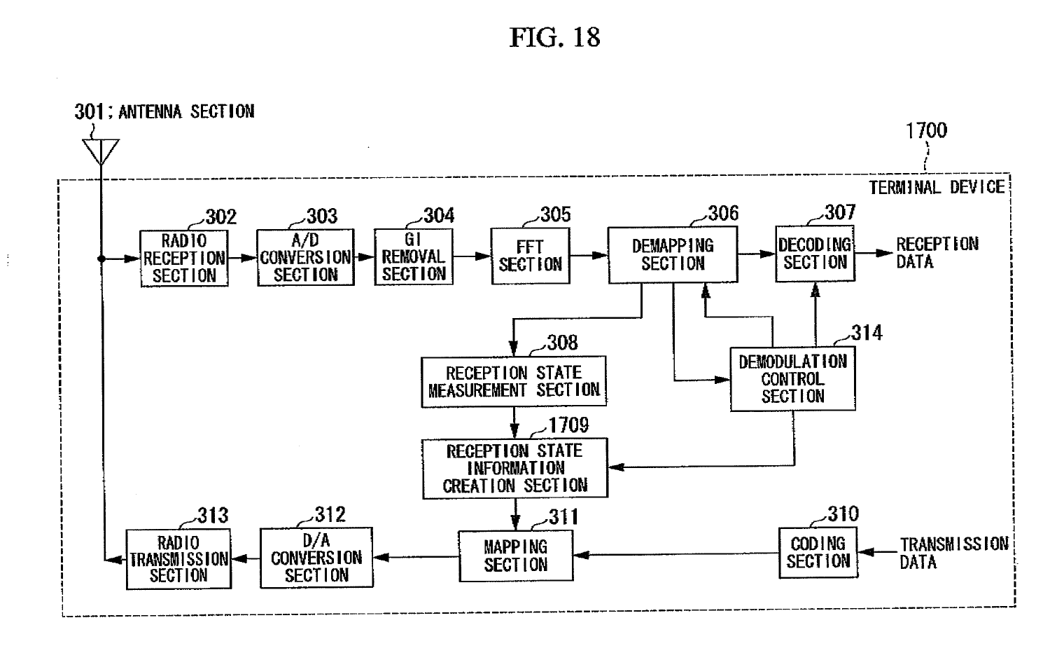

FIG. 18 is a schematic block diagram showing the structure of a terminal device 1700 of the fourth embodiment of the present invention. The terminal device 1700 is provided with an antenna section 301, a radio reception section 302, an A/D conversion section 303, a GI removal section 304, an FET section 305, a demapping section 306, a decoding section 307, a reception state measurement section 308, a reception state information creation section 1709, a coding section 310, a mapping section 311, a D/A conversion section 312, a radio transmission section 313, and a demodulation control section 314.

In the terminal device 1700 of the present embodiment, the reception state information creation section 1709 which corresponds to the reception state information creation section 309 of the terminal device 300 is different from the first embodiment (see FIG. 3). Because the rest of the structure of the terminal device is the same as in the first embodiment, a description thereof is omitted.

In the terminal device 1700 shown in FIG. 18, the reception state information creation section 1709 calculates an average value of the reception state measurement results for all of the channels output from the reception state measurement section 308 when, based on the report request information output from the demodulation control section 314, it determines that this report request information is for average reception state information, and creates reception state information showing the result of this calculation which it then outputs to the mapping section 311.

When the report request information output from the demodulation control section 314 is information requesting differential reception state information, taking the reception state measurement result for an initial channel which is output from the reception state measurement section 308 as a stating point, the reception state information creation section 1709 calculates respective differential values from adjacent channels using the reception state measurement results for other channels. The reception state information creation section 1709 then creates reception state information which shows the reception state measurement results for the initial channel and also shows the differential value results, and then outputs this information to the mapping section 311.

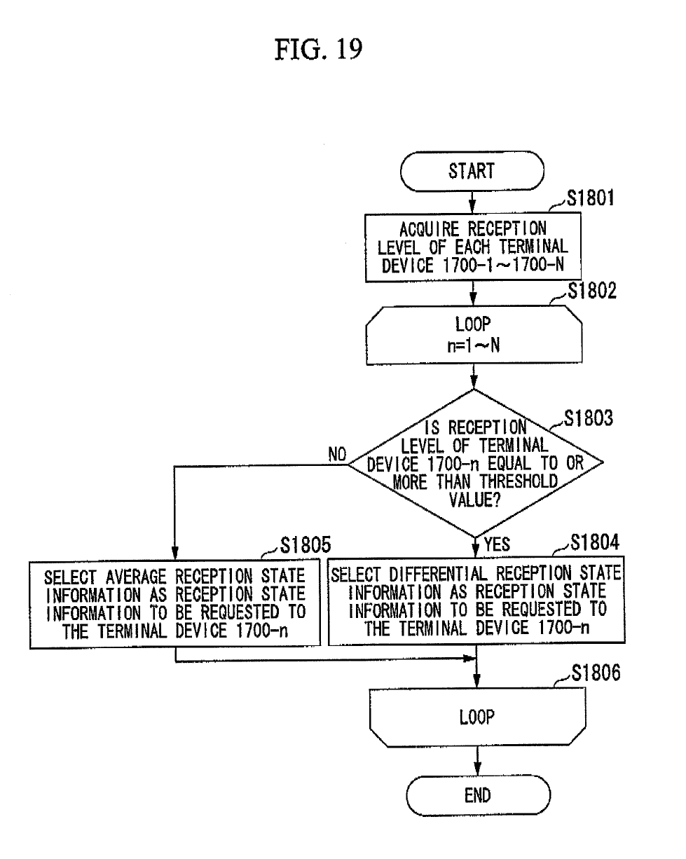

FIG. 19 is a flowchart showing the report request information decision processing of the report request decision section 1613 of the base station device 1600 according to the fourth embodiment of the present invention.

Firstly, the report request decision section 1613 acquires the reception levels for the respective terminal devices 1700-1 through 1700-N from the reception state information storage section 1617 (step S1801). Next, the report request decision section 1613 repeats the following processing for each of the terminal devices 1700-1 through 1700-N (i.e., a loop from step S1802 through step S1806).

Incidentally, the report request decision section 1613 compares the reception levels of each one of the terminal devices 1700-n with a predetermined threshold value (step S1803). If the reception level is equal to or greater than the predetermined threshold value, the report request decision section 1613 then selects the choice of requesting the differential reception state information from each terminal device (step S1804), while if the reception level is less than the predetermined threshold value, the report request decision section 1613 selects the choice of requesting average reception state information from each terminal device (step S1805). Note that the threshold values used in the first embodiment (see FIG. 5) can be used for the predetermined threshold values.

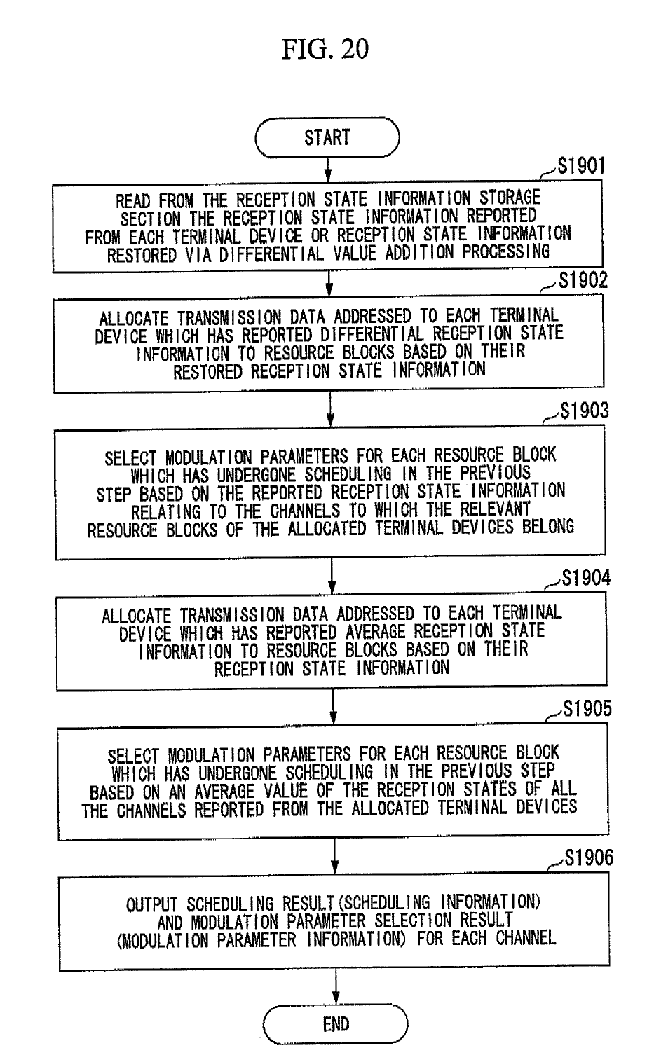

FIG. 20 is a flowchart showing a scheduling operation and a modulation parameter selection operation of the base station device 1600 in the fourth embodiment of the present invention.

Firstly, the scheduling section 1614 reads from the reception state information storage section 1617 the reception state information which has been reported from the respective terminal devices or the reception state information which has been restored by performing addition processing on the differential values (step S1901). Next, based on the reception state information for each channel in the results of the differential value addition processing of each terminal device, the scheduling section 1614 allocates the transmission data to be transmitted to each terminal device which has reported differential reception state information to the respective resource blocks (step S1902).

Next, for each of the resource blocks which received allocations in step S1902, the scheduling section 1614 selects modulation parameters based on the reception state information of each channel of the terminal devices which was allocated to the respective resource blocks (step S1903).

Next, based on the reception state information of each terminal device, the scheduling section 1614 allocates transmission data which is to be transmitted to each terminal device which reported average reception state information to the remaining resource blocks from the allocation in step S1902 (step S1904).

Next, the scheduling section 1614 selects modulation parameters for the respective resource blocks which received allocations in step S1904 based on the reception state information in each terminal device which was allocated to the respective resource blocks (step S1905).

Next, the scheduling section 1614 outputs the scheduling result (i.e., the scheduling information) and the modulation parameter selection result (i.e., the modulation parameter information) to the coding section 202, the mapping section 203, and the downlink control information creation section 215 (step S1906).

In this manner, in the present embodiment, when reception state information is reported from a plurality of terminal devices 1700 to the base station device 1600, a choice is made in accordance with the load information and the reception level in each terminal device as to whether to report average reception state information which represents an average value of the reception states of all of the channels, or to report differential reception state information in which the amount of information has been reduced by using information showing the reception state of a first channel together with differential values between this information and information showing the reception states of adjacent channels for all the other channels.

At this time the inter-relationship between the reception level and the reporting method used for the reception quality information is altered in accordance with the load. Because of this, in a situation in which the load is light, it becomes possible to perform efficient scheduling and adaptive modulation by priority based on the detailed reception state information of each individual channel which has a superior reception state, so that transmissions can be achieved at even higher rates.

In contrast, in a situation in which the load is heavy, by performing scheduling and adaptive modulation based on average reception state information which represents an average value of the reception states of all of the channels, it is possible to reduce the amount of reception state information which needs to be notified from the respective terminal devices using an uplink.

As a result of the above, in the overall system, it becomes possible to perform efficient scheduling and adaptive modulation for terminal devices requiring high-rate and large-capacity communication, while limiting the total amount of reception state information notified from each terminal device using the uplink.

### Fifth Embodiment

Next, a fifth embodiment of the present invention will be described.

In the above described first through fourth embodiments, cases are described in which either average reception state information which shows an average value of the reception states of all of the channels or else more detailed reception state information which shows the individual reception states of each channel is chosen as the reception state information about which the base station device requests a report from each terminal device.

In the fifth embodiment, a base station device 2000 selects, as the reception state information for which it is requesting a report, either first reception state information in the form of average reception state information, second reception state information (i.e., Top-M reception state information) which shows channel identification numbers for a predetermined M number (wherein M is a natural number and is less than the total number of channels) of channels which have excellent reception states and shows the reception states, or third reception state information (i.e., individual reception state information) which shows the individual reception states of each channel.

Note that in the present embodiment, a case is described in which Top-M reception state information is used in order to report reception information which is more detailed than the average reception state information, and individual reception state information is used in order to report reception information which is more detailed than the Top-M reception state information, however, the present invention is not limited to this. For example, it is also possible to use another of the methods used to report reception state information which are described in the first through fourth embodiments.

FIG. 21 is a schematic block diagram showing the structure of the base station device 2000 of the fifth embodiment of the present invention. The base station device 2000 is provided with a transmission buffer section 201, a coding section 202, a mapping section 203, an IFFT section 204, a GI insertion section 205, a D/A conversion section 206, a radio transmission section 207, an antenna section 208, a radio reception section 209, an A/D conversion section 210, a demapping section 211, a decoding section 212, a report request decision section 2013, a scheduling section 2014, a downlink control information creation section 215, a pilot creation section 216, a reception state information storage section 2017, and a load monitoring section 218.

Of the functional blocks of the base station device 2000, the report request decision section 2013 which corresponds to the report request decision section 213 of the base station device 200, the scheduling section 2014 which corresponds to the scheduling section 214 of the base station device 200, and the reception state information storage section 2017 which corresponds to the reception state information storage section 217 of the base station device 200 are different from the first embodiment (see FIG. 2). Because the rest of the structure of the base station device is the same as in the first embodiment (see FIG. 2), a description thereof is omitted.

In the base station device 2000 shown in FIG. 21, the report request decision section 2013 reads the reception levels (i.e., levels showing the reception signal power) of each terminal device from the reception state information storage section 2017, and based on the read reception levels and on the load information output from the load monitoring section 218, decides whether to request the respective terminal devices to report the average reception state information, or whether to request them to report the Top-M reception state information, or whether to request them to report the individual reception state information. The report request decision section 2013 then outputs the result of its decision to the downlink control information creation section 215 as report request information. Note that the procedure to decide the report request information is described below in detail.

The scheduling section 2014 reads the reception state information reported from the respective terminal devices and stored in the reception state information storage section 2017, and performs scheduling processing by allocating terminal devices to the respective resource blocks of each channel based on this reception state information. The scheduling section 2014 also selects modulation parameters to be used in the respective resource blocks, and outputs the scheduling results (i.e., the scheduling information) and the modulation parameter selection results (i.e., modulation parameter information) to the coding section 202, the mapping section 203, and the downlink control information creation section 215. Note that it is also possible for the scheduling section 2014 to perform the scheduling processing based also on the amount of transmission data within the transmission buffer section 201. Operations of the scheduling section 2014 are described below in detail.

The reception state information storage section 2017 stores for each terminal device the reception state information which has been reported from the respective terminal devices and separated by the demapping section 211, and outputs it to the scheduling section 2014. Note that when Top-M information is reported, the corresponding channel identification number is also recorded in the reception state information storage section 2017 at the same time.

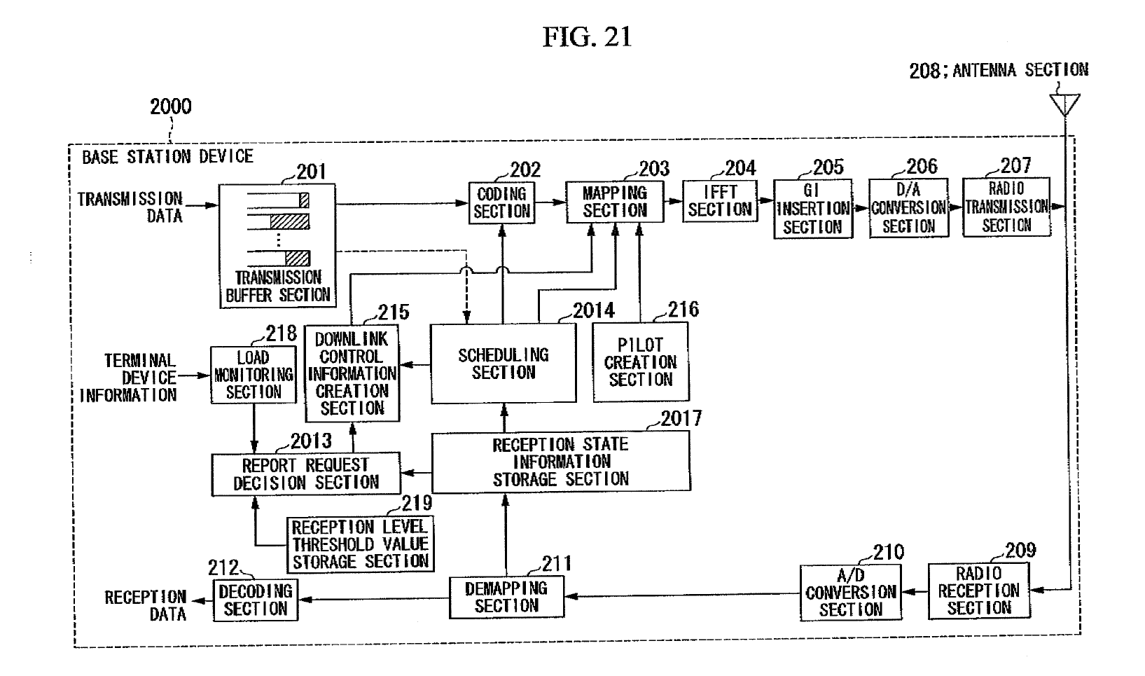

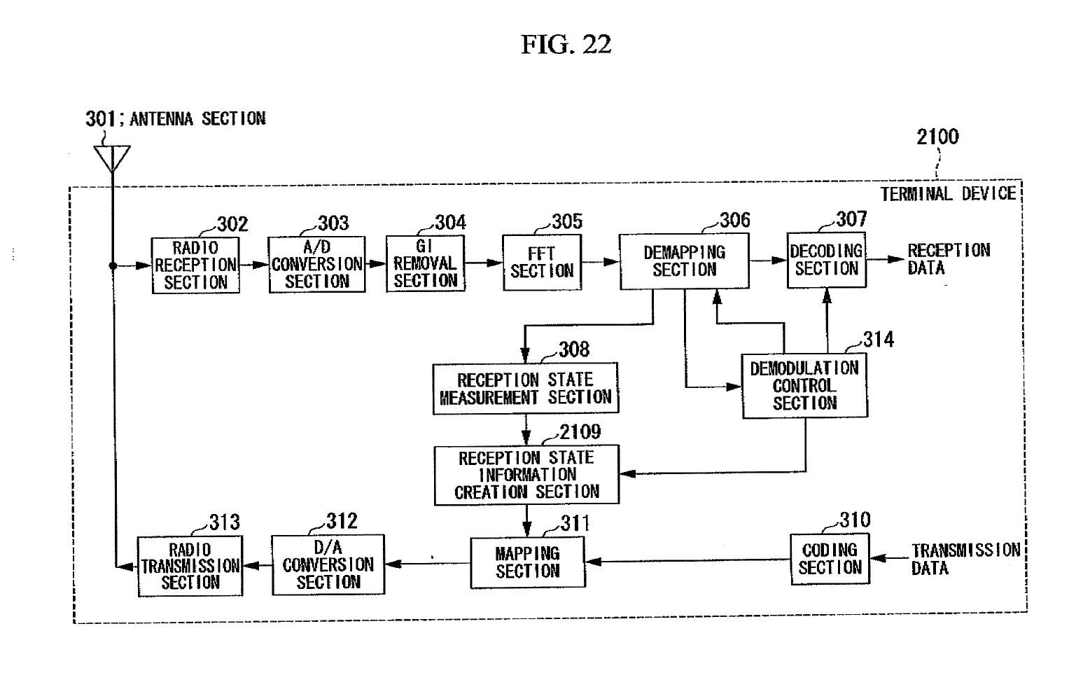

FIG. 22 is a schematic block diagram showing the structure of a terminal device 2100 of the fifth embodiment of the present invention. The terminal device 2100 is provided with an antenna section 301, a radio reception section 302, an A/D conversion section 303, a GI removal section 304, an FFT section 305, a demapping section 306, a decoding section 307, a reception state measurement section 308, a reception state information creation section 2109, a coding section 310, a mapping section 311, a D/A conversion section 312, a radio transmission section 313, and a demodulation control section 314.

In the terminal device 2100 of the present embodiment, the reception state information creation section 2109 which corresponds to the reception state information creation section 309 of the terminal device 300 is different from the first embodiment (see FIG. 3). Because the rest of the structure of the terminal device is the same as the first embodiment (FIG. 3), a description thereof is omitted.

In the terminal device 2100 shown in FIG. 22, the reception state information creation section 2109 calculates an average value of the reception state measurement results for all of the channels output from the reception state measurement section 308 when, based on the report request information output from the demodulation control section 314, it determines that this report request information is information requesting average reception state information, and creates reception state information showing the result of this calculation which it then outputs to the mapping section 311.

When the report request information output from the demodulation control section 314 is information requesting Top-M reception state information, the reception state information creation section 2109 selects M number of channels having excellent reception state measurement results which have been output from the reception state measurement section 308, and creates reception state information showing the identification numbers of these channels and showing the results of the reception state measurements for these channels which it then outputs to the mapping section 311.

When the report request information output from the demodulation control section 314 is information requesting reception state information for all of the channels, the reception state information creation section 2109 creates reception state information showing the results of the reception state measurements for all of the channels which were output from the reception state measurement section 308 which it then outputs to the mapping section 311.

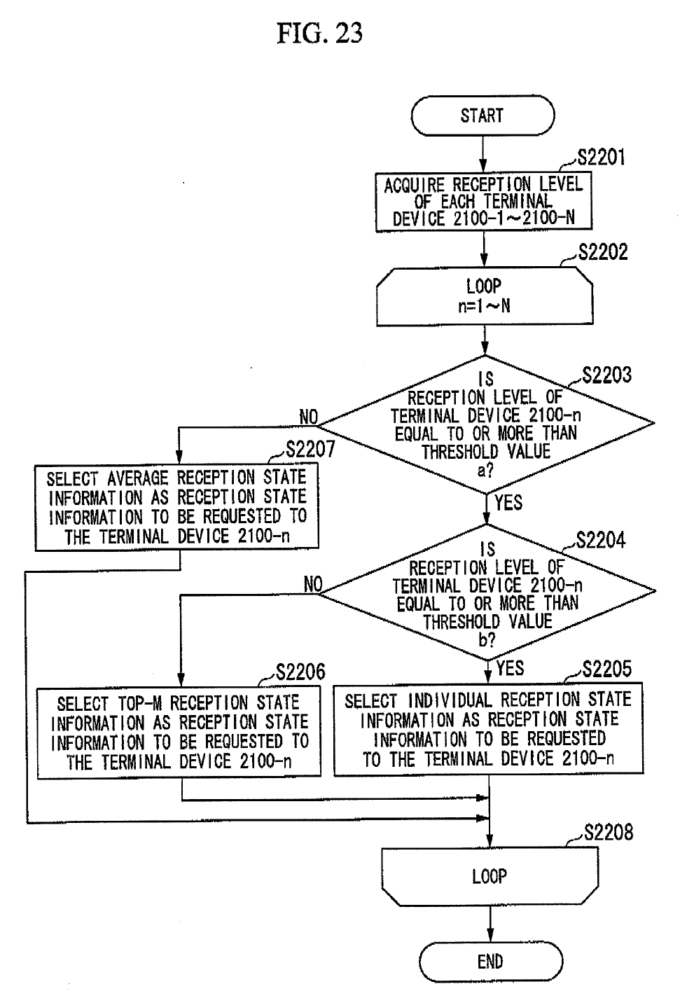

FIG. 23 is a flowchart showing the report request information decision processing of the report request decision section 2013 of the base station device 2000 according to the fifth embodiment of the present invention.

Firstly, the report request decision section 2213 acquires the reception level for each one of terminal devices 2100-1 through 2100-N from the reception state information storage section 2017 (step S2201). Next, the report request decision section 2213 repeats the following processing for each of the terminal devices 2100-1 through 2100-N (i.e., a loop from step S2202 through step S2208).

Incidentally, the report request decision section 2213 compares the reception level of the terminal device 2100-n with a predetermined threshold value a (step S2203). If the reception level is equal to or greater than the predetermined threshold value a, the report request decision section 2213 compares the reception level of that terminal device 2100-n with a predetermined threshold value b (step S2204).

Next, if the reception level of the terminal device 2100-n is equal to or greater than the predetermined threshold value b, the report request decision section 2213 selects the choice of requesting the individual reception state information from the terminal device 2100-n (step S2205), while if the reception level is equal to or greater than the predetermined threshold value a and is also less than the predetermined threshold value b, the report request decision section 2213 selects the choice of requesting the Top-M reception state information from the terminal device 2100-n (step S2206). If, however, the reception level is less than the predetermined threshold value a, the report request decision section 2213 selects the choice of requesting the average reception state information from the terminal device 2100-n (step S2207).

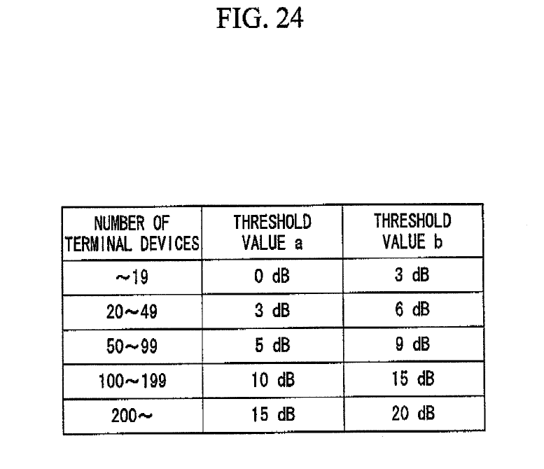

FIG. 24 is a view illustrating threshold values used in the fifth embodiment of the present invention. The table shown in FIG. 24 is used to decide the threshold values a and the threshold values b which correspond to the number of terminal devices (i.e., load information).

The report request decision section 2213 refers to a table (i.e., FIG. 24) showing relationships between the number of terminal devices and the threshold values, and uses threshold values (for example, 3 dB for the threshold value a and 6 dB for the threshold value b) which correspond to the input number of terminal devices (for example 30). At this time, by setting the threshold value a and the threshold value b such that they are greater as the number of terminal devices increases, the threshold values can be set such that the proportion of terminal devices requesting average reception state information increases as the number of terminal devices increases, while, conversely, the proportion of terminal devices requesting Top-M reception state information or individual reception state information increases as the number of terminal devices decreases.

Note that the terminal device numbers and threshold values shown in FIG. 24 are simply an example thereof and the present invention is not limited to these. It is also possible to use as the threshold values values which have been set such that the number of terminal devices reporting average reception state information, the number of terminal devices reporting Top-M reception state information, and the number of terminal devices reporting individual reception state information are in a predetermined ratio to each other, or values which provide a ratio for the numbers of terminal devices which causes the total amount of reception state information reported from all of the terminal devices in accordance with the request information at the time of the reporting to be not more than a predetermined value.

Note that, in the present embodiment, a description is given of a case in which the threshold values a and b are decided from the number of terminal devices using the table shown in FIG. 24, however, the present invention is not limited to this. For example, it is also possible to use another decision method in which the threshold values a and b increase as the number of terminal devices increases.

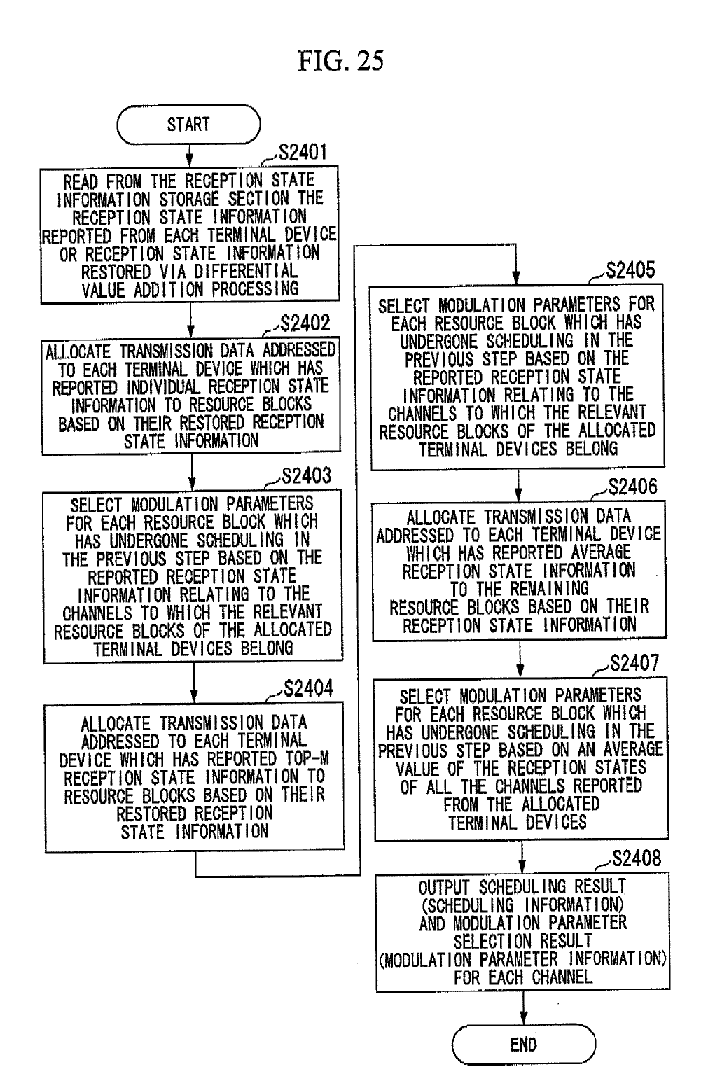

FIG. 25 is a flowchart showing a scheduling operation and a modulation parameter selection operation of the base station device 2000 in the fifth embodiment of the present invention.

The scheduling section 2014 reads from the reception state information storage section 2017 the reception state information which has been reported from each terminal device (step S2401). Next, based on the reception state information of each channel of the respective terminal devices, the scheduling section 2014 allocates the transmission data to be transmitted to each terminal device which has reported individual reception state information to the respective resource blocks (step S2402).

Next, for each of the resource blocks which received allocations in step S2402, the scheduling section 2014 selects modulation parameters based on the reception state information of each channel of the terminal devices which was allocated to the respective resource blocks (step S2403).

Next, based on the reception state information of each channel of each terminal device, the scheduling section 2014 allocates transmission data which is to be transmitted to each terminal device which reported Top-M reception state information to the remaining resource blocks from the allocation in step S2402 (step S2404).

Next, the scheduling section 2014 selects modulation parameters for the respective resource blocks which received allocations in step S2404 based on the reception state information in each channel of each terminal device which was allocated to the respective resource blocks (step S2405).

Next, based on the reception state information of each terminal device, the scheduling section 2014 allocates transmission data which is to be transmitted to each terminal device which reported average reception state information to the remaining resource blocks from the allocation in step S2404 (step S2406).

Next, the scheduling section 2014 selects modulation parameters for the respective resource blocks which received allocations in step S2406 based on the reception state information of each terminal device which was allocated to the respective resource blocks (step S2407).

Next, the scheduling section 2014 outputs the scheduling result (i.e., the scheduling information) and the modulation parameter selection result (i.e., the modulation parameter information) to the coding section 202, the mapping section 203, and the downlink control information creation section 215 (step S2408).

In this manner, in the present embodiment, when reception state information is reported from a plurality of terminal devices 2100 to the base station device 2000, a choice is made in accordance with the load information and the reception level in each terminal device as to whether to report average reception state information which shows an average value of the reception states of all of the channels, or to report Top-M reception state information which shows the reception state of a predetermined M number of channels which have an excellent reception state, or to report individual reception state information which shows the respective reception states of all the channels.

At this time, the inter-relationship between the reception level and the reporting method used for the reception quality information is altered in accordance with the load. Because of this, in a situation in which the load is light, it becomes possible to perform efficient scheduling and adaptive modulation by priority based on the detailed reception state information of each individual channel which has a superior reception state, so that transmissions can be achieved at even higher rates.

In contrast, in a situation in which the load is heavy, by performing scheduling and adaptive modulation based on average reception state information which represents an average value of the reception states of all of the channels, it is possible to reduce the amount of reception state information which needs to be reported from the respective terminal devices using an uplink.

As a result of the above, in the overall system, it becomes possible to perform efficient scheduling and adaptive modulation for terminal devices requiring high-rate and large-capacity communication, while limiting the total amount of reception state information reported from each terminal device using the uplink.

### Sixth Embodiment

Next, a sixth embodiment of the present invention will be described.

In the present embodiment, a case is described in which, based on the load information and on the maximum Doppler frequency fd in each terminal device, either average reception state information which shows an average value of the reception states of all of the channels or else individual reception state information which shows the individual reception states of each channel is selected.

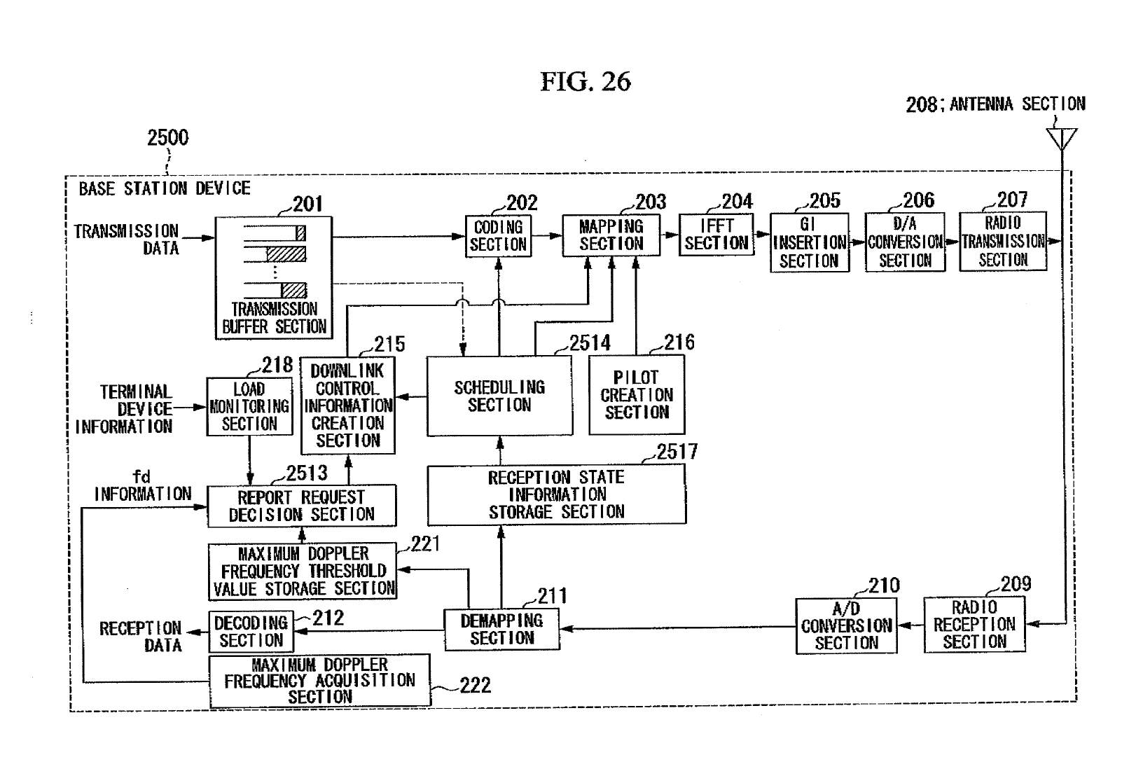

FIG. 26 is a schematic block diagram showing the structure of a base station device 2500 of the sixth embodiment of the present invention. The base station device 2500 is provided with a transmission buffer section 201, a coding section 202, a mapping section 203, an IFFT section 204, a GI insertion section 205, a D/A conversion section 206, a radio transmission section 207, an antenna section 208, a radio reception section 209, an A/D conversion section 210, a demapping section 211, a decoding section 212, a report request decision section 2513, a scheduling section 2514, a downlink control information creation section 215, a pilot creation section 216, a reception state information storage section 2517, a load monitoring section 218, a maximum Doppler frequency threshold value storage section 221, and a maximum Doppler frequency acquisition section 222.

When the base station device 2500 of the present embodiment decides the reception state information which will be sent from the base station device 2500 to each one of the terminal devices 300 to request a report, it uses the load information output from the load monitoring section 218 and the maximum Doppler frequency fd of each terminal device. Because of this, of the functional blocks of the base station device 2500, the report request decision section 2513 which corresponds to the report request decision section 213 of the base station device 200, the scheduling section 2514 which corresponds to the scheduling section 214 of the base station device 200, and the reception state information storage section 2517 which corresponds to the reception state information storage section 217 of the base station device 200 are different from the first embodiment (see FIG. 2). Because the rest of the structure of the base station device is the same as in the first embodiment, a description thereof is omitted.

In the base station device 2500 shown in FIG. 26, the reception state information storage section 2517 stores for each terminal device the reception state information which has been reported from the respective terminal devices and separated by the demapping section 211, and outputs the reception state information to the scheduling section 2514.

When the maximum Doppler frequency fd acquired by the maximum Doppler frequency acquisition section 222 is equal to or greater than a threshold value stored in the maximum Doppler frequency threshold value storage section 221 which corresponds to the load information acquired by the load monitoring section 218, the report request decision section 2513 selects a reception state information reporting method which is used to report a greater amount of information than when the maximum Doppler frequency is less than the threshold value. In the present embodiment, if the maximum Doppler frequency is equal to or greater than the threshold value, the report request decision section 2513 selects a method in which the reception state information of all of the channels is reported, while if the maximum Doppler frequency is less than the threshold value, the report request decision section 2513 selects a method in which an average value for the reception states of all of the channels is reported.

Namely, based on the load information output from the load monitoring section 218 and on the measurement results for the maximum Doppler frequency fd measured in the maximum Doppler frequency acquisition section 222, the report request decision section 2513 decides whether to request the respective terminal devices to report the average reception state information, or whether to request them to report the individual reception state information. The report request decision section 2513 then outputs the result of this decision to the downlink control information creation section 215 as report request information.

Note that, as is described above, it is also possible for the maximum Doppler frequency acquisition section 222 to measure the maximum Doppler frequency fd based on signals from the terminal devices, or to employ a structure in which each terminal device measures the maximum Doppler frequency fd and reports the results of this measurement of the maximum Doppler frequency fd to the base station device 2500 resulting in the reported maximum Doppler frequency fd being acquired by the maximum Doppler frequency acquisition section 222. Note that the procedure to decide the report request information is described below in detail.

The maximum Doppler frequency threshold value storage section 221 stores threshold values for the maximum Doppler frequency in accordance with the load (i.e., the number of terminal devices) indicated by the load information. The information stored by the maximum Doppler frequency threshold value storage section 221 is described in FIG. 28.

Because the structure of the terminal devices of the present embodiment is the same as the structure of the terminal devices 300 of the first embodiment (see FIG. 3), a description thereof is omitted.

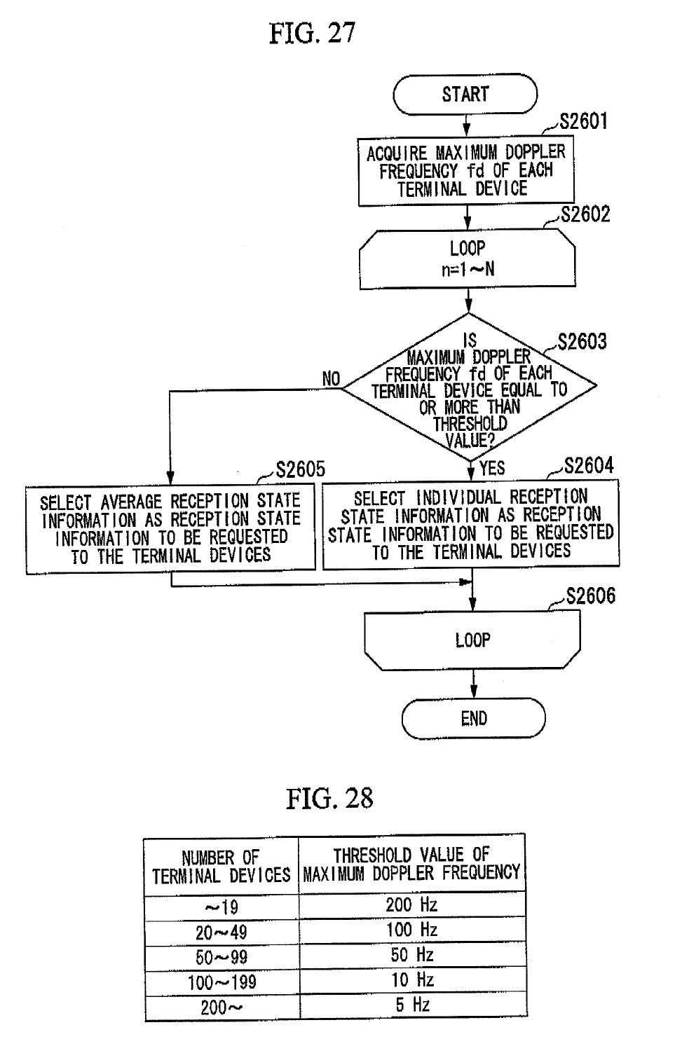

FIG. 27 is a flowchart showing the report request information decision processing of the report request decision section 2513 of the base station device 2500 according to the sixth embodiment of the present invention.

Firstly, the report request decision section 2513 acquires the maximum Doppler frequency fd for each terminal device from the reception state information storage section (step S2601). Next, the report request decision section 2513 repeats the following processing for each of the terminal devices (i.e., N number of terminal devices) (i.e., a loop from step S2602 through step S2606).

Incidentally, the report request decision section 2513 compares the maximum Doppler frequency fd of the respective terminal devices with a predetermined threshold value (step S2603). If the maximum Doppler frequency fd is equal to or greater than the predetermined threshold value, the report request decision section 2513 selects the choice of requesting the individual reception state information from that terminal device (step S2604), while if the maximum Doppler frequency fd is less than the predetermined threshold value, the report request decision section 2513 selects the choice of requesting the average reception state information from that terminal, device (step S2605).

FIG. 28 is a view illustrating maximum Doppler frequency threshold values used in the sixth embodiment of the present invention. The table shown in FIG. 28 is used when the maximum Doppler frequency threshold values which correspond to the number of terminal devices (i.e., to the load information) are being decided, and is recorded in the maximum Doppler frequency threshold value storage section 221.

The report request decision section 2513 refers to a table (i.e., FIG. 28) showing relationships between the threshold values and the number of terminal devices recorded in the maximum Doppler frequency threshold value storage section 221, and uses maximum Doppler frequency threshold values (for example, 100 Hz) which correspond to the input number of terminal devices (for example 30). At this time, by setting the threshold values such that they become smaller as the number of terminal devices increases, the threshold values can be set such that the proportion of terminal devices requesting average reception state information increases as the number of terminal devices increases, while, conversely, the proportion of terminal devices requesting individual reception state information increases as the number of terminal devices decreases.

Note that the values for the terminal device numbers and maximum Doppler frequency threshold values shown in FIG. 28 are simply examples thereof and the present invention is not limited to these. It is also possible to use as the maximum Doppler frequency threshold values values which have been set such that the number of terminal devices reporting average reception state information and the number of terminal devices reporting individual reception state information are in a predetermined ratio to each other, or values which provide a ratio for the numbers of terminal devices which causes the total amount of reception state information reported from all of the terminal devices in accordance with the request information at the time of the reporting to be equal to or less than a predetermined value.

Note that, in the present embodiment, a description is given of a case in which the maximum Doppler frequency threshold values are decided from the number of terminal devices using a table such as that shown in FIG. 28, however, the present invention is not limited to this. For example, it is also possible to use another decision method in which the maximum Doppler frequency threshold value increases as the number of terminal devices increases such as using a predetermined formula which calculates threshold values for the maximum Doppler frequencies using the number of terminal devices as an argument.

Note also that in the above description a case has been described in which the maximum Doppler frequency fd in each terminal device is used as an index to show the speed of variations in the reception state measurement results for the channels of each terminal device, however, the present invention is not limited to this. For example, it is also possible to use another index associated with the speed of variations in the reception state measurement results for the channels of each terminal device such as the coherent time in the terminal devices, the difference between the reception state at the time when the reception state in a terminal device is measured and the reception state at the time when that terminal device receives the transmission data created when the base station device has performed the scheduling and adaptive modulation based on the earlier reception state measurement results, and values obtained by measuring the movement speed of the terminal devices.

In this manner, in the present embodiment, when reception state information is reported from a plurality of terminal devices to the base station device, a choice is made in accordance with the load information (i.e., the number of terminal devices) and the maximum Doppler frequency threshold value in each terminal device as to whether to report average reception state information which shows an average value of the reception states of all of the channels, or to report individual reception state information which shows the respective reception states of all the channels.

At this time, the interrelationship between the maximum Doppler frequency fd and the reporting method used for the reception quality information is altered in accordance with the load. Because of this, in a situation in which the load is light, it becomes possible to perform efficient scheduling and adaptive modulation by priority based on the detailed reception state information of each individual channel, so that transmissions can be achieved at even higher rates.

In contrast, in a situation in which the load is heavy, by performing scheduling and adaptive modulation based on average reception state information which represents an average value of the reception states of all of the channels, it is possible to reduce the amount of reception state information which needs to be reported from the respective terminal devices using an uplink.

As a result of the above, in the overall system, it becomes possible to perform efficient scheduling and adaptive modulation for terminal devices requiring high-rate and large-capacity communication, while limiting the total amount of reception state information reported from each terminal device using the uplink.

### Seventh Embodiment

Next, a seventh embodiment of the present invention will be described.

In the present embodiment, a case is described in which, based on the load information and on a delay dispersion in each terminal device, either average reception state information which shows an average value of the reception states of all of the channels or else individual reception state information which shows the individual reception states of each channel is selected.

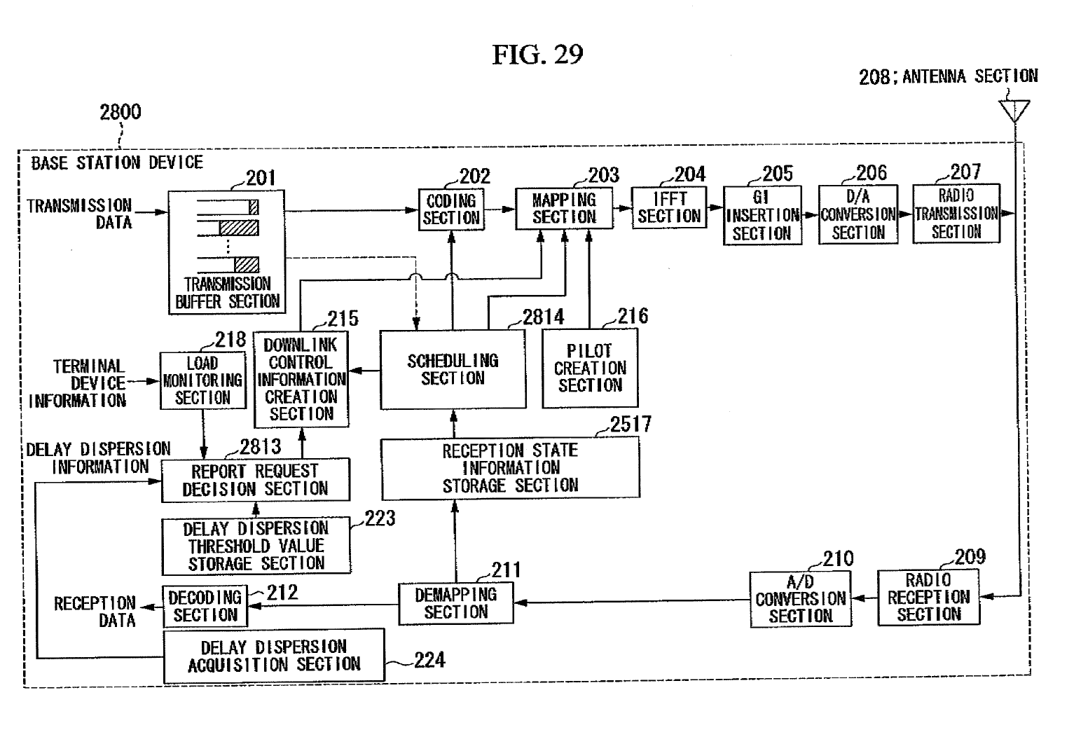

FIG. 29 is a schematic block diagram showing the structure of a base station device 2800 of the seventh embodiment of the present invention. The base station device 2800 is provided with a transmission buffer section 201, a coding section 202, a mapping section 203, an IFFT section 204, a GI insertion section 205, a D/A conversion section 206, a radio transmission section 207, an antenna section 208, a radio reception section 209, an A/D conversion section 210, a demapping section 211, a decoding section 212, a report request decision section 2813, a scheduling section 2814, a downlink control information creation section 215, a pilot creation section 216, a reception state information storage section 2517, a load monitoring section 218, a delay dispersion threshold value storage section 223, and a delay dispersion acquisition section 224.

When the base station device 2800 of the present embodiment decides the reception state information which will be sent from the base station device 1800 to each one of the terminal devices to request a report, it uses the load information output from the load monitoring section 218 and the delay dispersion in each terminal device. Because of this, of the functional blocks of the base station device 2800, the report request decision section 2813 which corresponds to the report request decision section 213 of the base station device 200, the scheduling section 2814 which corresponds to the scheduling section 214 of the base station device 200, and the reception state information storage section 2517 which corresponds to the reception state information storage section 217 of the base station device 200 are different from the first embodiment (see FIG. 2).

Note that because the reception state information storage section 2517 is the same as the reception state information storage section 2517 of the base station device 2500 of the sixth embodiment (see FIG. 26), and because the rest of the structure of the base station device is the same as in the first embodiment (see FIG. 2), descriptions thereof are omitted.

In the base station device 2800 shown in FIG. 29, when the delay dispersion acquired by the delay dispersion acquisition section 224 is equal to or greater than a threshold value stored in the delay dispersion threshold value storage section 223 which corresponds to the load information acquired by the load monitoring section 218, the report request decision section 2813 selects a reception state information reporting method which is used to report a greater amount of information than when the delay dispersion is less than the threshold value. In the present embodiment, if the delay dispersion is equal to or greater than the threshold value, the report request decision section 2813 selects a method in which the reception state information of all of the channels is reported, while if the delay dispersion is less than the threshold value, the report request decision section 2813 selects a method in which an average value for the reception states of all of the channels is reported.

Namely, based on the load information output from the load monitoring section 218 and on the measurement results for the delay dispersion measured by the delay dispersion acquisition section 224, the report request decision section 2813 decides whether to ask the respective terminal devices to report the average reception state information, or whether to ask them to report the individual reception state information. The report request decision section 2813 then outputs the result of this decision to the downlink control information creation section 215 as report request information.

Note that, as is described above, it is also possible for the delay dispersion acquisition section 224 to measure the delay dispersion based on signals from the terminal devices, or to employ a structure in which each terminal device measures the delay dispersion and reports the results of this measurement of the delay dispersion to the base station device 2800 resulting in the reported delay dispersion being acquired by the delay dispersion acquisition section 224. Note that the procedure to decide the report request information is described below in detail.

The delay dispersion threshold value storage section 223 stores threshold values for the delay dispersion in accordance with the load (i.e., the number of terminal devices) indicated by the load information. The information stored by the delay dispersion threshold value storage section 223 is described in FIG. 31.

The delay dispersion acquisition section 224 measures the delay dispersion for each terminal device from the pilot series separated by the demapping section 211, and outputs the result of this measurement to the report request decision section 2813. Note that the delay dispersion is a value calculated using the following Formula (1).

$$\begin{matrix}[ Formula 1 ] & \\ σ = \sqrt{\frac{{\sum }_{n = 1}^{N} {P}_{n} \cdot {( {t}_{n} - \overline{t} )}^{2}}{{\sum }_{n = 1}^{N} {P}_{n}}} & ( 1 )\end{matrix}$$

wherein N is the number of delay waves, Pₙ is the reception power of the n^{th} delay wave, tₙ is the delay time of the n^{th} delay wave, and t is the average delay time and is expressed using the following formula.

$$[ Formula 2 ]$$

$$\overline{t} = \frac{{\sum }_{n = 1}^{N} {P}_{n} \cdot {t}_{n}}{{\sum }_{n = 1}^{N} {P}_{n}}$$

Because the structure of the terminal devices of the present embodiment is the same as the structure of the terminal devices 300 of the first embodiment (see FIG. 3), a description thereof is omitted.

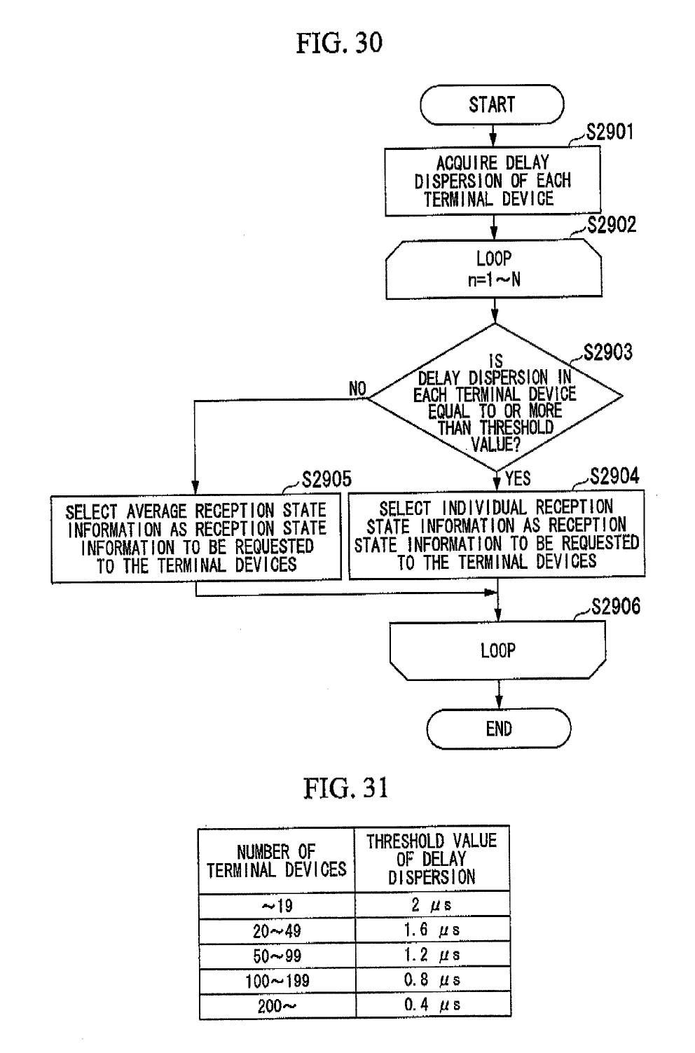

FIG. 30 is a flowchart showing the report request information decision processing of the report request decision section 2813 of the base station device 2800 according to the seventh embodiment of the present invention.

Firstly, the report request decision section 2813 acquires the delay dispersion in each terminal device from the reception state information storage section (step S2901). Next, the report request decision section 2813 repeats the following processing for each of the terminal devices (i.e., N number of terminal devices) (i.e., a loop from step S2902 through step S2906).

Incidentally, the report request decision section 2813 compares the delay dispersion of each one of the respective terminal devices with a predetermined threshold value (step S2903). If the delay dispersion is equal to or greater than the predetermined threshold value, the report request decision section 2813 selects the choice of requesting the individual reception state information from that terminal device (step S2904), while if the delay dispersion is less than the predetermined threshold value, the report request decision section 2813 selects the choice of requesting the average reception state information from that terminal device (step S2905).

FIG. 31 is a view illustrating delay dispersion threshold values used in the seventh embodiment of the present invention. The table shown in FIG. 31 is used when the delay dispersion threshold values which correspond to the number of terminal devices (i.e., to the load information) are being decided, and is recorded in the delay dispersion threshold value storage section 224.

The report request decision Section 2813 refers to a table (see FIG. 31) showing relationships between the delay dispersion threshold values and the number of terminal devices recorded in the delay dispersion threshold value storage section 224, and decides threshold values (for example, 1.6 μs) which correspond to the input number of terminal devices (for example 30). In the present embodiment, by setting the delay dispersion threshold values such that they become smaller as the number of terminal devices increases, the delay dispersion threshold values can be set such that the proportion of terminal devices requesting average reception state information increases as the number of terminal devices increases, while, conversely, the proportion of terminal devices requesting individual reception state information increases as the number of terminal devices decreases.

Note that the values for the terminal device numbers and delay dispersion threshold values shown in FIG. 31 are simply examples thereof and the present invention is not limited to these. It is also possible to use as the delay dispersion threshold values values which have been set such that the number of terminal devices reporting average reception state information and the number of terminal devices reporting individual reception state information, are in a predetermined ratio to each other, or values which provide a ratio for the numbers of terminal devices which causes the total amount of reception state information reported from all of the terminal devices in accordance with the request information at the time of the reporting to be equal to or less than a predetermined value.

Moreover, here, a description is given of a case in which the delay dispersion threshold values are decided from the number of terminal devices using a table such as that shown in FIG. 31, however, the present invention is not limited to this. For example, it is also possible to use another decision method in which the delay dispersion threshold value increases as the number of terminal devices increases such as using a predetermined formula which calculates threshold values for the delay dispersion using the number of terminal devices as an argument.

Note that in the above description a case has been described in which the delay dispersion on the transmission path between the base station device and a terminal device is used as an index to show differences between the reception state in each channel which is shown by the average reception state information and the original reception state measurement results, however, the present invention is not limited to this. For example, it is also possible to use another index associated with the accuracy of the expanded reception state in each channel such as the coherent bandwidth of the transmission path between the base station device and a terminal device, a maximum sample number in which the sample value is less than a predetermined value, the difference between the sample value of a predetermined sample number and a previously set predetermined sample number, and the like.

In this manner, in the present embodiment, when reception state information is reported from a plurality of terminal devices to the base station device 2800, a choice is made in accordance with the load information and the delay dispersion in each terminal device as to whether to report average reception state information which shows an average value of the reception states of all of the channels, or to report individual reception state information which shows the respective reception states of all the channels.

At this time, the inter-relationship between the delay dispersion and the reporting method used for the reception quality information is altered in accordance with the load. Because of this, in a situation in which the load is light, it becomes possible to perform efficient scheduling and adaptive modulation by priority based on the detailed reception state information of each individual channel, so that transmissions can be achieved at even higher rates.

In contrast, in a situation in which the load is heavy, by performing scheduling and adaptive modulation based on average reception state information which represents an average value of the reception states of all of the channels, it is possible to reduce the amount of reception state information which needs to be reported from the respective terminal devices using an uplink.

As a result of the above, in the overall system, it becomes possible to perform efficient scheduling and adaptive modulation for terminal devices requiring high-rate and large-capacity communication, while limiting the total amount of reception state information reported from each terminal device using the uplink.

### Eighth Embodiment

Next, an eighth embodiment of the present invention will be described.

In the present embodiment, a case is described in which, based on the load information and on a QoS (Quality of Service) level of the transmission data addressed to each terminal device, either average reception state information which shows an average value of the reception states of all of the channels or else individual reception state information which shows the individual reception states of each channel is selected.

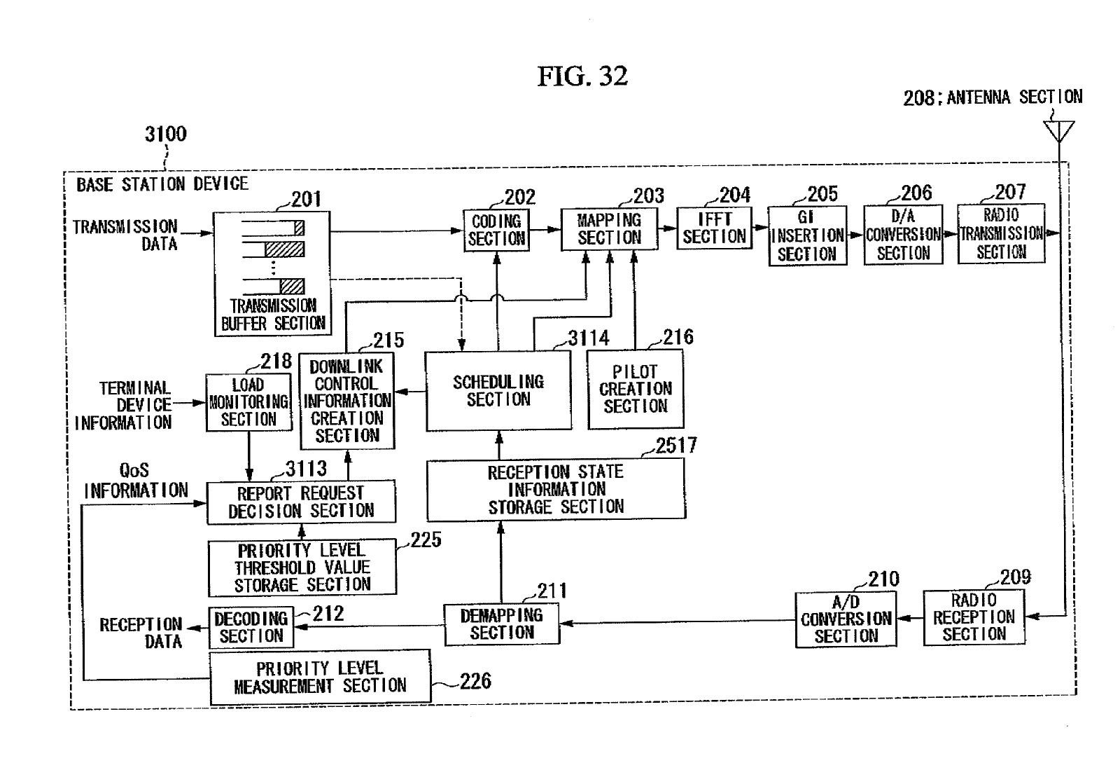

FIG. 32 is a schematic block diagram showing the structure of a base station device 3100 of the eighth embodiment of the present invention. The base station device 3100 is provided with a transmission buffer section 201, a coding section 202, a mapping section 203, an IFFT section 204, a GI insertion section 205, a D/A conversion section 206, a radio transmission section 207, an antenna section 208, a radio reception section 209, an A/D conversion section 210, a demapping section 211, a decoding section 212, a report request decision section 3113, a scheduling section 3114, a downlink control information creation section 215, a pilot creation section 216, a reception state information storage section 2517, a load monitoring section 218, and a priority level acquisition section 226.

When the base station device 3100 of the present embodiment decides the reception state information which will be sent from the base station device 3100 to each one of the terminal devices to request a report, it uses the load information output from the load monitoring section 218 and the QoS level of the transmission data addressed to each terminal device. Because of this, of the functional blocks of the base station device 3100, the report request decision section 3113 which corresponds to the report request decision section 213 of the base station device 200, the scheduling section 3114 which corresponds to the scheduling section 214 of the base station device 200, and the reception state information storage section 2517 which corresponds to the reception state information storage section 217 of the base station device 200 are different from the first embodiment (see FIG. 2).

Note that because the reception state information storage section 2517 is the same as the reception state information storage section 2517 of the base station device 2500 of the seventh embodiment (see FIG. 29), and because the rest of the structure of the base station device is the same as in the first embodiment (see FIG. 2), descriptions thereof are omitted.

In the base station device 3100 shown in FIG. 32, when the priority level of the transmission data acquired by the priority level acquisition section 226 is equal to or greater than a threshold value stored in the priority level threshold value storage section 225 which corresponds to the load information acquired by the load monitoring section 218, the report request decision section 3113 selects a reception state information reporting method which is used to report a greater amount of information than when the priority level is less than the threshold value. In the present embodiment, if the priority level is equal to or greater than the threshold value, the report request decision section 3113 selects a method in which the reception state information of all of the channels is reported, while if the priority level is less than the threshold value, the report request decision section 3113 selects a method in which an average value for the reception states of all of the channels is reported.

Namely, based on the load information output from the load monitoring section 218 and on the priority level of the transmission data acquired by the priority level acquisition section 226, namely, on the QoS level of the transmission data addressed to each terminal device which has been reported from an upper layer (not shown), the report request decision section 3113 decides whether to ask the respective terminal devices to report the average reception state information, or whether to ask them to report the individual reception state information. The report request decision section 3113 then outputs the result of this decision to the downlink control information creation section 215 as report request information. Note that the procedure to decide the report request information is described below in detail.

The priority level threshold value storage section 225 stores threshold values for priority levels which correspond to the load (i.e., the number of terminal devices) shown by the load information. The information stored by the priority level threshold value storage section 225 is described in FIG. 34.

Because the structure of the terminal devices of the present embodiment is the same as the structure of the terminal devices 300 of the first embodiment (see FIG. 3), a description thereof is omitted.

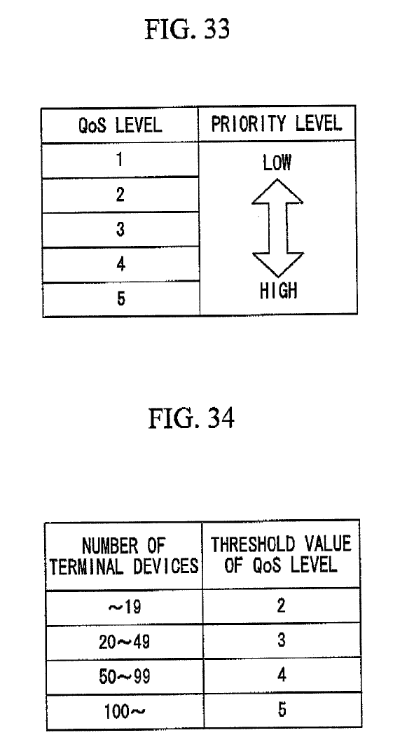

FIG. 33 is a view illustrating the QoS levels in the eighth embodiment of the present invention. The level of priority is determined for each set of transmission data based on the amount of traffic and the permitted delay time. The QoS level is decided based on the priority level of the transmission data. Here, five categories of transmission data from 1 to 5 in ascending level of priority are set as the QoS levels.

FIG. 34 is a view illustrating QoS level threshold values used in the eighth embodiment of the present invention. FIG. 34 is used when the QoS level threshold values which correspond to the number of terminal devices (i.e., to the load information) are being decided, and is recorded in the priority level threshold value storage section 225.

The report request decision section 3113 refers to a table (see FIG. 34) showing relationships between the QoS level threshold values and the number of terminal devices recorded in the priority level threshold value storage section 225, and uses QoS level threshold values which correspond to the input number of terminal devices. At this time, by setting the QoS level threshold values such that they become larger as the number of terminal devices increases, the threshold values can be set such that the proportion of terminal devices requesting average reception state information increases as the number of terminal devices increases, while, conversely, the proportion of terminal devices requesting individual reception state information increases as the number of terminal devices decreases.

Note that the values for the terminal device numbers and QoS level threshold values shown in FIG. 34 are simply examples thereof and the present invention is not limited to these. It is also possible to use as the QoS level threshold values values which have been set such that the number of terminal devices reporting average reception state information and the number of terminal devices reporting individual reception state information are in a predetermined ratio to each other, or values which provide a ratio for the numbers of terminal devices which causes the total amount of reception state information reported from all of the terminal devices in accordance with the request information at the time of the reporting to be equal to or less than a predetermined value.

Moreover, here, a description is given of a case in which the QoS level threshold values are decided from the number of terminal devices using the table shown in FIG. 34, however, the present invention is not limited to this. For example, it is also possible to use another decision method in which the threshold values increase as the number of terminal devices increases.

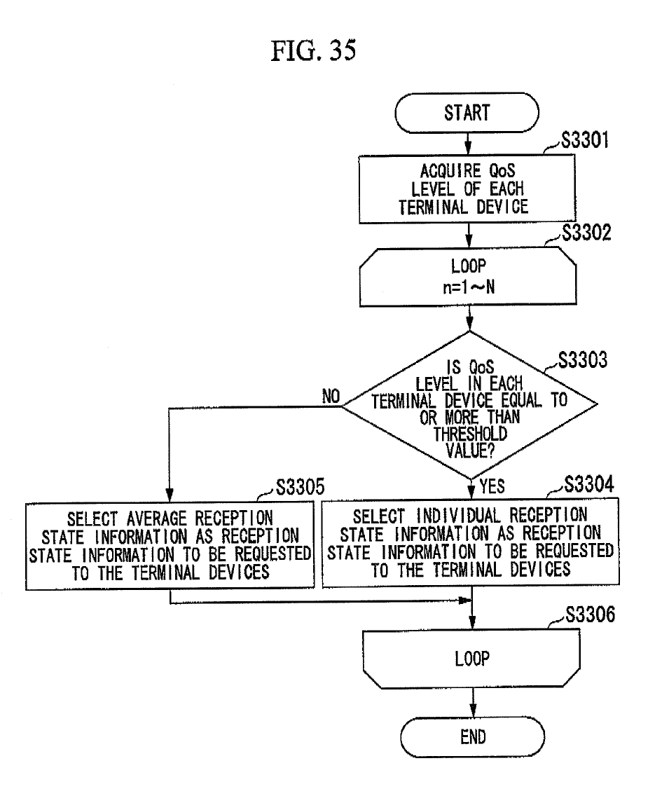

FIG. 35 is a flowchart showing the report request information decision processing of the report request decision section 3113 of the base station device 3100 according to the eighth embodiment of the present invention.

Firstly, the report request decision section 3113 acquires the QoS level in each terminal device from the reception state information storage section 2517 (step S3301). Next, the report request decision section 3113 repeats the following processing for each of the terminal devices (i.e., N number of terminal devices) (i.e., a loop from step S3302 through step S3306).

Incidentally, the report request decision section 3113 compares the QoS level of each one of the respective terminal devices with a predetermined threshold value (step S3303). If the QoS level is less than the predetermined QoS level threshold value, the report request decision section 3113 selects the choice of requesting the average reception state information from that terminal device (step S3305), while if the QoS level is equal to or greater than the predetermined threshold value, the report request decision section 3113 selects the choice of requesting the individual reception state information from that terminal device (step S3304).

In this manner, in the present embodiment, when reception state information is reported from a plurality of terminal devices to the base station device 3100, a choice is made in accordance with the load information and the QoS level of the transmission data addressed to each terminal device as to whether to report average reception state information which shows an average value of the reception states of all of the channels, or to report individual reception state information which shows the respective reception states of all the channels.

At this time, the inter-relationship between the QoS level and the reporting method used for the reception quality information is altered in accordance with the load. Because of this, in a situation in which the load is light, it becomes possible to perform efficient scheduling and adaptive modulation by priority based on the detailed reception state information of each individual channel, so that transmissions can be achieved at even higher rates.

In contrast, in a situation in which the load is heavy, by performing scheduling and adaptive modulation based on average reception state information which represents an average value of the reception states of all of the channels, it is possible to reduce the amount of reception state information which needs to be reported from the respective terminal devices using an uplink.

As a result of the above, in the overall system, it becomes possible to perform efficient scheduling and adaptive modulation for terminal devices requiring high-rate and large-capacity communication, while limiting the total amount of reception state information reported from each terminal device using the uplink.

### Ninth Embodiment

Next, a ninth embodiment of the present invention will be described.

In the first embodiment, a case is described in which either average reception state information which shows an average value of the reception states of all of the channels or else more detailed reception state information which shows the individual reception states of each channel is chosen as the reception state information about which the base station 200 device requests a report from each terminal device 300, and the selected report request information is then sent to the terminal device 300.

In the ninth embodiment, a base station device 3500 transmits a control signal which includes load information showing the load to the terminal devices 3600 and, based on the load information sent from the base station device 3500 and on measured reception levels, the terminal devices 3600 select average reception state information which shows an average value of the reception states of all the channels or individual reception state information which shows the individual reception states of each channel.

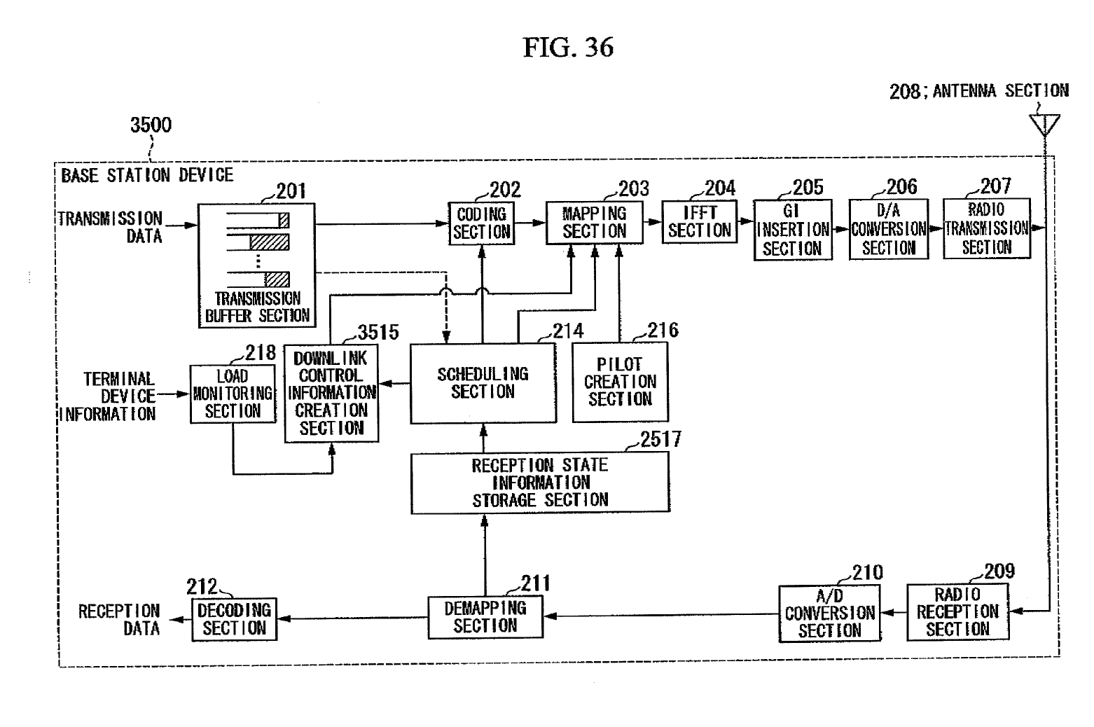

FIG. 36 is a schematic block diagram showing the structure of the base station device 3500 of the ninth embodiment of the present invention. The base station device 3500 is,provided with a transmission buffer section 201, a coding section 202, a mapping section 203, an IFFT section 204, a GI insertion section 205, a D/A, conversion section 206, a radio transmission section 207 (also known as a load information transmission section), an antenna section 208, a radio reception section 209, an A/D conversion section 210, a demapping section 211, a decoding section 212, a scheduling section 214, a downlink control information creation section 3515, a pilot creation section 216, a reception state information storage section 2517, and a load monitoring section 218 (also known as a load information acquisition section).

Of the functional blocks of the base station device 3500, no block which corresponds to the report request decision section 213 of the base station device 200 of the first embodiment has been provided, while the downlink control information creation section 3515 which corresponds to the downlink information creation section 215 of the base station device 200 of the first embodiment, and the reception state information storage section 2517 which corresponds to the reception state information storage section 217 of the base station device 200 are different from the first embodiment (see FIG. 2).

Note that because the reception state information storage section 2517 is the same as the reception state information storage section 2517 of the base station device 2500 of the sixth embodiment (see FIG. 26), and because the rest of the structure of the base station device is the same as in the first embodiment (see FIG. 2), descriptions thereof are omitted.

The load monitoring section 218 acquires load information which shows the load of the base station device 3500, and outputs it to the downlink control information creation section 3515.

In the base station device 3500 of the present embodiment, the downlink control information creation section 3515 decides load levels based on the load information output from the load monitoring section 218, and creates downlink control information scheduling information which includes load level information which shows the decided load level, and scheduling information and modulation parameter information from the scheduling section 214.

The radio transmission section 207 transmits to the terminal devices 3600 by means of the antenna section 208 load information which has been acquired by the load information acquisition section and output from the downlink control information creation section 3515 via the mapping section 203, the IFFT section 204, the GI insertion section 205, and the D/A conversion section 206.

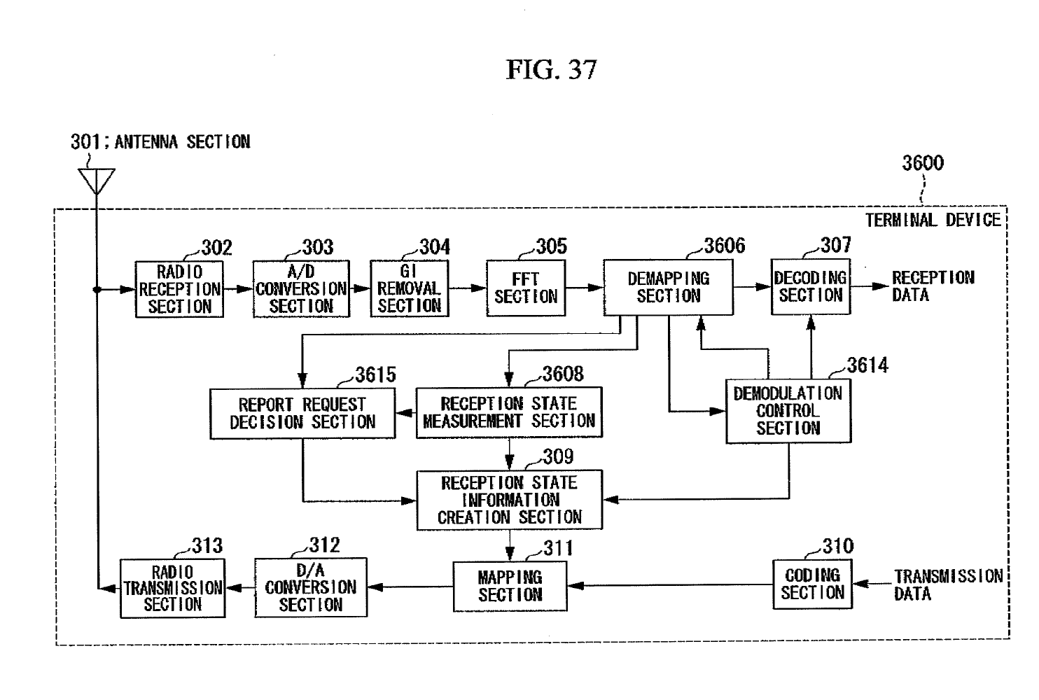

FIG. 37 is a schematic block diagram showing the structure of a terminal device 3600 of the ninth embodiment of the present invention. The terminal device 3600 is provided with an antenna section 301, a radio reception section 302 (also called a load information reception section), an A/D conversion section 303, a GI removal section 304, an FFT section 305, a demapping section 3606, a decoding section 307, a reception state measurement section 3608, a reception state information creation section 309, a coding section 310, a mapping section 311, a D/A conversion section 312, a radio transmission section 313 (also called a transmission section), a demodulation control section 314, and a report request decision section (also called a reporting method selection section).

In the terminal device 3600 of the present embodiment, the demapping section 3606 which corresponds to the demapping section 306 of the terminal device 300, the demodulation control section 3614 which corresponds to the demodulation control section 314 of the terminal device 300, and the reception state measurement section 3608 which corresponds to the reception state measurement section 308 of the terminal device 300 are different from the first embodiment (see FIG. 3). This terminal device 3600 is also equipped with the report request decision section 3615.

Because the rest of the structure of the terminal device shown in FIG. 37 is the same as in the first embodiment, a description thereof is omitted.

In the terminal device 3600, the radio reception section 302 receives load information transmitted by the radio transmission section 207 of the base station device 3500, and outputs it to the demapping section 3606 via the A/D conversion section 303, the GI removal section 304, and the FFt section 305.

The demapping section 3606 firstly separates pilot symbols from the modulation symbol series output from the FFT section 305, and outputs these to the reception state measurement section 308. The demapping section 306 also performs demapping on those signals in the downlink control information which include the load level information and outputs the result to the report request decision section 3615, and performs demapping on the signals which include the scheduling information and modulation parameter information and outputs the result to the demodulation control section 3614. The demapping section 3606 also performs demapping on the data series in accordance with the scheduling information and demodulation parameter information from the demodulation control section 3614, and outputs the result to the decoding section 307. Note that transmission path compensation for the modulation symbol series may also be performed based on the pilot symbols.

The reception state measurement section 3608 measures reception levels and reception states in each of the channels using pilot symbols output from the demapping section 3606, and outputs the reception level measurement results to the report request decision section 3615 and the reception state measurement results to the reception state information creation section 309.

The demodulation control section 3614 extracts scheduling information (i.e., information relating to channels allocated to the transmission data addressed to the terminal device 300) and modulation parameter information (i.e., information relating to modulation parameters for these allocated channels) from signals which include the scheduling information and modulation parameter information input from the demapping section 3606, and outputs the scheduling information and modulation parameter information respectively to the demapping section and the decoding section 307. Note that when the signals which include the scheduling information and modulation parameter information have previously undergone error correction coding in the base station device 3500, then it is sufficient to only perform error correction decoding.

The report request decision section 3615 selects the reporting method information by which the terminal device 3600 will report the reception state information to the base station device 3500 based on the load information acquired by the radio reception section 302. Namely, the report request decision section 3615 extracts load level information from signals which include the load level information input from the demapping section 3606, and based on the extracted reception levels and on the reception levels input from the reception state measurement section 3608, decides whether to request first reception state information which shows the average value of the reception states of all the channels (i.e., average reception state information), or whether to request second reception state information which shows the individual reception states of each one of the channels (i.e., individual reception state information). The report request decision section 3615 then outputs the result of its decision to the reception state information creation section 309 as report request information.

The radio transmission section 313 transmits the reception state measured by the reception state measurement section 3608 to the base station device 3500 via the antenna section 301 using the reporting method selected by the report request decision section 3615.

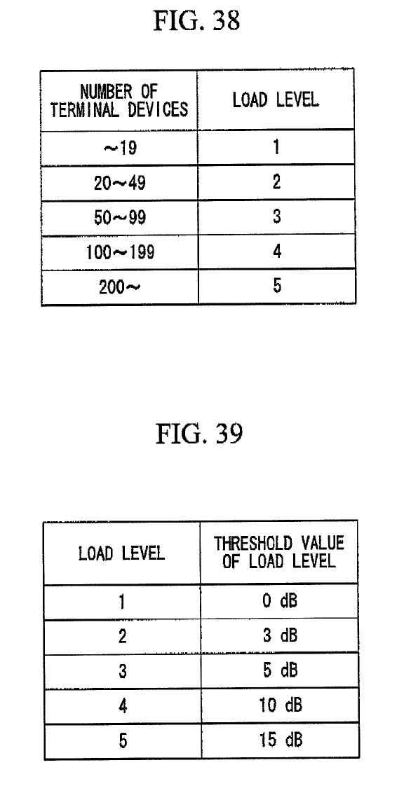

FIG. 38 is shows an example of information stored by the base station device 3500 according to the ninth embodiment of the present invention. As is shown in FIG. 38, the base station device 3500 associates the number of terminal devices with the load level and stores these. In FIG. 38, the load level is set so as to increase as the load information (i.e., the number of terminal devices) increases.

The report request decision section 3615 receives from the base station device 3500 load information which shows the number of terminal devices with which the base station device 3500 is communicating, and decides a load level (for example, 2) which corresponds to that number of terminal devices (for example, 30) using the table in FIG. 38.

It is possible to use the same processing as that performed by the report request decision section 213 of the first embodiment (see FIG. 4) for the processing performed by the report request decision section 3615, however, the method used to decide the threshold values is different.

FIG. 39 is a view illustrating threshold values in the ninth embodiment of the present invention. The report request decision section 3615 holds a table (FIG. 39) showing relationships between the load level and the threshold value, and uses a threshold value (for example, 3 dB) which corresponds to the input load level (for example, 2). At this time by setting the threshold values so that they are greater as the load level increases, the threshold values can be set such that the proportion of terminal devices requesting average reception state information increases as the load level increases, while, conversely, the proportion of terminal devices requesting individual reception state information increases as the load level decreases.

Note that the terminal device numbers and threshold values shown in FIG. 39 are simply examples thereof and the present invention is not limited to these. It is also possible to use as the threshold values a value which creates a predetermined ratio between the number of terminal devices reporting average reception state information and the number of terminal devices reporting individual reception state information, or a value which provides a ratio for the numbers of terminal devices which causes the total amount of reception state information reported from all, of the terminal devices in accordance with the request information at the time of report to be not more than a predetermined value.

Moreover, here, a description is given of a case in which threshold values are decided from the number of terminal devices using a table such as is shown in FIG. 39, however, the present invention is not limited to this. For example, it is also possible to use another decision method in which the threshold value increases as the number of terminal devices increases.

In this manner, in the present embodiment, the base station device 3500 transmits a control signal which includes load information showing the load to the terminal devices 3600 and, based on the load information sent from the base station device 3500 and on measured reception levels, the terminal devices 3600 select average reception state information which shows an average value of the reception states of all the channels or individual reception state information which shows the individual reception states of each channel.

At this time, the inter-relationship between the reception level and the reporting method used for the reception quality information is altered in accordance with the load level shown by the load information. Because of this in a situation in which the load is light, it becomes possible to perform efficient scheduling and adaptive modulation by priority based on the detailed reception state information of each individual channel, so that transmissions can be achieved at even higher rates.

In contrast, in a situation in which the load is heavy, by performing scheduling and adaptive modulation based on average reception state information which represents an average value of the reception states of all of the channels, it is possible to reduce the amount of reception state information which needs to be reported from the respective terminal devices using an uplink.

As a result of the above, in the overall system, it becomes possible to perform efficient scheduling and adaptive modulation for terminal devices requiring high-rate and large-capacity communication, while limiting the total amount of reception state information reported from each terminal device using the uplink.

### Tenth Embodiment

Next, a tenth embodiment of the present invention will be described.

In the first through ninth embodiments, cases are described in which an OFDM system is used and channels are used which are made up of either one or a plurality of subcarriers.

In the present embodiment, a case is described in which an MIMO (Multiple Input Multiple Output)-OFDM system is used, and in which each one of either one or a plurality of subcarriers in the signal transmitted from each transmission antenna is used as a channel.

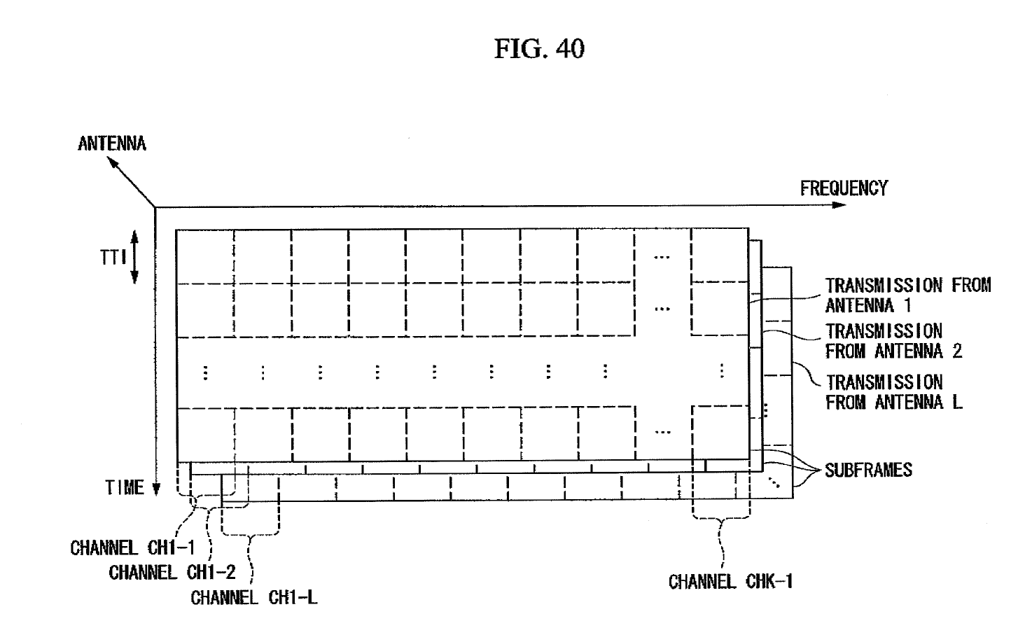

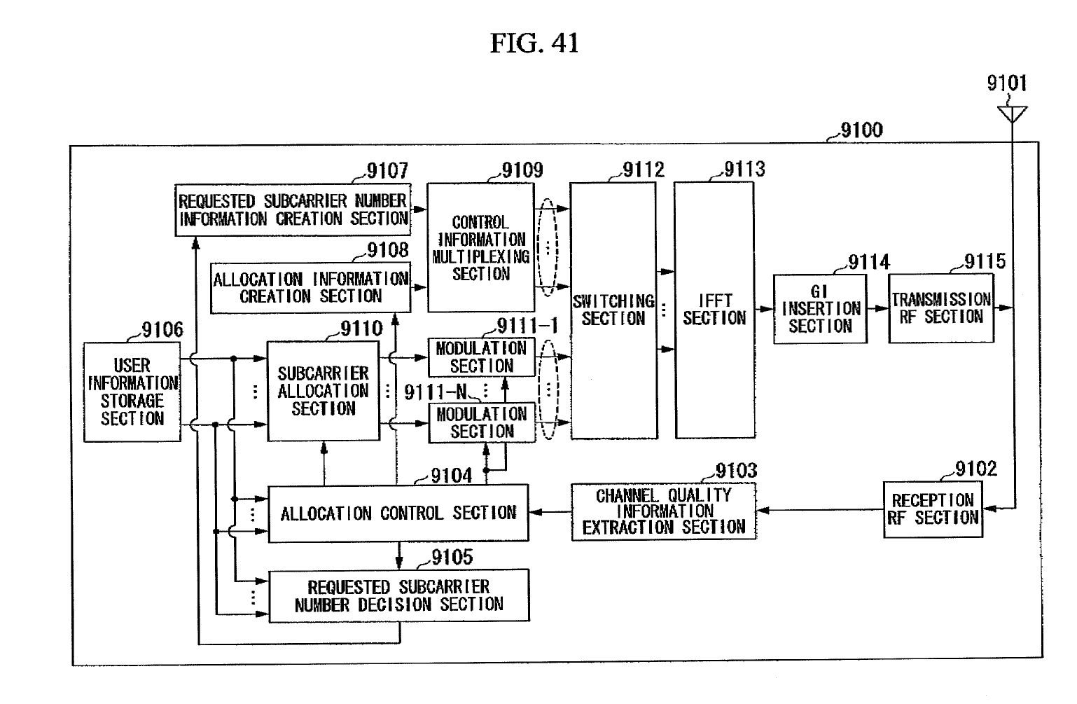

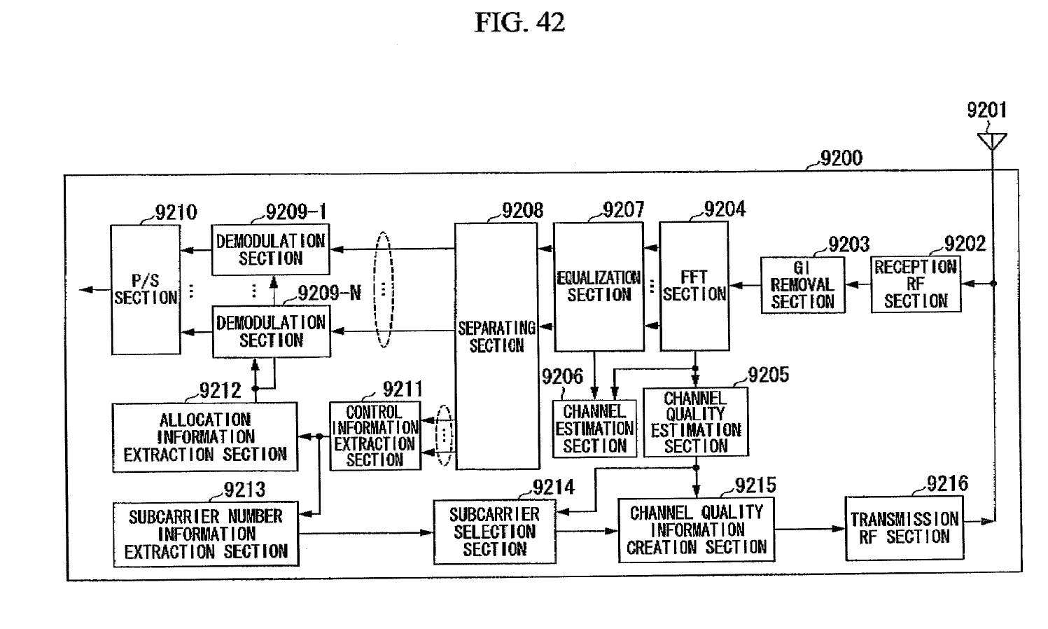

FIG. 40 shows an example of a subframe structure of a downlink in the tenth embodiment of the present invention. In FIG. 40, the horizontal axis shows frequency, while the vertical axis shows time. A base station device transmits different signals from L (wherein L is an integer of 2 or more) number of transmission antennas. A subframe contains L number of areas which are transmitted respectively from the 1^{st} antenna to the L^{th} antenna, and each area is further divided into K (wherein K is a natural number) of areas in the frequency direction. Each one of these L×K areas is used as a channel, so that these subframes are taken to mean transmission units, and form a range in which channel allocation is performed in a single scheduling processing. In addition, the subframes are divided into T (wherein T is a natural number) number of predetermined time intervals TTI in the time axial direction, and the interior of 1 TTI in one channel is taken as a scheduling unit (i.e., a resource block).

In an MIMO-OFDM system having this type of subframe structure, only the areas indicated by the terms channels or resource blocks are different and it is still possible to apply the same processing as that applied in each of the above described embodiments.

As is described above, in a system in which communication is performed using a plurality of channels within a subframe, it is possible to apply the above described first through ninth embodiments to systems in which there is a possibility that the reception state will be different in each channel of each terminal device, and in the overall system, it becomes possible to perform efficient scheduling and adaptive modulation for terminal devices requiring high-rate and large-capacity communication, while limiting the total amount of reception state information reported from each terminal device using the uplink.

Note that in the above described embodiments, cases are described in which average reception state information which shows an average value of the reception states of all the channels is used, however, instead of an average value, it is also possible to use values representing the reception states of all of the channels such as the maximum value of the reception states of all the channels, or the minimum value thereof or the median value thereof or the like.

Moreover, in the above described embodiments, cases are described in which multicarrier transmission systems (in particular, OFDM transmission systems) are used, a channel structure which is provided with at least one subcarrier is used, and cellular systems that use channels as the subject units for adaptive modulation, and in which CNR which is calculated based on pilot symbols is used as the reception state are used, however, the present invention is not limited to this. For example, it is also possible to use a MC-CDMA (Multiple Carrier-Code Division Multiple Access) system which employs diffusion technology as the transmission system. Moreover, the present invention can also be applied to other systems which perform communication using as the adaptive modulation and adaptive scheduling units a plurality of channels such as a plurality of channels indicated by transmission antennas or specific modes in SDMA (Space Division Multiple Access) such as MIMO (Multiple Input Multiple Output), or a plurality of code channels in CDMA, or channels formed by a combination of these. Moreover, the present invention can also be applied to systems in which there is a possibility that the reception state will be different in each channel.

Moreover, in each of the above described embodiments, cases are described in which CNR is used as the reception state information, however, the present invention is not limited to this. It is also possible to use an index which shows the reception state in relation to the reception signal power or the transmission wave power such as RSSI (Received Signal Strength Indicator), SNR, SIR (Signal to Interference power Ratio), SINR (Signal to Interference plus Noise power Ratio), CIR (Carrier to Interference power Ratio), CINR (Carrier to Interference plus Noise power Ratio) and the like.

Moreover, it is also possible to use an index relating to the transmission speed such as modulation parameters selected in accordance with the transmission path state such as modulation parameters such as MCS (Modulation and Coding Scheme) which is a combination of a modulation system and a channel code rate, or such as the transmission rate.

Moreover, in each of the above described embodiments, a communication system which employs FDD (Frequency Division Duplex) and which is formed by a base station device and a plurality of terminal devices, and which is an OFDM adaptive modulation system in downlink communication, and which is a system which does not perform OFDM and adaptive modulation in uplink communication is assumed, however, the present invention is not limited to this.

Moreover, in each of the above described embodiments, it is also possible to control the base station device and terminal devices by recording on a computer-readable recording medium a program which realizes the functions or a portion of the functions of each section of the base station devices (see FIG. 2, FIG. 9, FIG. 13, FIG. 17, FIG. 21, FIG. 26, FIG. 29, FIG. 32, FIG. 36) and each section of the terminal devices (see FIG. 3, FIG. 10, FIG. 14, FIG. 18, FIG. 22, FIG. 37) of the first through tenth embodiments, and by causing this program recorded on a recording medium to be read and executed by a computer system. Note that, here, ‘computer system’ includes the OS and hardware such as peripheral devices and the like.

Moreover, ‘computer readable recording medium’ refers to a storage medium such as a portable medium such as a flexible disc, a magneto-optical disc, ROM, or CD-ROM, or hard disc incorporated in a computer system or the like. Furthermore, ‘computer readable recording medium’ also includes devices that hold a program dynamically for short periods of time such as communication lines when the program is transmitted via a network such as the Internet or via a communication circuit such as a telephone line, and includes devices which hold a program for a fixed period of time such as the volatile memory incorporated in computer systems which form the servers and clients in the case of the communication lines or networks described above. The above described program may realize a portion of the above described functions or may realize the above described functions in combination with a program which has already been recorded on a computer system.

Embodiments of this invention have been described in detail above with reference made to the drawings, however, the specific structure of this invention is not limited to these embodiments and other designs and the like are also included insofar as they do not depart from the spirit or scope of this invention.

### INDUSTRIAL APPLICABILITY

The present invention provides a base station device, a terminal device, a communication system, and a communication method which make it possible to obtain superior transmission efficiency by enabling adaptive modulation and adaptive scheduling to be performed at the same time as the total amount of reception state information is kept to a minimum.

1. A base station device which performs communication with terminal devices, comprising:
a load information acquisition section which acquires load information which shows a load on the base station device;
a reporting method selection section which selects a reporting method for the terminal devices to report reception state information to the base station device based on load information acquired by the load information acquisition section; and
a reporting section which reports the reporting method selected by the reporting method selection section to the terminal devices.

2. The base station device according to claim 1, wherein
the load information acquisition section acquires the number of terminal devices which are performing communication with the base station device as the load information, and
the reporting method selection section selects the reporting method for the terminal devices to report reception state information to the base station device based on the number of terminal devices acquired by the load information acquisition section.

3. The base station device according to claim 1, wherein
the load information acquisition section acquires the number of terminal devices which are reporting reception state information to the base station device as the load information, and
the reporting method selection section selects the reporting method for the terminal devices to report reception state information to the base station device based on the number of terminal devices acquired by the load information acquisition section.

4. The base station device according to claim 1, wherein
the reporting method selection section selects the reporting method for the terminal devices to report reception state information to the base station device from among reporting methods for reception state information in which there are different amounts of information to be reported.

5. The base station device according to claim 4, wherein
the reporting method selection section selects a reporting method for the reception state information in which the amount of information to be reported decreases as the load shown by the load information increases.

6. The base station device according to claim 4, wherein
there are provided:
a reception level acquisition section which acquires the reception levels in the terminal devices of signals transmitted from the base station device to the terminal devices; and
a reception level threshold value storage section which stores threshold values for the reception levels in accordance with the load shown by the load information, and wherein
the reporting method selection section selects the reporting method for the terminal devices to report the reception state information to the base station device based on the load information acquired by the load information acquisition section and on the threshold values stored by the reception level threshold value storage section and on the reception levels.

7. The base station device according to claim 6, wherein
the reporting method selection section selects the reporting method for the terminal devices to report the reception state information to the base station device based on threshold values stored by the reception level threshold value storage section which correspond to the load information acquired by the load information acquisition section and on the reception level.

8. The base station device according to claim 7, wherein,
when the reception level acquired by the reception level acquisition section is equal to or more than a threshold value stored by the reception level threshold value storage section which corresponds to the load information acquired by the load information acquisition section, the reporting method selection section selects a reporting method for reception state information having a greater amount of information to be reported than when this acquired reception level is less than this threshold value.

9. The base station device according to claim 4, wherein
there are provided:
a maximum Doppler frequency acquisition section which acquires the maximum Doppler frequency of signals transmitted between the base station device and the terminal devices; and
a maximum Doppler frequency threshold value storage section which stores threshold values for the maximum Doppler frequency in accordance with the load shown by the load information, and wherein
the reporting method selection section selects the reporting method for the terminal devices to report the reception state information to the base station device based on the threshold values stored by the maximum Doppler frequency threshold value storage section which correspond to the load information acquired by the load information acquisition section and on the maximum Doppler frequency.

10. The base station device according to claim 9, wherein
when the maximum Doppler frequency acquired by the maximum Doppler frequency acquisition section is equal to or more than a threshold value stored by the maximum Doppler frequency threshold value storage section which corresponds to the load information acquired by the load information acquisition section, the reporting method selection section selects a reporting method for reception state information having a smaller amount of information to be reported than when this acquired maximum Doppler frequency is less than this threshold value.

11. The base station device according to claim 4, wherein
there are provided:
a delay dispersion acquisition section which acquires the delay dispersion in the terminal devices of signals transmitted from the base station device to the terminal devices; and
a delay dispersion threshold value storage section which stores threshold values for the delay dispersion in accordance with the load shown by the load information, and wherein
the reporting method selection section selects the reporting method for the terminal devices to report the reception state information to the base station device based on the threshold values stored by the delay dispersion threshold value storage section which correspond to the load information acquired by the load information acquisition section and on the delay dispersion.

12. The base station device according to claim 11, wherein
when the delay dispersion acquired by the delay dispersion acquisition section is equal to or more than a threshold value stored by the delay dispersion threshold value storage section which corresponds to the load information acquired by the load information acquisition section, the reporting method selection section selects a reporting method for reception state information having a smaller amount of information to be reported than when this acquired delay dispersion is less than this threshold value.

13. The base station device according to claim 4, wherein
there are provided:
a priority level acquisition section which acquires the priority level of signals transmitted from the base station device to the terminal devices; and
a priority level threshold value storage section which stores threshold values for the priority levels in accordance with the load shown by the load information, and wherein
the reporting method selection section selects the reporting method for the terminal devices to report the reception state information to the base station device based on the threshold values stored by the priority level threshold value storage section which correspond to the load information acquired by the load information acquisition section and on the priority level.

14. The base station device according to claim 13, wherein
when the priority level acquired by the priority level acquisition section is equal to or more than a threshold value stored by the priority level threshold value storage section which corresponds to the load information acquired by the load information acquisition section, the reporting method selection section selects a reporting method for reception state information having a greater amount of information to be reported than when this acquired priority level is less than this threshold value.

15. The base station device according to claim 1, wherein
the reporting method selection section selects as the reporting method for the terminal devices to report the reception state information to the base station device either a first reporting method in which a representative value of the reception states of all the channels is reported or a second reporting method in which the reception state of each channel is reported.

16. The base station device according to claim 15, wherein
the reporting method selection section selects the first reporting method when the load shown by the load information is equal to or more than a predetermined threshold value, and selects the second reporting method when the load shown by the load information is less than the predetermined threshold value.

17. The base station device according to claim 15 or 16, wherein the second reporting method is a method which reports the reception state information of all the channels.

18. The base station device according to claim 15 or 16, wherein the second reporting method is a method which reports identification information of predetermined channels from all the channels, and reports the reception state information of those predetermined channels.

19. The base station device according to claim 15 or 16, wherein the second reporting method is a method which reports the reception state information of all the channels after the information amount thereof has been reduced by means of discrete cosine conversion.

20. The base station device according to claim 15 or 16, wherein the second reporting method is a method which reports a differential value between the reception state of a predetermined channel and the reception state of a channel adjacent thereto.

21. The base station device according to claim 15 or 16, wherein the first reporting method is a method which reports either an average value, a median value, or a minimum value of the reception states of all the channels.

22. The base station device according to claim 15 or 16, wherein there are provided:
a reception state information receiving section which receives reception state information reported from the terminal devices; and
a channel allocation section which allocates to each channel transmission data for the terminal devices based on the reporting method for the reception state information received by the reception state information receiving section.

23. The base station device according to claim 15 or 16, wherein the channel allocation section gives priority to allocating transmission data to each channel in terminal devices which have used the second reporting method to report reception state information received by the reception state information receiving section over terminal devices which have used the first reporting method to report this reception state information.

24. A terminal device which performs communication with a base station device, comprising:
a reporting method receiving section which receives the reporting method, which was selected based on the load of the base station device, for the terminal device to report reception state information to the base station device;
a reception state measurement section which measures the reception state of each channel; and
a transmission section which transmits the reception states measured by the reception state measurement section to the base station device using the reporting method information received by the reporting method receiving section.

25. A terminal device which performs communication with a base station device, comprising:
a load information receiving section which receives load information which shows a load of the base station device;
a reception state measurement section which measures the reception state of each channel;
a reporting method selection section which selects a reporting method for the terminal devices to report reception state information to the base station device based on load information received by the load information receiving section; and
a transmission section which transmits the reception states measured by the reception state measurement section to the base station device using the reporting method selected by the reporting method selection section.

26. A communication system which is provided with a base station device and terminal devices, wherein
the base station device is provided with:
a load information acquisition section which acquires load information which shows a load of the base station device;
a reporting method selection section which selects a reporting method for the terminal devices to report reception state information to the base station device based on load information acquired by the load information acquisition section; and
a reporting section which reports the reporting method selected by the reporting method selection section to the terminal devices, and wherein
the terminal devices are provided with:
a reporting method receiving section which receives the reporting method reported by the reporting section;
a reception state measurement section which measures the reception state of each channel; and
a transmission section which transmits the reception states measured by the reception state measurement section to the base station device using the reporting method information received by the reporting method receiving section.

27. A communication system which is provided with a base station device and terminal devices, wherein
the base station device is provided with:
a load information acquisition section which acquires load information which shows a load of the base station device; and
a load information transmission section which transmits the load information acquired by the load information acquisition section to the terminal devices, and wherein
the terminal devices are provided with:
a load information receiving section which receives load information transmitted by the load information transmission section;
a reception state measurement section which measures the reception state of each channel;
a reporting method selection section which selects a reporting method for the terminal devices to report reception state information to the base station device based on load information received by the load information receiving section; and
a transmission section which transmits the reception states measured by the reception state measurement section to the base station device using the reporting method selected by the reporting method selection section.

28. A communication method for a base station device which performs communication with terminal devices, comprising:
a load information acquisition step in which load information which shows a load on the base station device is acquired;
a reporting method selection step in which a reporting method for the terminal devices to report reception state information to the base station device is selected based on load information acquired in the load information acquisition step; and
a reporting step in which the reporting method selected in the reporting method selection step is reported to the base station device.

29. A communication method for a terminal device which performs communication with a base station device, comprising:
a reporting method receiving step in which a reporting method for the terminal device to report reception state information to the base station device is received;
a reception state measurement step in which the reception state of each channel is measured; and
a transmission step in which the reception states measured by the reception state measurement section is transmitted to the base station device using the reporting method information received in the reporting method receiving step.

30. A communication method for a terminal device which performs communication with a base station device, comprising:
a load information receiving step in which load information which shows a load of the base station device is received;
a reception state measurement step in which the reception state of each channel is measured;
a reporting method selection step in which a reporting method for the terminal devices to report reception state information to the base station device is selected based on load information received in the load information receiving step; and
a transmission step in which the reception states measured by the reception state measurement section are transmitted to the base station device using the reporting method selected in the reporting method selection step.

31. A communication method which utilizes a base station device and terminal devices, wherein
the base station device executes:
a load information acquisition step in which load information which shows a load of the base station device is acquired;
a reporting method selection step in which a reporting method for the terminal devices to report reception state information to the base station device is selected based on load information acquired in the load information acquisition step; and
a reporting step in which the reporting method selected in the reporting method selection step is reported to the base station device, and wherein
the terminal devices execute:
a reporting method receiving step in which the reporting method reported in the reporting step is received;
a reception state measurement step in which the reception state of each channel is measured; and
a transmission step in which the reception states measured in the reception state measurement step are transmitted to the base station device using the reporting method information received in the reporting method receiving step.

32. A communication method which utilizes a base station device and terminal devices, wherein
the base station device executes:
a load information acquisition step in which load information which shows a load of the base station device is acquired; and
a load information transmission step in which the load information acquired in the load information acquisition step is transmitted to the terminal devices, and wherein
the terminal devices execute:
a load information receiving step in which load information transmitted in the load information transmission step is received;
a reception state measurement step in which the reception state of each channel is measured;
a reporting method selection step in which a reporting method for the terminal devices to report reception state information to the base station device is selected based on load information received in the load information receiving step; and
a transmission step in which the reception states measured in the reception state measurement step are transmitted to the base station device using the reporting method selected in the reporting method selection step.
